(19) United States
(12) Patent Application Publication
(10) Pub. No.: US 2013/0318004 A1
(43) Pub. Date: Nov. 28, 2013

(54) APPARATUSES, METHODS AND SYSTEMS FOR FACILITATING COMMUNITIES OF SOCIAL NETWORK BASED INVESTMENT

(71) Applicants: Oren Bass, New York, NY (US); Salim Lahoud, New York, NY (US); Raymond Tamblin, New York, NY (US)

(72) Inventors: Oren Bass, New York, NY (US); Salim Lahoud, New York, NY (US); Raymond Tamblin, New York, NY (US)

(73) Assignee: PAVE, INC., New York, NY (US)

(21) Appl. No.: 13/891,493

(22) Filed: May 10, 2013

Related U.S. Application Data
(63) Continuation of application No. PCT/US13/27338, filed on Feb. 22, 2013.
(60) Provisional application No. 61/602,080, filed on Feb. 22, 2012.

(51) Int. Cl. G06Q 40/06; G06Q 50/00

(52) U.S. Cl. CPC G06Q 40/06; G06Q 50/01
USPC 705/36 R

(57) ABSTRACT

The APPARATUSES, METHODS AND SYSTEMS FOR FACILITATING COMMUNITIES OF SOCIAL BASED INVESTMENT (“PAVE™ apparatuses, methods, systems, programs and interfaces”) transform user input into profile pages, a social networking platform, social based funding agreements and mentorship arrangements.

### CROSS-REFERENCE TO RELATED APPLICATIONS

This patent application claims the benefit of priority to and is a continuation of International Application No. PCT/US13/27338, filed Feb. 22, 2013, which in turn claims the benefit of priority to U.S. Provisional Patent Application No. 61/602,080, filed Feb. 22, 2012. Each of the aforementioned patent applications is incorporated by reference herein in its entirety for any purpose whatsoever.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address interactions over a social network and social networking platform, and more particularly, include APPARATUSES, METHODS AND SYSTEMS FOR FACILITATING COMMUNITIES OF SOCIAL NETWORK BASED INVESTMENT.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Various social networks (e.g., Facebook®, LinkedIn®, and the like) have recently come into being that have encouraged the connectivity between individuals and to foster the development of interpersonal networks. The present disclosure provides improvements on the state of the art.

### SUMMARY

The purposes and advantages of embodiments of the present disclosure will be set forth in and become apparent from the description that follows. Additional advantages of the disclosed embodiments will be realized and attained by the methods, systems, computer programs and mobile computing devices particularly pointed out in the written description hereof, as well as from the appended drawings.

The present disclosure is directed to embodiments and aspects of a community, or social network, that fosters investment and growth of individuals, groups and/or entities. Applicant aims to build a community linking those with means and those with talent, thus creating a Pave™ community and social network. It is Applicant's belief that such a community can nurture individual, and in turn, societal growth.

The existing financial “system” does not foster individual growth as it privileges assets for access to capital. It is a goal of the Pave™ community and social network to break those traditional barriers which stand in the way of an individual, group or entity achieving their goals and potential.

Embodiments of the Pave™ community and social network focus on talent and its growth by harnessing the power of the personal equity product and leveraging the interpersonal links between individuals. Various embodiments disclosed herein permit ambitious prospects (e.g., young professionals, film makers, athletes, groups, entities etc.) and their supporters (e.g., backers, contacts and the like) to connect, interact and form long-lasting relationships.

The Pave™ community and social network thereby gives people more options and more access to tools to achieve their goals. For prospects (“Prospect”) this can unlock their future earning potential at a point in time when the impact will be at its maximum. For backers (“Backers”), being part of the Pave™ community and social network will provide both a social and financial investment opportunity.

As will be appreciated, many of the disclosed embodiments align the interests of the prospect and backer in order to help ensure success of the prospect, and remuneration of the backer. As the present disclosure is directed to compensation to a backer through future value (e.g., money, services, or other value), the ultimate value realized by the backer can be highly dependent on the degree to which the backer takes an active role in the development of the prospect. Such a platform, that provides for alignment of interests, helps foster a community environment that is strongly motivated to take all actions needed to ensure success of prospects.

The present disclosure embodies many features that a prospect can select to opt into in order to participate in various implementations of the system. A prospect may select to opt into none, some, or all aspects of the embodiments disclosed herein in accordance with the preferences of the prospect, and as required by applicable laws and regulations, as appropriate. For example, a user of the system can be provided with a request to opt in or to decline any such feature in a variety of ways, such as by way of a click wrap agreement or other disclosure explaining the nature of the features of the system that requires the user to check one or more check boxes and/or radio buttons to assent to participate.

Thus, in one aspect, the disclosure provides various methods of operating an online social media platform. The method can include, for example, receiving prospect profile information from a first prospect via processor and storing the prospect profile information in a prospect database. The prospect profile information generally includes personal prospect profile information to be verified, and prospect profile information relating to at least one aspiration of the prospect. The method typically further includes verifying the personal prospect profile information, generating verification information to confirm verification of the personal prospect profile information, storing the verification information in the prospect database, populating an online prospect profile page with the prospect profile information, and making the online prospect profile page accessible to be viewed by at least one registered user of the online social media platform. It will also be appreciated that the disclosed embodiments can be modified to be implemented over a peer to peer network. It will be further appreciated that peer to peer activity can take place over the disclosed social media platforms.

In some implementations, the method can include generating a personal equity funding agreement for the prospect. The personal equity funding agreement specifies terms and conditions for obtaining at least one of monetary funding, and services from at least one backer in exchange for at least one of a portion of the prospect's future earnings over a first predetermined time period and prospect services of the prospect over a second predetermined time period and/or other value. Thus, a prospect may offer future income or services and/or other value in exchange for capital and/or services from a backer. The prospect or backer can be an individual or a group of people. The capital received by the prospect can be an up-front amount, a deferred amount, or distributed payments over time.

The first time period can be any desired time increment, such as one month, six months, one year, five years, ten years, fifteen years, twenty years, twenty five years or thirty years, for example, in any desired increment of one month (e.g., 36 months, 42 months, 37 months, etc.). The portion of the prospect's earnings can be any desired percentage of gross income or after tax income, for example, such as from 0.1% to 15% in any increment of 0.1 percentage, or any other desired percentage, or flat fee, if desired. The income of the prospect in some embodiments may be required to exceed a threshold value before the prospect is required to make payments under the agreement. The threshold can be any desired value that is fixed or variable, such as a set number for gross income (e.g., $50,000 per annum), or average income (e.g., individual or household) for the prospect's geographic region, the applicable poverty line level for the region in which the prospect resides, or other desired level.

Terms of exemplary personal funding agreements can include, for example, (i) name and current residence address of the prospect, (ii) social security number or taxpayer ID number of the prospect, (iii) prospect date of birth, (iv) prospect marital status, (v) educational background of prospect (e.g., university(ies) attended, degree(s) received, grade point average), (vi) period of study (e.g., if prospect is a student), (vii) amount of investment sought, (viii) date that investment is desired or required, (ix) purpose for investment, (x) repayment period, (xi) information obligations of prospect, (xii) privacy and confidentiality provisions, (xiii) amount of future earnings to be repaid, (xiv) upfront fee to be paid to administrator of social media platform (e.g., 1%, 2%, 3%, 4%, 5% of amount paid to prospect), (xv) terms specifying prepayment of agreement by prospect, (xvi) bankruptcy provisions, (xvii) default and remedies provisions, (xviii) governing law and jurisdiction, (xix) assignability of agreement (e.g., may be non-assignable by prospect but assignable by backer), and (xx) representations and warranties of backer and/or prospect. For example, the prospect may represent and warrant that (i) no lawsuit is pending against the prospect that would impair performance under the agreement, (ii) the prospect has not defaulted on any material contract, (iii) the prospect has filed all tax returns and paid all taxes due, (iv) the prospect has no prior criminal convictions, and (v) the prospect has not filed for personal bankruptcy.

In some implementations, the prospect can enter two or more separate funding agreements at the same or different times with the same backer, or with different backers. If desired, the agreement can be between the prospect and a group of backers in their individual capacities, or through an entity, such as a company owned by a plurality of individuals (e.g., limited liability company).

Aside from future income and services in the future, the prospect can similarly offer other value in exchange for financing and/or services from a backer. For example, if the prospect is a performing artist, the prospect can offer a backer free tickets to the prospect's performances over a set period of time (e.g., one or more years, or the lifetime of the prospect) and/or free copies of their work (e.g., music albums). Similarly, if the prospect is an athlete, the prospect can offer a backer free tickets to the prospect's athletic matches (e.g., boxing matches, baseball games, football games, basketball games, hockey games, tennis matches, automobile races, etc.) over a predetermined time period in which the athlete is performing (or commentating, if it is later in the prospect's career). Similarly, if the prospect is a designer, the prospect can offer a backer a free sample or samples of their designs (and or a discount) over a predetermined time period as they are created and, in some instances, before they are publicly offered, as desired. If the prospect is a film maker, the prospect can offer the backer free or private screenings of the film for the backer (and/or complementary copies of the film) and guests with the film maker to discuss the film in private. In other implementations, if the prospect is a politician, the prospect can offer the backer free admission to fundraising events where other people of influence are present, and the like. In any implementation, the prospect can offer value in the form of discounted services or goods.

It will be appreciated that, in some embodiments, a prospect may only wish to obtain services in exchange of future prospect income or other value from the prospect. For example, in certain industries (e.g., music business, film business) it is vital to obtain introductions in order to achieve success.

In some implementations, generating the personal equity funding agreement can include at least one of (i) receiving prospect percentage offer input from the prospect via processor, the prospect percentage offer input indicating an amount of future earnings the prospect is willing to exchange for value, (ii) receiving prospect term input from the prospect via processor, the prospect term input indicating a time period over which the prospect is willing to provide future earnings in exchange for value, (iii) receiving prospect service offer input from the prospect via processor, the prospect service offer input indicating at least one service the prospect is willing to exchange for value, (iv) receiving prospect capital request input from the prospect via processor, the prospect capital request input indicating an amount of capital the prospect seeks to obtain, (v) receiving prospect service request input from the prospect via processor, the prospect service request input indicating at least one service the prospect seeks to obtain, (vi) receiving prospect geographic input from the prospect via processor, the prospect geographic input indicating a geographic region of interest of the prospect, and (vii) receiving prospect backer input from the prospect via processor, the prospect backer input indicating at least one attribute that the prospect seeks in a prospective backer. The prospect percentage offer input can indicate a maximum amount of future earnings the prospect is willing to exchange for value. The prospect term input can indicate the maximum or minimum time period over which the prospect is willing to provide future earnings in exchange for value. The prospect capital request input indicates the minimum amount of capital the prospect seeks to obtain.

The personal equity funding agreement in any implementation described herein (via method, system, software, user interface, etc.) can, in some embodiments, include a plurality of agreements, such as (i) a first agreement between the backer and a third entity, such an individual or organization administering or controlling the social media platform (or an affiliate or assignee thereof), and (ii) a second agreement between the prospect and the third entity. Such an arrangement facilitates a prospect maintaining withholding their identity from a backer, as the prospect reveals their identity to the third entity in order to enter the agreement. Withholding identity of a prospect from a backer can be advantageous to the prospect as it prevents undesired communications to the prospect from the backer, such as in the event that the prospect is not ultimately successful financially and the backer nonetheless seeks their return of capital directly from the prospect in violation of the agreement. In some embodiments, the backer may also select to withhold their identity from the prospect, such as to avoid similar advances or communications or to prevent the prospect from informing others that the backer is funding their activities. The agreement structures contemplated herein also facilitate such a goal. In some implementations, the agreement(s) only become effective after the backer delivers some or all of capital or services under the agreement(s). In other embodiments, the parties to the agreement(s) can be the prospect and backer without a third party.

In some implementations, a prospect can receive disclosures from an administrator of the social networking platform (or affiliate thereof) describing, for example, (i) the impact or potential impact on the prospect of paying a percentage of earnings over a stated or predetermined period, (ii) the possibility that the prospect's identify could become discoverable either directly or inferentially by a backer, and/or (iii) potential tax consequences to the prospect for receiving capital.

In some implementations, a backer can receive disclosures from an administrator of the social networking platform (or affiliate thereof) describing, for example, (i) the condition, background and prospects of a prospect (such as via a third party verification service), (ii) the risk of loss of any funds invested in the prospect, (iii) the degree to which the legality of any agreement entered into may or may not be enforceable, (iv) potential tax consequences from investing in prospects. For example, in some implementations, eligibility criteria of a prospect can be provided to a backer that includes a description of pre-existing financial obligations of the prospect. Such information can be used by a backer to help structure their offer under an agreement, for example, to avoid an undue future financial burden on the prospect.

In further implementations, at least a portion of the information contained on the online prospect profile page can be made accessible to be viewed by at least one backer after the prospect has assented to the personal equity funding agreement. The online prospect profile page generally does not disclose the identity of the prospect, but the prospect can select to reveal their identity to other members of the social media platform as desired, such as by other members individually or the like. In some embodiments, a prospect can reveal their identity in order to receive mentoring services or other services from a backer. The online prospect profile page can include at least one of (i) a description of a prospect goal, (ii) an amount of capital sought by the prospect to help meet the prospect goal, (iii) one or more backer services sought by the prospect to help meet the prospect goal, (iv) an amount of equity the prospect is willing to exchange for capital or backer services, (v) a description of prospect services available to be exchanged for capital or backer services, (vi) at least one geographic region in which the prospect operates, (vii) the educational background of the prospect, (viii) a picture of the prospect, (ix) a sample of the prospect's work, (x) a timeframe in which the prospect desires to accomplish a goal, (xi) prior accomplishments of the prospect and (xii) GPS coordinate information of the prospect.

In some implementations, the method can further include assigning a prospect rating to the prospect. The prospect rating can be based at least in part on the prospect profile information. The prospect rating can be further based on one or more of (i) a credit score or credit rating, (ii) a prior achievement of the prospect, (iii) a subjective review by an individual that is familiar with the prospect, (iv) earning potential of the prospect, (v) a grade point average of the prospect, (vi) a quality rating of the prospect by peers of the prospect, and the like. In some embodiments, only individuals that have had dealings with the prospect may be permitted to help rate the prospect. The services of the prospect over a predetermined time period can include, by way of example, at least one of (i) execution of an artistic work, (ii) execution of a literary work, (iii) execution of a cinematic work, (iv) a personal appearance and (v) a consulting arrangement. In some implementations, the personal prospect profile information to be verified can include one or more of (i) the age of the prospect, (ii) the identity of the prospect, (iii) the social security number of the prospect, (iv) the tax identification number for the prospect, (v) a legal address of the prospect, (vi) the credit history of the prospect, (vii) a criminal background check of the prospect and (viii) at least one personal reference or recommendation of the prospect.

In some implementations, the prospect rating can include assigning a value or range of values to the future earning potential or anticipated success of the prospect based on a variety of factors. Such factors that may act as inputs can include, for example, (i) the age of the prospect, (ii) the education of the prospect, (iii) skills or experiences of the prospect, (iv) the personal contacts of the prospect, (v) past income of the prospect, and the like. As to the education of the prospect, the valuation can be based on, for example, (i) educational institution(s) attended by the prospect, (ii) courses taken by the prospect, (iii) the major of the prospect, (iv) the types of internships performed by the prospect, (iv) grades of the prospect in individual courses and/or overall grades of the prospect, and the like. In some implementations, the inputs are analyzed by a valuation engine that compares each input with aggregated data of other prospects or individuals in order to estimate the future income or success of the prospect. In some implementations, the valuation can generate a recommendation to the prospect to increase their likelihood of success or future income by changing one or more aspects of their inputted information. Stated another way, the valuation engine can provide advice to a prospect or other individual to maximize their revenue or optimize other preferences of the prospect and may recommend career paths to the prospect. For example, the valuation engine may determine that the prospect will increase their chances of success and/or increased future income by (i) learning a further language, (ii) changing their concentration of study (e.g., major), (iii) by changing educational institutions, (iv) by taking one or more additional courses, (v) by pursuing an additional degree, (vi) by obtaining a specific internship or type of internship, (vii) by seeking counsel of a particular backer or type of backer, (viii) by changing their geographic location or base of operation, and the like. Such criteria can also be used to adjust the prospect profile rating.

In further embodiments, the method can further include providing the prospect access to a database of backers via a processor. If desired, the method can further include providing the prospect with means for requesting a social media connection to another individual having a profile on the social media platform to permit the prospect to develop a personal network of connections within the social media platform. The method can still further include providing means to the prospect for importing a list of contacts into a portion of the prospect's profile from a software application, as well as providing means to the prospect to provide a link on the prospect's profile page to a profile of the prospect on another online social media platform. If desired, the online prospect profile page can include a field that can be populated with content provided by viewer of the prospect profile page. The online prospect profile page can include an actuator to permit a backer to engage in a negotiation with the prospect to enter into an agreement with the backer. The method can further include providing means to execute a transfer of funds from a backer to the prospect. In some embodiments, funds can transfer through the social media platform. In other embodiments, funds are transferred from backer to prospect without passing through a bank account associated with the social media platform or entity responsible for administering the platform. For example, funds can be transferred directly from backer to prospect, or through a third entity.

In some implementations, the method can further include receiving backer offer information relating to the prospect from at least one backer via processor, analyzing the backer offer information via processor, generating an offer from the backer to the prospect, and forwarding the offer to the prospect via processor. Receiving the backer offer information can includes one or more of (i) receiving backer percentage request input from the backer via processor, the backer percentage request input indicating an amount of future prospect earnings the backer wishes to receive in exchange for value, (ii) receiving backer term input from the backer via processor, the backer term input indicating a time period over which the wishes to receive future prospect earnings, (iii) receiving backer service request input from the backer via processor, the backer service request input indicating at least one prospect service the backer wishes to receive in exchange for value, (iv) receiving backer capital offer input from the backer via processor, the backer capital offer input indicating an amount of capital the backer is willing to exchange for future prospect earnings or at least one prospect service, (v) receiving backer service offer input from the backer via processor, the backer service offer input indicating at least one service the backer is willing to exchange for future prospect earnings or at least one prospect service, (vi) receiving backer geographic input from the backer via processor, the backer geographic input indicating a geographic region of interest of the backer, and (vii) receiving backer prospect input from the backer via processor, the backer prospect input indicating at least one attribute that the backer seeks in a prospective prospect.

In other implementations, the offer can further include receiving rejection information from the prospect indicating that the prospect declined the offer via processor, and forwarding the rejection information to the backer. The method can further include (i) receiving revised backer offer information from the backer via processor, (ii) analyzing the revised backer offer information via processor (iii) generating a revised offer from the backer to the prospect, and (iv) forwarding the revised offer to the prospect via processor. If desired, the method can include (i) receiving counteroffer information from the prospect via processor, the counteroffer information indicating terms acceptable to the prospect, (ii) analyzing the counteroffer information via processor, (iii) generating a counteroffer from the prospect to the backer, and forwarding the counteroffer to the backer via processor.

In some implementations of the method, backer offer information relating to the prospect can be received from two or more backers, and the method can further include conducting an auction via processor for at least one of (i) future earnings of the prospect, and (ii) at least one service of the prospect.

In other implementations, at least one backer can input backer offer information, generate an offer using the backer offer information, and forwards the offer to the prospect via processor. The offer can include at least one of (i) backer percentage request information indicating an amount of future prospect earnings the backer wishes to receive in exchange for value, (ii) backer term information indicating a time period over which the wishes to receive future prospect earnings, (iii) backer service request information indicating at least one prospect service the backer wishes to receive in exchange for value, (iv) backer capital offer information indicating an amount of capital the backer is willing to exchange for future prospect earnings or at least one prospect service, (v) backer service offer information indicating at least one service the backer is willing to exchange for future prospect earnings or at least one prospect service, and (vi) backer geographic information indicating a geographic region of interest of the backer.

In some embodiments, the prospect can review the offer, and forward a rejection of the offer to the backer. If so desired, the backer can input revised backer offer information, generate a revised offer using the backer offer information, and forward the revised offer to the prospect via processor. In some implementations, the prospect can review the offer (e.g., via processor), prepare a counteroffer indicating terms acceptable to the prospect, and forward the counteroffer to the backer via processor. In some embodiments, a plurality of backer offers can be received by the prospect, and the prospect can initiate an auction process via processor for at least one of (i) future earnings of the prospect, and (ii) at least one service of the prospect.

In some implementations, the method can further include providing a portal for backers to exchange ownership interests in future earnings or services of the prospect. The method can also include providing means for having the prospect consent to having ownership interests in future earnings or services of the prospect transferred from a first backer to a second backer. If desired, the method can further include means for investing in the future earnings of a plurality of prospects by purchasing a single financial instrument.

In some embodiments, the method can include providing means for submitting at least one of (i) a review of the prospect, (ii) a recommendation of the prospect and (iii) a rating of the prospect. If desired, the method can further include providing means for setting milestones for the prospect. The milestones can be set, for example, by at least one of (i) the prospect, (ii) an administrator of the social media platform, and (iii) a backer. A payment can be made, for example, from the backer to the prospect upon completion of at least one of the milestones. The milestone can relate to one or more, for example of (i) achieving a particular grade point average, (ii) achieving a minimum grade on a standardized test (e.g., MCAT, GMAT, GRE, LSAT), (iii) obtaining an award for work performed, and the like. Moreover, the magnitude of the milestone payment can be established in the funding agreement to be dependent on performance of the prospect. Thus, for example, milestone payments can increase with higher academic performance, test scores, awards, higher placement in competitions (e.g. auto races, athletic events, etc.).

The prospect can be, for example, one or more of (i) a film maker, (ii) a vocal performer, (iii) a sculptor, (iv) a painter, (v) an archaeologist, (vi), an athlete, (viii) a politician, (ix) a social reformer, (x) an entrepreneur, (xi) an institution, (xii) a graphic artist, (xiii) a celebrity and (xiv) an author, (xv) a group of people, and the like. The institution can be, by way of example only, (i) an opera company, (ii) an educational institution, (iii) a youth organization, (iv) a charity, and the like. The group of people can be, for example, a sports team, a musical band, and the like.

In further implementations, the method can further include receiving backer profile information from a first backer via processor and storing the backer profile information in a backer database. The backer profile information can include identifying backer profile information to be verified and backer profile information relating to at least one interest of the backer. The method can further include one or more of verifying the identifying backer profile information, generating backer verification information to confirm verification of the identifying backer profile information, storing the backer verification information in the backer database, populating an online backer profile page with the backer profile information, and making the online backer profile page accessible to be viewed by at least one registered user of the online social media platform. The backer can be, for example, at least one of (i) a philanthropist, (ii) an artistic institution, (iii) a professional investor, (iv) a member of the general public, (v) a political organization, (vi) an athlete, (viii) an entrepreneur, (xi) a financial institution, (xii) a celebrity, (xiii) an educational institution (ix) an accredited investor, and (x) a relative or friend of the prospect, among others. The artistic institution can be, for example, one of (i) an opera company, (ii) a media company, (iii) a movie studio, and (iv) a museum, among others.

In some implementations, the backer profile information can include, for example, one or more of (i) a backer service available to help meet the prospect achieve the prospect goal, (ii) at least one geographic region in which the backer operates, (iii) the educational background of the backer, (iv) a listing of hyperlinks to profile pages of prospects that the backer has previously worked with, (v) a rating of the backer, (vi) a listing of business contacts of the backer, and the like. The backer service can include at least one of (i) a mentoring service (ii) a networking service to help the prospect develop their network, (iii) voice lessons, (iv) acting lessons, (v) dance lessons, and the like.

For backer or prospect profile pages, lists of social media or other contacts can be provided. Such lists can be selectively filtered to remove identifying information for contacts, and can provide sufficient information to help identify the nature of the contact. For example, a backer profile may have links to high profile individuals in various industries. Thus, for example, instead of listing Donald Trump by name, such an individual could be listed by way of (i) approximate net worth, (ii) an indication that they are a famous television or media personality, (iii) and that they have significant influence in particular areas of the business world (e.g., real estate).

In some embodiments, the method can include providing a rating of a backer. Such ratings can be based on objective and/or subjective criteria. In some implementations, only individuals that have had direct interactions with the backer through the system (e.g., one or more prospects) are given one or more opportunities to rate the backer. A backer can be based a variety of criteria, such as (i) whether the backer made one or more payments to a prospect as agreed, (ii) whether the backer was responsive to a prospect request within a reasonable time frame, (iii) whether the backer followed through on promises to the prospect, (iv) a rating on the quality of the results of the prospect's interactions with the backer, (v) public visibility of the backer, and the like. For example, a backer can be rated on a scale (e.g., from 1 to 10 or other suitable scale, with 1 indicating poor performance and 10 indicating superior performance). As to making payments, the backer can be rated on objective criteria such as whether payments were made on time and in the appropriate amounts to the prospect. The backer can be rated subjectively by prospect's on their personality on a scale (e.g., a 1-10 scale as set forth above) on qualities such as: (i) emotional supportiveness toward a prospect, (ii) demonstration of initiative to help a prospect, (iii) the quality of advice given to a prospect, (iv) the quality of contacts provided to a prospect, (v) whether the backer actively introduced the prospect to at least one contact and the quality of the introduction, (vi) quality of engagements that the backer arranged for the prospect, (vii) quality of commercial sponsors the backer arranged for the prospect, (viii) attentiveness of the backer toward the prospect, (ix) the degree to which the backer kept commitments to the prospect, and the like.

In some embodiments, the method can further include providing a recommendation engine for matching the prospect with at least one prospective backer, generating a recommendation via processor using the recommendation engine to identify the at least one prospective backer for the prospect by comparing the prospect profile information with backer profile information relating to the at least one prospective backer, and providing the recommendation to the prospect to initiate contact with the at least one prospective backer. The method can further include generating a ranking of a plurality of prospects, wherein the ranking of prospects is used by the recommendation engine to generate the recommendation. If desired, the method can further include providing the backer with means for requesting a social media connection to another individual having a profile on the social media platform to permit the backer to develop a personal network of connections within the social media platform.

In accordance with further embodiments, the method can further include providing means for the prospect to establish security settings for their online profile. If desired, the method can further include providing means to at least one of the prospect and backer to enter bank account information into a database. The method can further include providing means in the prospect profile for displaying content from a web page. The content can include, for example, a feed from the prospect's account on a different social networking platform, among other things. The prospect and/or backer profile can further aggregate content from other web pages in order to help assemble the profile, or to suggest content, connections, services or products to the prospect or backer.

In some implementations, the method can further include generating a prospect buyout agreement relating to the personal equity funding agreement for the prospect, the buyout agreement specifying terms and conditions for discharging the personal equity funding agreement. In some embodiments, the funding agreement can be discharged for monetary compensation. The value of such compensation can be established through a bidding process initiated by the prospect (or backer, if desired, if the backer wishes to monetize their interest). The prospect may choose to initiate a bidding process to obtain additional capital and/or to buy out an existing agreement with a backer. If desired, the prospect can have the option of not specifying that the prospect is initiating the bidding process to achieve a buyout amount, and can instead maintain the appearance that the prospect is simply seeking to raise more capital. Thus, if a prospect is in an agreement to provide 5% of their earnings for the next ten years, the prospect can seek to auction 5% of their earnings for the next ten years in order to determine the fair market present value of the existing agreement. In other implementations, the prospect can seek bidding of a multiple or a fraction of the amount in order to help maintain anonymity. Thus, in accordance with the above example, the prospect may seek to solicit bids on 1% of their income for the next ten years. The buyout amount for the agreement for 5% of their income would thus be multiplied by a factor of 5, and the buyout value would be established.

In some implementations, the prospect can reveal that they are seeking a valuation to buy out of an existing agreement. In such embodiments, the backer that is a party to the existing agreement can be required to submit a bid to establish valuation. Such a requirement may be triggered in the event it is determined that the bidder does not wish to exit the agreement. Various conditions may be selected in order to prevent the backer from overpricing the value of the buyout (and thus possibly prevent the buyout) of the agreement. For example, the backer can be required to provide additional capital to the prospect at the price bid by the backer in exchange for additional value from the prospect. Thus, in the above example, the backer could be required to buy 5% (or a fraction of that amount, e.g., 4%, 3%, 2% or 1%) of future prospect income for the bid upon amount. In other embodiments, the high bid may require the backer to pay a premium to the prospect on the value already obtained by the backer under the existing agreement. Thus, the backer may be required to pay the prospect the difference of the amount bid less amounts already paid to the prospect (or a fraction of such difference, such as 1%-99% in 1% increments). The bidding process can also include other backers, as desired. The process can include a prospect soliciting bids over a predetermined time period (e.g., one or more days, one or more weeks, or one or more months), receiving one or more bids, and then selecting one of the bids, or an average of the bids, to determine the valuation. Computing the valuation can include analyzing a population of bids, computing a mean of the bids in the population, and then discarding bids that fall more than the standard deviation from the mean. The remaining bids can then be averaged to determine the buyout value. In other implementations, a penalty can be assessed to the prospect for exiting the agreement. The penalty can be a set percentage (e.g., 1%-25%, in one percent increments) of the computed buyout value set forth above, or of the highest bid received in the process, as desired. In some implementations, the prospect can pay for the buyout, or in other embodiments, the buyout process can be exercised in order to switch to a different backer. A penalty can be assessed for switching backers (e.g., a percentage of the established value of the buyout) that can be borne by the prospect and/or new backer. In some embodiments, a penalty may not be assessed, such as where the backer subject to the existing agreement has a backer rating that is below or has fallen below a threshold value, reflecting that they are not an effective backer. Valuation auctions as described herein can be performed at predetermined time periods (e.g., quarterly), randomly by the platform, or upon demand by a prospect, backer, or administrator of the social networking platform, as desired. Such valuation processes can also be performed simply for valuation purposes and need not result in an agreement being exited or a new one entered.

In some implementations, a backer can establish a contest through the social media platform, wherein prospects can be invited to (or may simply apply) to win the contest. The prize for winning the contest can include money and/or services from the backer or others as described herein. The backer can specify parameters for the contest, including for example a time over which submissions from prospects will be accepted, the nature of the prize and the time of the drawing. The backer profile page can include advice for preparing for and submitting applications, and a prospect can choose to monitor the activity of the backer. The backer(s) of this embodiment (or of any other embodiment) can be well-known individuals of influence in various industries (e.g., recording industry, film industry, business world, and the like).

Content (e.g., newsfeeds, recommended connections, product placement, advertisements (e.g. for generating revenue) and the like) can be selected for delivery to the profile page of a backer or prospect or to an electronic mail or social media account in accordance with a variety of parameters, such as schools attended, industries in which the prospect or backer is involved, sex of the prospect or backer, people that the prospect or backer follow or are connected to on social media sites, consumer activity of the prospect or backer, or the like. In some implementations, cursor tracking and/or screen touches (as appropriate) can be used to log behavioral data of users of the platform. Screen hovers or clicks over particular content to track user behavior in a graphical user interface, gestures on a touch-sensitive interface, pupil tracking, etc., or logging of pages viewed can be used to select data that the system believes the user would find of interest.

In some implementations, a funding agreement can specify that future payments of a prospect are directed into a trust or other financial vehicle or institution (e.g., non profit or not-for-profit institution or entity, such as a non-profit corporation) for funding of other prospects. An initial source of capital can be collected from wealthy individuals, persons of influence or great notoriety and/or philanthropic organizations in order to fund prospects, such as prospects in under-served or underprivileged demographics or regions (e.g., third world countries). Such initial capital can be provided in any desired form, such as (i) an immediate transfer of liquid assets, (ii) a pledge of assets in the future, such as of life insurance proceeds or future income, or the like.

The disclosure also includes a method of operating an online social media platform that includes facilitating an introduction on the social media platform via processor between a prospect and a backer that wishes to invest capital and mentoring in the prospect, establishing an online connection between the prospect and backer via processor on the social media platform to facilitate the investment of at least one of (i) capital and (ii) mentoring in the prospect, providing a first set of online tools on the social media platform via processor to define a contractual relationship that delineates a plurality of parameters that define the investment of at least one of (i) capital and (ii) mentoring, and providing a second set of online tools via processor to ensure that the prospect pays money into an account controlled by an administrator of the social media platform as a condition of the contractual relationship.

In accordance with further aspects, the investment can include a capital contribution to the prospect and at least one of (i) an introduction by the backer to the prospect to a contact of the investor and (ii) a professional service to be rendered by the backer for the prospect. The professional service can be selected to improve a skill of the prospect. For example, the professional service can include at least one of (i) a voice lesson, (ii) a mentoring session and (iii) providing publicity for the prospect, among other things. Capital received by the prospect under the contract can include at least one of an amount received at the onset of the agreement, an amount to be paid during the term of the agreement, and amounts distributed over a predetermined time period. The prospect can pay money under the contract that is at least one of (i) a percentage of gross income, (ii) a percentage of after tax income and (iii) a flat fee. The contract can specify that the prospect pays money only if the prospect's income exceeds a threshold amount. The threshold amount can include at least one of (i) a fixed amount, (ii) a variable amount depending on cost of living of the geographic region in which the prospect resides and (iii) an amount based on the poverty line level for the geographic region in which the prospect resides.

In some implementations, the terms of the personal equity funding agreement can include at least one of (i) the name and current residence address of the prospect, (ii) the social security number or taxpayer ID number of the prospect, (iii) the prospect's date of birth, (iv) the prospect's marital status, (v) the educational background of prospect, (vi) the period of study of the prospect, (vii) the amount of investment sought, (viii) the date that the investment is desired, (ix) the purpose for the investment, (x) the repayment period, (xi) termination conditions of the agreement, (xii) privacy and confidentiality provisions, (xiii) an amount of future earnings to be repaid, (xiv) an upfront fee to be paid to administrator of social media platform, (xv) terms specifying prepayment of agreement by prospect, (xvi) bankruptcy provisions, (xvii) default and remedies provisions, (xviii) governing law and jurisdiction, (xix) assignability of the agreement; (xx) representations and warranties of backer and/or prospect; (xxi) an agreement to provide written permission to an administrator of the social media platform or the backer to obtain federal tax transcripts for one or a plurality of years during the term of the agreement, (xxii) written permission to deposit or remove a fixed amount of capital from a bank account of the prospect and (xxiii) written permission to permit an administrator of the social media platform or a backer to obtain payment under the funding agreement from the prospect directly from an employer or a bank account of the prospect. The prospect can agree to obtain permission from an individual that files taxes jointly with the prospect to provide the tax transcripts, or to file a tax return individually if that permission cannot be obtained. The representations and warranties by the prospect can include at least one of (i) a statement that no lawsuit is pending against the prospect that would impair performance under the agreement, (ii) a statement that the prospect has not defaulted on any material contract, (iii) a statement that the prospect has filed all tax returns and paid all taxes due, (iv) a statement that the prospect has no prior criminal convictions, and (v) a statement that the prospect has not filed for personal bankruptcy. The prospect may be able to enter two or more separate personal equity funding agreements via processor on the social media platform. At least two of the funding agreements can be between the prospect and different backers. Alternatively, at least two of the funding agreements can be between the prospect and the same backer. The agreements can have overlapping effective time periods such that the agreements are in force simultaneously for a first time period. If desired, the agreements may not have overlapping effective time periods such that the agreements are in force at different times. A percentage of future income to be paid by the prospect under the personal equity funding agreement can be established at least in part due to at least one of (i) a review of the backer by the prospect, (ii) a projected future income of the prospect and (iii) an amount of capital to be raised by the prospect. The review, recommendation, or rating of the prospect can be obtained from a third party social media platform or a third party website. The parties to the personal equity funding agreement can be the prospect and a first group of backers in their individual capacities. The parties to the personal equity funding agreement can include the prospect and a group of backers operating through a legal entity. The legal entity can be, for example, one of a corporation, a limited liability company, and a partnership.

In further implementations, the prospect services can relate to at least one of (i) an occupation of the prospect, (ii) a passion of the prospect and (iii) activities of the prospect. The reward can include at least one of (i) complimentary or reduced price admission to an event or project in which the prospect is participating or planning to participate, (ii) a complimentary or reduced price article relating to a passion, event or project of the prospect. The personal equity funding agreement can include an agreement to which the backer and prospect are parties. The personal equity funding agreement can include (i) a first agreement generated via processor between the backer and a third entity and (ii) a second agreement between the prospect and the third entity generated via processor. The third entity can include at least one of (i) an individual, (ii) an organization administering the social media platform (iii) an organization controlling the social media platform, and (iii) an affiliate of the social media platform. At least one of the backer and the prospect can elect to withhold their identity from the other while selecting to reveal their identity to the third entity prior to entering the agreement via processor. If desired, at least one of the backer and the prospect can elect to withhold their identity from the other party while selecting to reveal their identity to the third entity after entering the agreement via processor.

The disclosure also provides a method of operating an online social media platform, including facilitating an introduction via processor on the social media platform between a prospect and an investor that wishes to invest capital and mentoring in the prospect, establishing an online connection between the prospect and investor via processor on the social media platform to facilitate the investment of at least one of (i) capital and (ii) mentoring in the prospect, providing a first set of online tools via processor on the social media platform to define a contractual relationship that delineates a plurality of parameters that define the investment of at least one of (i) capital and (ii) mentoring, and providing an interactive tool to the prospect via processor to help the prospect determine a suitable amount of future income to exchange for the investment.

In some implementations, the interactive tool can be configured to permit the prospect to run at least one future prospect income scenario of the prospect via processor based on at least one input from the prospect. The at least one future prospect income scenario can be recorded via a processor to a disclosure file in a database. A plurality of prospect income scenarios can be recorded via processor to the disclosure file. If desired, all interactions of the prospect with the interactive tool can be recorded via processor to the disclosure file. Such disclosures may later be used in order to demonstrate the nature of the financial disclosures to the prospect. If desired, the interactive tool can be configured to illustrate rates of return of different types of investments to the prospect via processor having different risk levels to help the prospect to determine an appropriate amount of future income to exchange for the investment from the backer. The interactive tool can include a graphical user interface having a slider that can be dragged across a range from a first point to a second point via processor, wherein the range relates to the rate of return under the personal equity funding agreement. The graphical user interface can be configured to provide different images via processor illustrating different types of comparable investments as a function of the rate of return as the rate of return is being adjusted while moving the slider from a first location to a second location. The interactive tool can be adapted to recommend an amount of future prospect income via processor for the prospect to provide in exchange for the investment from the backer. The interactive tool can be used by the prospect to model future income projections via processor and determine the amount of future income to exchange for the investment before entering negotiations with a backer. The interactive tool can be configured to provide income projections via processor to the prospect, the income projections being based on at least one of (i) a career choice of a prospect, (ii) an undergraduate major choice of the prospect, (iii) a social security number of the prospect, (iv) an educational institution chosen by a prospect to attend, (v) a grade point average of the prospect, (vi) awards received by the prospect, (v) a major area of study declared by the prospect, (vi) a minor area of study declared by the prospect. If desired, the interactive tool can be configured to provide a financial disclosure summary via processor to at least one of (i) the prospect and (ii) the backer that describes at least one of (i) the impact or potential impact on the prospect of paying a percentage of earnings over a stated time period, (ii) an income level needed to be achieved by the prospect in order for a backer to break even in an investment in the prospect, (iii) the probability that a prospect will achieve a stated income level, (iv) the possibility that the prospect's identity could become known either directly or inferentially by the backer, and (v) potential tax consequences to the prospect for receiving capital. If desired, the method may further include providing at least one legal disclosure to the prospect or backer via processor from an administrator of the online social media platform. The at least one legal (or other) disclosure can describe at least one of (i) the condition, background or future career prospects of the prospect, (ii) the risk of loss of any funds invested in the prospect, (iii) the degree to which the legality of any agreement entered into with the prospect may or may not be enforceable and (iv) potential tax consequences from investing in a prospect, among other things. The condition, background and future career prospects of the prospect can be determined via a third party verification service via processor, as desired.

In some implementations, a disclosure can be provided via processor to the backer that includes eligibility criteria of the prospect to engage in the funding agreement that includes at least one of (i) information about the prospect provided by way of third parties, and (ii) information that is disclosed by the prospect. The eligibility criteria of the prospect can include at least one of (i) a description of pre-existing financial obligations of the prospect, and (ii) a description of any insolvency proceedings in which the prospect was involved personally or through a legal entity, (iii) an employment history of the prospect and (iv) a description of any criminal activity in which the prospect was involved or alleged to be involved.

The disclosure further provides a method of evaluating a future career of a prospect on an online social media platform via processor. The method includes receiving career input from the prospect via processor, analyzing the career input from the prospect via processor by comparing the career input from the prospect with benchmark career data in a database, and generating an evaluation via processor that summarizes the career prospects of the prospect. The evaluation can include assigning a value or a range of values via processor to the future career of the prospect. If desired, the evaluation can include assigning a rank to the prospect via processor. The evaluation can include delivering at least one recommendation to the prospect via processor to modify the career input to enhance the career prospects of the prospect. The career input can include, for example, at least one of (i) career interest data of the prospect, (ii) a desired retirement age for the prospect, (iii) a desired income range for the prospect, (iv) a maximum debt load the prospect is willing to commit to in order to achieve the prospect's career goals, and (v) a geographical region in which the prospect would like to engage in their career. The recommendation can include at least one of (i) recommended steps to maximize future potential revenue of the prospect and (ii) a recommendation of a career path for the prospect. The recommendation can include a recommendation delivered to the prospect via processor for the prospect to (i) learn another language, (ii) change a concentration of study, (iii) engage in further coursework, (iv) engage in a particular internship, (v) change educational institutions, (vi) pursue an additional degree, (vii) seek counsel of a particular backer on the platform or a particular type of backer, and (viii) change the geographic location in which the prospect wishes to work or reside. The evaluation can be generated by analyzing via processor at least one of (i) the age of the prospect, (ii) the education of the prospect, (iii) skills or experiences of the prospect, (iv) the personal contacts of the prospect, and (v) past income of the prospect. Analyzing the education of the prospect can include analyzing via processor at least one of (i) an educational institution attended by the prospect, (ii) an educational course of study taken by the prospect, (iii) internships performed by the prospect, (iv) grades of the prospect in major coursework of the prospect and (v) the overall grade point average of the prospect. The at least one milestone can include at least one of (i) achieving or exceeding a specified minimum grade point average, (ii) achieving or exceeding a minimum grade on a standardized test (e.g., MCAT, GMAT, GRE, LSAT), and (iii) obtaining an award for work performed. The magnitude of the milestone payment can be established via processor in the personal equity funding agreement to be dependent on performance of the prospect.

In some implementations, the profile page of the backer can include at least one of (i) a list of social media contacts, (ii) a list of business contacts; (iii) a list of personal contacts, (iv) a field showing prospects invested in by the backer, (v) a histogram illustrating any backers that the backer may have had in the past, (vi) recommendations of the backer by prospects, (vii) recommendations of the backer by third parties, (viii) a field indicating a rating of the backer, (ix) a field explaining a rating of the backer. The contacts of the backer listed on the backer profile page can be organized and categorized via processor based on the professional activities of the contacts.

In some implementations, the method can include assigning a backer rating to the backer via processor based on at least one of (i) objective criteria and (ii) subjective criteria. The criteria can include at least one of (i) whether the backer adhered to the financial terms of the personal equity funding agreement, (ii) whether the backer was responsive to a communication from a prospect within a predetermined time frame, (iii) whether the backer followed through on a promise to a prospect, (iv) a rating on the quality of the results of a prospect's interactions with the backer, and (v) public visibility of the backer. The basis of the subjective criteria can include at least one of (i) emotional supportiveness toward the prospect, (ii) demonstration of initiative to help the prospect, (iii) the quality of advice given to the prospect, (iv) the quality of contacts provided to the prospect, (v) whether the backer actively introduced the prospect to at least one contact and the quality of the introduction, (vi) the quality of engagements that the backer arranged for the prospect, (vii) the quality of commercial sponsors the backer arranged for the prospect, (viii) the attentiveness of the backer toward the prospect, and (ix) the degree to which the backer kept commitments to the prospect. In some implementations, only individuals that have had direct interactions with the backer through the online social media platform can be permitted to rate the backer via processor.

In some implementations, the personal equity funding agreement can be discharged for monetary compensation via a buy out of the existing agreement via processor. If desired, the monetary compensation is established through agreement of the parties, or by way of a bidding process via processor, among other techniques. The bidding process is initiated by the prospect via processor, to achieve, for example, at least one of (i) obtaining additional capital and (ii) buying out an existing agreement with a backer. The prospect can make it known to others via processor that the prospect is initiating the bidding process. The value of the monetary compensation can also be established through a bidding process initiated by the backer via processor. The prospect can reveal to at least one other individual via processor that the prospect is soliciting a valuation to buy out of an existing agreement with the backer. In some embodiments, the backer can be required to submit a bid via processor to establish valuation. The requirement for the backer to submit a bid via processor to establish valuation can be triggered by backer not wishing to terminate the agreement that is in place.

In further implementations, the method can further include providing conditions via processor to prevent the backer from overpricing the value of the buyout, including at least one of (i) requiring the backer to provide additional capital to the prospect based on the price bid by the backer, (ii) requiring the backer to pay a premium to the prospect on the value already obtained by the backer under the existing agreement, and (iii) requiring the backer to pay the prospect the difference or a fraction of the difference of the amount bid less amounts already paid to the prospect. The bidding process can involve other backers on the online social media platform who are otherwise not engaged in a funding agreement with the prospect. The bidding process can include at least one of (i) the prospect soliciting bids via processor over a predetermined time period, (ii) the prospect receiving one or more bids via processor (iii), the prospect selecting one of the bids via processor, (iv) the prospect selecting an average of the bids via processor, and (v) computing the buyout valuation from the average of the bids via a processor. If desired, the bidding process can include analyzing a population of bids via processor, computing a mean of the bids in the population via processor or performing a different mathematical operation to obtain a representative bid, discarding bids that fall more than the standard deviation from the mean via processor, and averaging the remaining bids to determine the buyout valuation via processor.

In some implementations, the method can include assessing a penalty via processor to at least one of the prospect and the backer for exiting the agreement early. The conditions for assessing the penalty can be specified in the personal equity funding agreement. The penalty can include, for example, at least one of (i) a fixed percentage of the computed buyout value, (ii) a fixed percentage of a highest bid received in the bidding process, and (iii) a flat fee. The prospect can initiate the buyout process via processor and the penalty can be borne by the prospect. In other implementations, the

The backer can initiate the buyout process via processor and the penalty can be borne by the backer accordingly. The backer can be a party to the personal equity funding agreement sought to be terminated by the bidding process. In other implementations, the backer that initiates the buyout process can be a new backer that is not a party to the original personal equity funding agreement, wherein the new backer wishes to form a new personal equity funding agreement with the prospect via processor. The prospect can initiate the bidding process via processor, and if desired, a penalty may not be assessed against the prospect when the backer has a backer rating that is below a threshold value reflecting that the backer is ineffective. The bidding process can take place via processor (i) over a predetermined time period (ii) at a randomly selected time by the online social media platform and/or (iii) on demand by the prospect, backer, or an administrator of the online social media platform. If desired, the personal equity funding agreement can be valued through a bidding process via processor without canceling the agreement.

The disclosure also provides a method that further includes establishing a contest by the backer via processor, wherein the prospect can be invited to apply to win the contest via processor, wherein a prize for winning the contest can include receiving at least one of capital and services from the backer. The backer can specify parameters for the contest via processor, the parameters including at least one of (i) a time period during which submissions from prospects will be accepted (ii) the nature of the prize (iii) the time of the drawing and (iv) at least one action that the prospect has to perform that will be evaluated by the backer in determining the winner of the contest. In various embodiments, the backer profile page can include advice for prospects on preparing for and submitting applications to the contest. Content can be selected for delivery to the backer profile page via processor in accordance with a plurality of parameters. The content can include at least one of (i) newsfeeds, (ii) recommended social media connections, (iii) product placement, and (iv) advertisements for generating revenue. The plurality of parameters can include at least one of (i) a school attended by the backer or that the backer is following, (ii) an industry in which the prospect or backer is involved, (iii) the gender of the backer, (iv) people that the backer follow or are connected to on social media sites, and (iv) consumer activity of the backer.

Various implementations can also include logging behavioral data of users of the online social media platform via processor. For example, the behavioral data can be logged via processor via at least one of a graphical user interface, gestures on a touch-sensitive interface, movement of a pointing device, and pupil tracking. The behavioral data can be analyzed via processor to determine appropriate content to send to the user.

The disclosure further provides a method of operating an online social media platform, including facilitating an introduction on the social media platform via processor between a prospect and a backer that wishes to invest capital and mentoring in the prospect, establishing an online connection between the prospect and backer via processor on the social media platform to facilitate the investment of at least one of (i) capital and (ii) mentoring in the prospect, and providing a first set of online tools on the social media platform via processor to define a contractual relationship that delineates a plurality of parameters that define the investment of at least one of (i) capital and (ii) mentoring, wherein the contractual relationship specifies that future payments of the prospect are to be used to fund other prospects within the online social media platform.

In various implementations, the future payments of the prospect can be directed via processor into at least one of (i) a trust or other financial instrument, (ii) a nonprofit or not-for-profit institution or entity; and (iii) a corporation or other for profit entity. The prospect can decide which other prospects are funded by their payments via processor. The path of money paid by the prospect can be traced via processor to each prospect that the prospect funds with their payments to show the progression of successive investments of the money paid by the prospect.

In some implementations, the method can further include computing via processor the return on the money invested by the prospect in other prospects. If desired, the method can further include displaying via processor a virtual account for the prospect showing the amount of revenue generated by the prospect's investment in other prospects. If desired, the method can include displaying via processor a virtual account for the backer showing the amount of revenue generated by the backer's investment in the prospect, and further prospects chosen by the prospect. The virtual account can display a virtual account balance via processor including the sum of all revenues generated as a result of the backer's initial investment. The method can further include generating an incremental reward via processor for the backer when an investment by the backer into at least one prospect produces a monetary return based on an affiliation that the online social media platform has with a third party. The third party can be a sponsor of the social media platform. For example, the third party can be an airline, and the incremental reward can include airline reward points for the airline. In another embodiment, the third party can be a company producing retail merchandise, and the incremental reward can permit a recipient of the reward to purchase the retail merchandise.

In some implementations, the method can further include receiving booster capital from a booster via processor, wherein the booster capital is provided by the booster via processor without commitment to remunerate the booster. The booster can include at least one of (i) a wealthy individual, (ii) a person of influence, (iii) a person of notoriety, and (iv) a philanthropic organization. The booster capital can include at least one of (i) an initial source of capital collected to fund the prospect (ii) an immediate transfer of liquid assets (iii) a pledge of assets in the future, and (v) a pledge of life insurance proceeds or future income. In some implementations, the booster capital can only be used to fund prospects. Similarly, in some implementations, payments made by a first prospect funded with booster capital can only be used to fund other prospects. If desired, the other prospects that receive such payments can be chosen by the first prospect. Similarly, the booster can specify what types of projects the booster capital can be used for. In some implementations, all funds received from a backer are treated as booster capital if the amount of money is below a threshold amount, such as $500(US). In some implementations, perks can be given to a booster at the discretion of the recipient after receiving booster capital.

In further implementations, funds can be transferred from an account of the backer to an escrow account via processor after the backer capital offer input is received. If desired, at least some of the funds can be transferred from the escrow account into the prospect's account via processor after the prospect selects the backer and assents to the funding agreement. The funds can be returned to the backer's account via processor if they are not selected by the prospect. A hold can be placed on funds in an account via processor of the backer after the backer capital offer input is received. At least some of the funds can be transferred from the backer's account into at least one of an escrow account and the prospect's account via processor after the prospect selects the backer and assents to the funding agreement. The hold can be released on the funds in the backer's account via processor if the backer is not selected by the prospect. If desired, the social networking platform can initiate an ACH transaction via processor after the backer capital offer input is received. For example, the social networking platform can instruct a financial institution via processor to make a claim against the backer's account after receiving authorization from the backer to do so. The social networking platform can release the ACH hold via processor if the backer is not selected by the prospect. In some implementations, the social media platform can be configured to automatically provide tax information to backers and prospects via processor.

In further accordance with the disclosure, amounts paid back by the prospect during the first year of repayment required by the personal equity funding agreement can be based on computations from an income projection estimate performed via processor on the social networking platform. For example, in some implementations, the social media platform can receive by processor actual income input from the prospect at the end of the first year of repayment, the social media platform can compare the actual income input of the prospect with the projected income of the prospect via processor, and the social media platform can determine via processor any amounts to be paid to or from the prospect in order to satisfy the requirements of the personal equity funding agreement. If desired, the prospect can make quarterly, monthly, or annual payments to the backer via processor under the personal equity funding agreement. In some embodiments, funds received in the backer's account from the prospect may be removed or reinvested by the backer via processor. In other embodiments, the portion of payments can be automatically reinvested in other prospects via processor. The other prospects can be selected by the backer via processor. The other prospects can be selected by the prospect via processor. The other prospects can be selected by an administrator of the social media platform via processor. If desired, the prospect can specify what types of activities the payments can be used to pay for via processor. If desired, the portion of payments can be used to purchase mentorship outside of the prospect's network. In some implementations, the portion of payments can be expressed in a non-monetary denomination (i.e., not government issued legal tender), such as reward “points” or credits. If desired, capital that is unused by a prospect can be automatically deposited via processor into a general fund managed by an administrator of the social media platform. Money invested by a backer can be automatically applied to at least one prospect via processor.

In some implementations, at least one prospect can become automatically fully funded via processor once having reached a predetermined percentage of desired funding. The predetermined percentage of desired funding ranges from 0 to 99 percent in increments of one percent, such as 20, 30, 40, 50, 55, 60, 65, 70, 75, 80, 85, 90 and 95 percent, or percentages between those values. In some embodiments, criteria determining the automatic application of the money can be established by the backer via processor. Information disclosed by the prospect can include a description of any moral obligations or philosophical opinions the prospect has that could impact their ability to fulfill their obligations under the funding agreement. The pre-existing financial obligations of the prospect can include, for example, at least one of (i) a description of all legal debts to which the prospect is obligated, (ii) any alimony payments for which the prospect is responsible and (ii) a description of any civil judgments against the prospect. Criteria can be evaluated via processor to generate the backer rating via processor by analyzing feedback received from prospects with whom the backer has worked or third parties that know the backer. In some implementations, a backer can provide backer level input via processor relating to a level of commitment desired by the backer, wherein different backer levels require increasing amounts of commitment on the part of the backer. In some implementations, at least three backer levels can be provided via processor. However, one, two, three, four, five or more can similarly be provided. For example, a first, basic backer level can require only providing capital to a prospect. A second, intermediate, backer level can require, for example, at least one of (i) periodic communications between the backer and prospect, and (ii) providing professional introductions by the backer to the prospect. A third, upper backer level can require at least one of (i) a weekly telephone conference with the prospect to discuss the prospect's progress, (ii) in-person mentorship meetings with the backer and prospect at regular time intervals, and (iii) active endorsement of the prospect by the backer in a public forum.

If desired, the backer can change their backer level via processor during the term of the personal equity funding agreement. The remuneration to the backer can be affected by the backer choosing to change their backer level. The effect on the backer's remuneration of the backer changing the backer level can be specified in the personal equity funding agreement. Choosing a higher backer level can result in the backer being provided with privileges not available at a lower backer level, such as increased access to members of the platform, and interactive features on the platform, such as for locating platform members and being able to communicate with other platform members.

The disclosure further provides a method of operating an online social media platform, including facilitating an introduction on the social media platform via processor between a prospect and a backer that wishes to invest capital and mentoring in the prospect, establishing an online connection between the prospect and backer via processor on the social media platform to facilitate the investment of at least one of (i) capital (ii) mentoring in the prospect, and providing a set of online tools on the social media platform via processor to generate a map of circles of influence relating to at least one of the prospect and the backer, and displaying the map via processor. The map can illustrate via processor who the backer and prospect are affiliated with. Circles of influence can be determined via processor based on a common interest of a plurality of users of the social media platform. The recommendation can be generated via processor at least in part due to at least one material factor. The at least one material factor can include at least one of (i) a shared passion of the backer and prospect, (ii) a common educational institution shared by the backer and prospect, (iii) a common region of origin shared by the backer and the prospect, (iv) a common profession of the backer and prospect, and (v) a common favorite sports team of the backer and prospect. For example, the backer can be a brand name manufacturer or an institution, and the act of sponsoring a prospect permits the backer to advertise that they are sponsoring the prospect.

The disclosure provides a method of operating an online social media platform, including facilitating an introduction on the social media platform via processor between a prospect and a backer that wishes to invest capital and mentoring in the prospect, establishing an online connection between the prospect and backer via processor on the social media platform to facilitate the investment of at least one of (i) capital and (ii) mentoring in the prospect, and providing a first set of online tools on the social media platform via processor to define a contractual relationship that delineates a plurality of parameters that define the investment of at least one of (i) capital and (ii) mentoring, wherein the contractual relationship specifies that future payments of the prospect under the contract are to be used for charitable purposes.

In accordance with further aspects, the future payments of the prospect can be directed into a not-for-profit institution for funding of other prospects. The future payments of the prospect can be directed into a trust for funding of other prospects. Funds can be provided to the prospect under the personal equity funding agreement on a prepaid payment card, such as one that can operate on the VISA, MasterCard, American Express, PayPal or Discover payment networks.

The disclosure alto provides a method of operating an online social media platform, including facilitating an introduction on the social media platform via processor between a prospect and a backer that wishes to invest capital and mentoring in the prospect, establishing an online connection between the prospect and backer via processor on the social media platform to facilitate the investment of at least one of (i) capital and (ii) mentoring in the prospect, and providing an online discussion board portal on the social media platform via processor where a prospect can initiate a discussion with one or more individuals on the social networking platform.

In some implementations, the prospect can define a sub-community of users within the social media platform to participate with the prospect on the discussion board portal. The users can include backers with whom the prospect has entered into a personal equity funding agreement, among others.

A message can be generated and routed to at least one individual when the prospect initiates a discussion on the discussion board portal. In some implementations, the message is only routed to backers that wish to receive the message. In some embodiments, a backer at a first level of mentoring participation with the prospect automatically opts out of receiving the message. If desired, a backer at a second level of mentoring participation with the prospect that is higher than the first level involved can automatically opt into of receiving the message. In some implementations, the discussion board portal can be displayed within a profile page of the prospect. The discussion can include a question that the prospect wants answered. The prospect can be able to direct the question to all users of the social media platform. If desired, the method can further include directing the question to an administrator for approval prior to directing the message to all users of the social media platform. If desired, the prospect or other individual can set permissions to permit different users to view the discussion portal. The method can further include directing a discussion thread on the portal to a second online social media platform. The second online social media platform can be, for example, the Facebook® platform, the LinkedIn® platform, the Twitter® platform, or another platform.

In some implementations, the personal equity funding agreement can provide for a penalty if one of the parties to the personal equity funding agreement does not abide by the terms of the agreement. The penalty can include, for example, at least one of (i) being denied contact with other users of the platform, (ii) having a quality rating of the non-abiding party degraded, (iii) being denied the ability to enter into another personal equity funding agreement until the defect is cured and (iv) a monetary penalty. In further implementations, if desired, the personal equity funding agreement is not closed and funded until a prospect's funding goal is reached.

The aforementioned methods may also be implemented as social media platforms, computer readable programs, and graphical user interfaces, many of which are described further herein. It will be appreciated by those of skill in the art that the aforementioned description of various methods supports implementing the methods in such various manners.

The disclosure further provides various online social media platforms. Such platforms can include, for example, a server for receiving prospect profile information from a first prospect via processor and means for storing the prospect profile information in a prospect database. The prospect profile information preferably includes personal prospect profile information to be verified, and prospect profile information relating to at least one aspiration of the prospect. The platform can further include means for verifying the personal prospect profile information, means for generating verification information to confirm verification of the personal prospect profile information, means for storing the verification information in the prospect database, means for populating an online prospect profile page with the prospect profile information, and means for making the online prospect profile page accessible to be viewed by at least one registered user of the online social media platform.

In some implementations, the online social media platform can further include means for generating a personal equity funding agreement for the prospect. The personal equity funding agreement can specify terms and conditions for obtaining at least one of (i) monetary funding and (ii) backer services from at least one backer in exchange for at least one of (i) a portion of the prospect's future earnings over a first predetermined time period, and (ii) prospect services of the prospect over a second predetermined time period. The means for generating the personal equity funding agreement can include at least one of (i) means for receiving prospect percentage offer input from the prospect via processor, the prospect percentage offer input indicating an amount of future earnings the prospect is willing to exchange for value, (ii) means for receiving prospect term input from the prospect via processor, the prospect term input indicating a time period over which the prospect is willing to provide future earnings in exchange for value, (iii) means for receiving prospect service offer input from the prospect via processor, the prospect service offer input indicating at least one service the prospect is willing to exchange for value, (iv) means for receiving prospect capital request input from the prospect via processor, the prospect capital request input indicating an amount of capital the prospect seeks to obtain, (v) means for receiving prospect service request input from the prospect via processor, the prospect service request input indicating at least one service the prospect seeks to obtain, (vi) means for receiving prospect geographic input from the prospect via processor, the prospect geographic input indicating a geographic region of interest of the prospect, and (vii) means for receiving prospect backer input from the prospect via processor, the prospect backer input indicating at least one attribute that the prospect seeks in a prospective backer.

If desired, the prospect percentage offer input can indicate a maximum amount of future earnings the prospect is willing to exchange for value. The prospect term input can indicate the maximum or minimum time period over which the prospect is willing to provide future earnings in exchange for value. If desired, the prospect capital request input can indicate the minimum amount of capital the prospect seeks to obtain. In further implementations, the online social media platform can further include means for making at least a portion of the information contained on the online prospect profile page accessible to be viewed by at least one backer after the prospect has assented to the personal equity funding agreement. The platform can further include means for selectively revealing the identity of the prospect to at least one other user of the platform. By way of further example, the online social media platform can further include means for displaying at least one of the following on the online prospect profile page (i) a description of a prospect goal, (ii) an amount of capital sought by the prospect to help meet the prospect goal, (iii) one or more backer services sought by the prospect to help meet the prospect goal, (iv) an amount of equity the prospect is willing to exchange for capital or backer services, (v) a description of prospect services available to be exchanged for capital or backer services, (vi) at least one geographic region in which the prospect operates, (vii) the educational background of the prospect, (viii) a picture of the prospect, (ix) a sample of the prospect's work, (x) a timeframe in which the prospect desires to accomplish a goal, (xi) prior accomplishments of the prospect, (xii) GPS coordinate information of the prospect, and the like.

The online social media platform can similarly include means for generating a prospect rating to the prospect, the prospect rating being based at least in part on the prospect profile information. The means for generating the prospect rating can be adapted to generate the prospect rating based on at least one of (i) a credit score or credit rating, (ii) a prior achievement of the prospect, (iii) a subjective review by an individual that is familiar with the prospect, (iv) earning potential of the prospect, and the like. The services of the prospect over a predetermined time period can include, for example, one or more of (i) execution of an artistic work, (ii) execution of a literary work, (iii) execution of a cinematic work, (iv) a personal appearance and (v) a consulting arrangement, among others. The means for verifying can be adapted to verify one, for example, or more of (i) the age of the prospect, (ii) the identity of the prospect, (iii) the social security number of the prospect, (iv) the tax identification number for the prospect, (v) a legal address of the prospect, (vi) the credit history of the prospect, (vii) a criminal background check of the prospect and (viii) at least one personal reference or recommendation of the prospect.

In some implementations, the online social media platform can further include means for providing the prospect access to a database of backers via processor. If desired, the online social media platform can further include means for providing the prospect with means for requesting a social media connection to another individual having a profile on the social media platform to permit the prospect to develop a personal network of connections within the social media platform. The online social media platform can further include means for importing a list of prospect contacts into a portion of the prospect's profile from a software application. The platform can further include means for providing a link on the prospect's profile page to a profile of the prospect on another online social media platform.

In some implementations, the online prospect profile page can include a field that can be populated with content provided by viewer of the prospect profile page. The online prospect profile page can include an actuator to permit a backer to engage in a negotiation with the prospect to enter into an agreement with the backer. If desired, the platform can further include means for executing a transfer of funds from a backer to the prospect.

In further implementations, the online social media platform can include means for receiving backer offer information relating to the prospect from at least one backer via processor, means for analyzing the backer offer information via processor, means for generating an offer from the backer to the prospect, and means for forwarding the offer to the prospect via processor. The means for receiving backer offer information can include one or more of (i) means for receiving backer percentage request input from the backer via processor, the backer percentage request input indicating an amount of future prospect earnings the backer wishes to receive in exchange for value, (ii) means for receiving backer term input from the backer via processor, the backer term input indicating a time period over which the wishes to receive future prospect earnings, (iii) means for receiving backer service request input from the backer via processor, the backer service request input indicating at least one prospect service the backer wishes to receive in exchange for value, (iv) means for receiving backer capital offer input from the backer via processor, the backer capital offer input indicating an amount of capital the backer is willing to exchange for future prospect earnings or at least one prospect service, means for receiving backer service offer input from the backer via processor, the backer service offer input indicating at least one service the backer is willing to exchange for future prospect earnings or at least one prospect service, means for receiving backer geographic input from the backer via processor, the backer geographic input indicating a geographic region of interest of the backer, and means for receiving backer prospect input from the backer via processor, the backer prospect input indicating at least one attribute that the backer seeks in a prospective prospect.

In some implementations, the online social media platform can include means for receiving rejection information from the prospect indicating that the prospect declined the offer via processor, and means for forwarding the rejection information to the backer. If desired, the platform can further include means for receiving revised backer offer information from the backer via processor, means for analyzing the revised backer offer information via processor, means for generating a revised offer from the backer to the prospect, and means for forwarding the revised offer to the prospect via processor. In some embodiments, the online social media platform can include means for receiving counteroffer information from the prospect via processor, the counteroffer information indicating terms acceptable to the prospect, means for analyzing the counteroffer information via processor, means for generating a counteroffer from the prospect to the backer, and means for forwarding the counteroffer to the backer via processor.

In further embodiments, the online social media platform can include means for receiving backer offer information relating to the prospect from at least two backers, and means for conducting an auction via processor for at least one of (i) future earnings of the prospect, and (ii) at least one service of the prospect.

In some implementations, the online social media platform can include means for at least one backer to input backer offer information, means for generating an offer using the backer offer information, and means for forwarding the offer to the prospect via processor. The means for generating can generate an offer including at least one of (i) backer percentage request information indicating an amount of future prospect earnings the backer wishes to receive in exchange for value, (ii) backer term information indicating a time period over which the wishes to receive future prospect earnings, (iii) backer service request information indicating at least one prospect service the backer wishes to receive in exchange for value, (iv) backer capital offer information indicating an amount of capital the backer is willing to exchange for future prospect earnings or at least one prospect service, (v) backer service offer information indicating at least one service the backer is willing to exchange for future prospect earnings or at least one prospect service, and backer geographic information indicating a geographic region of interest of the backer, among other things. The platform can further include means for permitting the prospect to review the offer, and means for permitting the prospect to forward a rejection of the offer to the backer.

In some implementations, the online social media platform can similarly include means to permit the backer to input revised backer offer information, means for generating a revised offer using the backer offer information, and means to permit the backer to forward the revised offer to the prospect via processor. The platform can further include (i) means for permitting the prospect to review the offer via processor, (ii) means to permit the prospect to prepare a counteroffer indicating terms acceptable to the prospect, and (iii) means to permit the prospect to forward the counteroffer to the backer via processor. If desired, the platform can further include means for permitting the prospect to receive a plurality of backer offers, and means for permitting the prospect to initiate an auction process via processor for at least one of (i) future earnings of the prospect, and (ii) at least one service of the prospect.

In some implementations, the online social media platform can further include means for providing a portal for backers to exchange ownership interests in future earnings or services of the prospect. If so desired, the platform can further include means for having the prospect consent to having ownership interests in future earnings or services of the prospect transferred from a first backer to a second backer. If desired, the platform can further include means for permitting an investor to invest in the future earnings of a plurality of prospects by purchasing a single financial instrument.

In some embodiments, the online social media platform can further include means for permitting an individual to submit at least one of (i) a review of the prospect, (ii) a recommendation of the prospect and (iii) a rating of the prospect. If desired, the social media platform can still further include means for permitting an individual to set milestones for the prospect. The means for permitting an individual to set milestones for the prospect preferably permits milestones for the prospect to be set by at least one of (i) the prospect, (ii) an administrator of the social media platform, and (iii) a backer. If desired, the platform can further include means for executing payment from the backer to the prospect upon completion of at least one of the milestones. The prospect can be, for example, (i) a film maker, (ii) a vocal performer, (iii) a sculptor, (iv) a painter, (v) an archaeologist, (vi), an athlete, (viii) a politician, (ix) a social reformer, (x) an entrepreneur, (xi) an institution, (xii) a graphic artist, (xiii) a celebrity and (xiv) an author, among others. The institution can be (i) an opera company, (ii) an educational institution, (iii) a youth organization, (iv) a charity, and the like.

In further implementations, the online social media platform can further include means for receiving backer profile information from a first backer via processor and means for storing the backer profile information in a backer database. The backer profile information can include, for example, identifying backer profile information to be verified, and backer profile information relating to at least one interest of the backer. The platform can further include means for verifying the identifying backer profile information, means for generating backer verification information to confirm verification of the identifying backer profile information, means for storing the backer verification information in the backer database, means for populating an online backer profile page with the backer profile information, and means for making the online backer profile page accessible to be viewed by at least one registered user of the online social media platform. The backer can be, for example, (i) a philanthropist, (ii) an artistic institution, (iii) a professional investor, (iv) a member of the general public, (v) a political organization, (vi) an athlete, (viii) an entrepreneur, (xi) a financial institution, (xii) an educational institution, and the like. The artistic institution can be, for example, (i) a an opera company, (ii) a media company, (iii) a movie studio and (iv) a museum, among other things.

If desired, the backer profile can include information relating to at least one of (i) a backer service available to help meet the prospect achieve the prospect goal, (ii) at least one geographic region in which the backer operates, (iii) the educational background of the backer, (iv) a listing of hyperlinks to profile pages of prospects that the backer has previously worked with, (v) a rating of the backer, and the like. The backer service can include, for example, (i) a mentoring service (ii) a networking service to help the prospect develop their network, (iii) voice lessons, (iv) acting lessons and/or (v) dance lessons, among other things.

In some implementations the online social media platform can further include a recommendation engine for matching the prospect with at least one prospective backer. The recommendation engine can include, for example: (i) means for generating a recommendation via processor to identify the at least one prospective backer for the prospect by comparing the prospect profile information with backer profile information relating to the at least one prospective backer, and (ii) means for providing the recommendation to the prospect to initiate contact with the at least one prospective backer. The platform can further include means for generating a ranking of a plurality of prospects, wherein the ranking of prospects is used by the recommendation engine to generate the recommendation. If desired, the platform can further include means for permitting the backer to request a social media connection to another individual having a profile on the social media platform to permit the backer to develop a personal network of connections within the social media platform.

In further aspects, the online social media platform can further include means for the prospect to establish security settings for their online profile, means to permit at least one of the prospect and backer to enter bank account information into a database, and/or means for displaying content from a web page in the prospect profile. The content can be, for example, a feed from the prospect's account on a different social networking platform. The platform can, if desired, further include means for generating a prospect buyout agreement relating to the personal equity funding agreement for the prospect, the buyout agreement specifying terms and conditions for discharging the personal equity funding agreement.

The disclosure also provides an online social media platform, including means for facilitating an introduction on the social media platform via processor between a prospect and a backer that wishes to invest capital and mentoring in the prospect, means for establishing an online connection between the prospect and backer via processor on the social media platform to facilitate the investment of at least one of (i) capital and (ii) mentoring in the prospect, means for providing a first set of online tools on the social media platform via processor to define a contractual relationship that delineates a plurality of parameters that define the investment of at least one of (i) capital and (ii) mentoring, and means for providing a second set of online tools via processor to ensure that the prospect pays money into an account controlled by an administrator of the social media platform as a condition of the contractual relationship.

The platform can further include means to permit the investment to include a capital contribution to the prospect and at least one of (i) an introduction by the backer to the prospect to a contact of the investor, (ii) a professional service to be rendered by the backer for the prospect, as well as means to permit the professional service to be selected to improve a skill of the prospect. The platform can also include means to permit the professional service to include at least one of (i) a voice lesson, (ii) a mentoring session and (iii) providing publicity for the prospect. The platform can include means to permit capital received by the prospect under the contract to include at least one of an amount received at the onset of the agreement, an amount to be paid during the term of the agreement, and amounts distributed over a predetermined time period, as well as means to permit the prospect to pay money under the contract that is at least one of (i) a percentage of gross income, (ii) a percentage of after tax income and (iii) a flat fee, means to permit the contract to specify that the prospect pays money only if the prospect's income exceeds a threshold amount, as well as means to permit the threshold amount to include at least one of (i) a fixed amount, (ii) a variable amount depending on cost of living of the geographic region in which the prospect resides and (iii) an amount based on the poverty line level for the geographic region in which the prospect resides, as desired.

The online social media platform can also include means to permit the terms of the personal equity funding agreement to include at least one of (i) the name and current residence address of the prospect, (ii) the social security number or taxpayer ID number of the prospect, (iii) the prospect's date of birth, (iv) the prospect's marital status, (v) the educational background of prospect, (vi) the period of study of the prospect, (vii) the amount of investment sought, (viii) the date that the investment is desired, (ix) the purpose for the investment, (x) the repayment period, (xi) termination conditions of the agreement, (xii) privacy and confidentiality provisions, (xiii) an amount of future earnings to be repaid, (xiv) an upfront fee to be paid to administrator of social media platform, (xv) terms specifying prepayment of agreement by prospect, (xvi) bankruptcy provisions, (xvii) default and remedies provisions, (xviii) governing law and jurisdiction, (xix) assignability of the agreement; (xx) representations and warranties of backer and/or prospect; (xxi) an agreement to provide written permission to an administrator of the social media platform or the backer to obtain federal tax transcripts for one or a plurality of years during the term of the agreement, (xxii) written permission to deposit or remove a fixed amount of capital from a bank account of the prospect, (xxiii) written permission to permit an administrator of the social media platform or a backer to obtain payment under the funding agreement from the prospect directly from an employer or a bank account of the prospect. If desired, the platform can include means to permit the prospect to agree to obtain permission from an individual that files taxes jointly with the prospect to provide the tax transcripts, or to file a tax return individually if that permission cannot be obtained, and/or means to permit the representations and warranties by the prospect to include at least one of (i) a statement that no lawsuit is pending against the prospect that would impair performance under the agreement, (ii) a statement that the prospect has not defaulted on any material contract, (iii) a statement that the prospect has filed all tax returns and paid all taxes due, (iv) a statement that the prospect has no prior criminal convictions, and (v) a statement that the prospect has not filed for personal bankruptcy. Also, the platform can include means to permit the prospect to enter two or more separate personal equity funding agreements via processor on the social media platform.

If desired, the platform can include means to permit at least two of the funding agreements to be between the prospect and a different backer, means to permit at least two of the funding agreements to be between the prospect and the same backer, means to permit the agreements to have overlapping effective time periods such that the agreements are in force simultaneously for a first time period, means to permit the agreements to not have overlapping effective time periods such that the agreements are in force at different times, means to permit a percentage of future income to be paid by the prospect under the personal equity funding agreement to be established at least in part due to at least one of (i) a review of the backer by the prospect, (ii) a projected future income of the prospect and (iii) an amount of capital to be raised by the prospect, and/or means to permit the review, recommendation, or rating of the prospect to be obtained from a third party social media platform or a third party website. If desired, the platform can include means to permit the parties to the personal equity funding agreement to be the prospect and a first group of backers in their individual capacities, means to permit the parties to the personal equity funding agreement to include the prospect and a group of backers operating through a legal entity, and/or means to permit the legal entity to be one of a corporation, a limited liability company, and a partnership.

In further implementations, the platform can include means to permit the prospect services to relate to at least one of (i) an occupation of the prospect, (ii) a passion of the prospect and (iii) activities of the prospect; means to permit the reward to include at least one of (i) complimentary or reduced price admission to an event or project in which the prospect is participating or planning to participate and (ii) a complimentary or reduced price article relating to a passion, event or project of the prospect; means to permit the personal equity funding agreement to include an agreement to which the backer and prospect are parties, and/or means to permit the personal equity funding agreement to include (i) a first agreement generated via processor between the backer and a third entity and (ii) a second agreement between the prospect and the third entity generated via processor. If desired, the platform can include means to permit the third entity to include at least one of (i) an individual, (ii) an organization administering the social media platform (iii) an organization controlling the social media platform, and (iii) an affiliate of the social media platform; means to permit at least one of the backer and the prospect to withhold their identity from the other while selecting to reveal their identity to the third entity prior to entering the agreement via processor; and/or means to permit at least one of the backer and the prospect to withhold their identity from the other party while selecting to reveal their identity to the third entity after entering the agreement via processor.

The disclosure further provides an online social media platform, including means for facilitating an introduction via processor on the social media platform between a prospect and an investor that wishes to invest capital and mentoring in the prospect, means for establishing an online connection between the prospect and investor via processor on the social media platform to facilitate the investment of at least one of (i) capital and (ii) mentoring in the prospect, means for providing a first set of online tools via processor on the social media platform to define a contractual relationship that delineates a plurality of parameters that define the investment of at least one of (i) capital and (ii) mentoring, and means for providing an interactive tool to the prospect via processor to help the prospect determine a suitable amount of future income to exchange for the investment.

If desired, the platform can include means to permit the interactive tool to be configured to permit the prospect to run at least one future prospect income scenario of the prospect via processor based on at least one input from the prospect, means to permit the at least one future prospect income scenario to be recorded via a processor to a disclosure file in a database, means to permit a plurality of prospect income scenarios to be recorded via processor to the disclosure file, and/or means to permit all interactions of the prospect with the interactive tool to be recorded via processor to the disclosure file. If desired, the platform can include means to permit the interactive tool to be configured to illustrate rates of return of different types of investments to the prospect via processor having different risk levels to help the prospect to determine an appropriate amount of future income to exchange for the investment from the backer. In some implementations, the platform can include means to permit the interactive tool to include a graphical user interface having a slider that can be dragged across a range from a first point to a second point via processor, wherein the range relates to the rate of return under the personal equity funding agreement; means to permit the graphical user interface to be configured to provide different images via processor illustrating different types of comparable investments as a function of the rate of return as the rate of return is being adjusted while moving the slider from a first location to a second location; means to permit the interactive tool to be adapted to recommend an amount of future prospect income via processor for the prospect to provide in exchange for the investment from the backer; means to permit the interactive tool to be used by the prospect to model future income projections via processor and determine the amount of future income to exchange for the investment before entering negotiations with a backer, and/or means to permit the interactive tool to be configured to provide income projections via processor to the prospect, the income projections being based on at least one of (i) a career choice of a prospect, (ii) an undergraduate major choice of the prospect, (iii) a social security number of the prospect, (iv) an educational institution chosen by a prospect to attend, (v) a grade point average of the prospect, (vi) awards received by the prospect, (v) a major area of study declared by the prospect, (vi) a minor area of study declared by the prospect.

In further aspects, the online social media platform can further include means to permit the interactive tool to be configured to provide a financial disclosure summary via processor to at least one of (i) the prospect and (ii) the backer that describes at least one of (i) the impact or potential impact on the prospect of paying a percentage of earnings over a stated time period, (ii) an income level needed to be achieved by the prospect in order for a backer to break even in an investment in the prospect, (iii) the probability that a prospect will achieve a stated income level, (iv) the possibility that the prospect's identity could become known either directly or inferentially by the backer, and (v) potential tax consequences to the prospect for receiving capital.

The platform can similarly include means for providing at least one legal disclosure to the prospect or backer via processor from an administrator of the online social media platform and/or means to permit the at least one disclosure to describe at least one of (i) the condition, background or future career prospects of the prospect, (ii) the risk of loss of any funds invested in the prospect, (iii) the degree to which the legality of any agreement entered into with the prospect may or may not be enforceable, (iv) potential tax consequences from investing in a prospect. The condition, background and future career prospects of the prospect can be determined via a third party verification service via processor. The platform can further include means to permit a disclosure to be provided via processor to the backer that includes eligibility criteria of the prospect to engage in the funding agreement that includes at least one of (i) information about the prospect provided by way of third parties, and (ii) information that is disclosed by the prospect.

If desired, the platform can additionally or alternatively include means to permit the eligibility criteria of the prospect to include at least one of (i) a description of pre-existing financial obligations of the prospect, and (ii) a description of any insolvency proceedings in which the prospect was involved personally or through a legal entity, (iii) an employment history of the prospect and (iv) a description of any criminal activity in which the prospect was involved or alleged to be involved.

The disclosure also provides an online social media platform of evaluating a future career of a prospect on an online social media platform via processor, the platform including means for receiving career input from the prospect via processor, means for analyzing the career input from the prospect via processor by comparing the career input from the prospect with benchmark career data in a database, and means for generating an evaluation via processor that summarizes the career prospects of the prospect.

If desired, means for generating an evaluation can include means for assigning a value or a range of values via processor to the future career of the prospect. The means for generating an evaluation can include means for assigning a rank to the prospect via processor. The means for generating an evaluation can include means for delivering at least one recommendation to the prospect via processor to modify the career input to enhance the career prospects of the prospect.

If desired, the means for receiving career input can include at least one of (i) means for receiving career interest data of the prospect, (ii) means for receiving a desired retirement age for the prospect, (iii) means for receiving a desired income range for the prospect, (iv) means for receiving a maximum debt load the prospect is willing to commit to in order to achieve the prospect's career goals, and (v) means for receiving a geographical region in which the prospect would like to engage in their career. The means for delivering at least one recommendation can include at least one of (i) means for generating recommended steps to maximize future potential revenue of the prospect and (ii) means for generating a recommendation of a career path for the prospect.

The platform can further include means to permit the recommendation to include a recommendation delivered to the prospect via processor for the prospect to (i) learn another language, (ii) change a concentration of study, (iii) engage in further coursework, (iv) engage in a particular internship, (v) change educational institutions, (vi) pursue an additional degree, (vii) seek counsel of a particular backer on the platform or a particular type of backer, and (viii) change the geographic location in which the prospect wishes to work or reside.

If desired, the platform can additionally or alternatively include means to permit the evaluation to be generated by analyzing via processor at least one of (i) the age of the prospect, (ii) the education of the prospect, (iii) skills or experiences of the prospect, (iv) the personal contacts of the prospect, and (v) past income of the prospect. The platform can similarly further include means to permit analyzing the education of the prospect to include analyzing via processor at least one of (i) an educational institution attended by the prospect, (ii) an educational course of study taken by the prospect, (iii) internships performed by the prospect, (iv) grades of the prospect in major coursework of the prospect and (v) the overall grade point average of the prospect.

If desired, the platform can additionally or alternatively include means to permit the at least one milestone to include at least one of (i) achieving or exceeding a specified minimum grade point average, (ii) achieving or exceeding a minimum grade on a standardized test (e.g., MCAT, GMAT, GRE, LSAT), and (iii) obtaining an award for work performed, and/or means to permit the magnitude of the milestone payment to be established via processor in the personal equity funding agreement to be dependent on performance of the prospect. The platform can similarly include means to permit the profile page of the backer to include at least one of (i) a list of social media contacts, (ii) a list of business contacts; (iii) a list of personal contacts, (iv) a field showing prospects invested in by the backer, (v) a histogram illustrating any backers that the backer may have had in the past, (vi) recommendations of the backer by prospects, (vii) recommendations of the backer by third parties, (viii) a field indicating a rating of the backer, (ix) a field explaining a rating of the backer. The platform can also include means to permit the contacts of the backer listed on the backer profile page to be organized and categorized via processor based on the professional activities of the contacts. The platform can additionally include means for assigning a backer rating to the backer via processor based on at least one of (i) objective criteria and (ii) subjective criteria.

If desired, the platform can include means to permit the criteria to include at least one of (i) whether the backer adhered to the financial terms of the personal equity funding agreement, (ii) whether the backer was responsive to a communication from a prospect within a predetermined time frame, (iii) whether the backer followed through on a promise to a prospect, (iv) a rating on the quality of the results of a prospect's interactions with the backer, and (v) public visibility of the backer. The platform can include means to permit the basis of the subjective criteria to include at least one of (i) emotional supportiveness toward the prospect, (ii) demonstration of initiative to help the prospect, (iii) the quality of advice given to the prospect, (iv) the quality of contacts provided to the prospect, (v) whether the backer actively introduced the prospect to at least one contact and the quality of the introduction, (vi) the quality of engagements that the backer arranged for the prospect, (vii) the quality of commercial sponsors the backer arranged for the prospect, (viii) the attentiveness of the backer toward the prospect, and (ix) the degree to which the backer kept commitments to the prospect. Similarly, the platform can include means to permit only individuals that have had direct interactions with the backer through the online social media platform to rate the backer via processor, means to permit the personal equity funding agreement to be discharged for monetary compensation via a buy out of the existing agreement via processor, means to permit the value of the monetary compensation to be established through a bidding process via processor, means for permitting the bidding process to be initiated by the prospect via processor, means for permitting the bidding process to be initiated by the prospect via processor to achieve at least one of (i) obtaining additional capital and (ii) buying out an existing agreement with a backer, means to permit the prospect to make it known to others via processor that the prospect is initiating the bidding process, means to permit the monetary compensation to be established through a bidding process initiated by the backer via processor, means to permit the prospect to reveal to at least one other individual via processor that the prospect is soliciting a valuation to buy out of an existing agreement with the backer and/or means to require the backer to submit a bid via processor to establish valuation. The requirement for the backer to submit a bid via processor to establish valuation, where desired, can be triggered by the backer not wishing to terminate the agreement that is in place.

The platform can similarly include means for providing conditions via processor to prevent the backer from overpricing the value of the buyout, including at least one of (i) means for requiring the backer to provide additional capital to the prospect based on the price bid by the backer, (ii) means for requiring the backer to pay a premium to the prospect on the value already obtained by the backer under the existing agreement, and (iii) means for requiring the backer to pay the prospect the difference or a fraction of the difference of the amount bid less amounts already paid to the prospect. The platform can include means to permit the bidding process to involve other backers on the online social media platform who are otherwise not engaged in a funding agreement with the prospect. The means for the bidding process can include means for at least one of (i) the prospect soliciting bids via processor over a predetermined time period, (ii) the prospect receiving one or more bids via processor (iii), the prospect selecting one of the bids via processor, (iv) the prospect selecting an average of the bids via processor, and (v) computing the buyout valuation from the average of the bids via a processor.

If desired, the means for the bidding process can include means for analyzing a population of bids via processor, means for computing a mean of the bids in the population via processor, means for discarding bids that fall more than the standard deviation from the mean via processor, and means for averaging the remaining bids to determine the buyout valuation via processor. The platform can similarly include means for assessing a penalty via processor to at least one of the prospect and the backer for exiting the agreement early. The conditions for assessing the penalty can be specified in the personal equity funding agreement, for example. The penalty can include at least one of (i) a fixed percentage of the computed buyout value, (ii) a fixed percentage of a highest bid received in the bidding process, and (iii) a flat fee. The platform can similarly further include means for permitting the prospect to initiate the buyout process via processor wherein the penalty is borne by the prospect.

The platform can similarly include means for permitting the backer to initiate the buyout process via processor wherein the penalty is borne by the backer. The backer can be a party to the personal equity funding agreement sought to be terminated by the bidding process. The platform can include means to permit the backer that initiates the buyout process to be a new backer that is not a party to the original personal equity funding agreement via processor. The platform can also include means for permitting the prospect to initiate the bidding process via processor, wherein the penalty is not assessed against the prospect when the backer has a backer rating that is below a threshold value reflecting that the backer is ineffective.

The platform can similarly include means to permit the bidding process to take place via processor (i) over a predetermined time period (ii) at a randomly selected time by the online social media platform and/or (iii) on demand by the prospect, backer, or an administrator of the online social media platform. The platform can include means to permit the personal equity funding agreement to be valued through a bidding process via processor without canceling the agreement. If desired, the platform can also include means for establishing a contest by the backer via processor, wherein the prospect is invited to apply to win the contest via processor, wherein a prize for winning the contest includes receiving at least one of capital and services from the backer. The platform can include means for permitting the backer to specify parameters for the contest via processor, the parameters including at least one of (i) a time period during which submissions from prospects will be accepted (ii) the nature of the prize (iii) the time of the drawing and (iv) at least one action that the prospect has to perform that will be evaluated by the backer in determining the winner of the contest. The platform can similarly include means to permit the backer profile page to include advice for prospects on preparing for and submitting applications to the contest; means for selecting content for delivery to the backer profile page via processor in accordance with a plurality of parameters; means to permit the content to include at least one of (i) newsfeeds, (ii) recommended social media connections, (iii) product placement, and (iv) advertisements for generating revenue; and/or means to permit the plurality of parameters to include at least one of (i) a school attended by the backer or that the backer is following, (ii) an industry in which the prospect or backer is involved, (iii) the gender of the backer, (iv) people that the backer follow or are connected to on social media sites, and (iv) consumer activity of the backer.

In further implementations, the platform can include means for logging behavioral data of users of the online social media platform via processor. The behavioral data can be logged via processor via at least one of a graphical user interface, gestures on a touch-sensitive interface, movement of a pointing device or cursor, and pupil tracking. The platform can similarly also include means for analyzing the behavioral data via processor to determine appropriate content to send to the user.

The disclosure further provides an online social media platform, including means for facilitating an introduction on the social media platform via processor between a prospect and a backer that wishes to invest capital and mentoring in the prospect, means for establishing an online connection between the prospect and backer via processor on the social media platform to facilitate the investment of at least one of (i) capital and (ii) mentoring in the prospect, and means for providing a first set of online tools on the social media platform via processor to define a contractual relationship that delineates a plurality of parameters that define the investment of at least one of (i) capital and (ii) mentoring, wherein the contractual relationship specifies that future payments of the prospect are to be used to fund other prospects within the online social media platform.

In further implementations, the platform can further include means for directing future payments of the prospect via processor into at least one of (i) a trust or other financial instrument, (ii) a nonprofit or not-for-profit institution or entity; and (iii) a corporation or other for profit entity; means for permitting the prospect to decide which other prospects are funded by the paying prospect's payments via processor. The platform can similarly include means for tracing money paid by the prospect via processor to each prospect that the prospect funds with their payments to show the progression of successive investments of the money paid by the prospect; means for computing via processor the return on the money invested by the prospect in other prospects; and/or means for displaying via processor a virtual account for the prospect showing the amount of revenue generated by the prospect's investment in other prospects. The platform can similarly include means for displaying via processor a virtual account for the backer showing the amount of revenue generated by the backer's investment in the prospect, and further prospects chosen by the prospect; means for displaying a virtual account balance via processor including the sum of all revenues generated as a result of the backer's initial investment; and/or means for generating an incremental reward via processor for the backer when an investment by the backer into at least one prospect produces a monetary return based on an affiliation that the online social media platform has with a third party. Means can be provided to permit the third party to be a sponsor of the social media platform. If desired, the platform can further include means to permit the third party to be an airline, wherein the incremental reward includes airline reward points for the airline, and/or for the third party to be a company producing retail merchandise, wherein the incremental reward permit a recipient to purchase the retail merchandise.

The platform can similarly include means for receiving booster capital from a booster via processor, wherein the booster capital is provided by the booster via processor without commitment to remunerate the booster. The platform can similarly include means to permit the booster to include at least one of (i) a wealthy individual, (ii) a person of influence, (iii) a person of notoriety, and (iv) a philanthropic organization; and/or means to permit the booster capital to include at least one of (i) an initial source of capital collected to fund the prospect (ii) an immediate transfer of liquid assets (iii) a pledge of assets in the future, and (v) a pledge of life insurance proceeds or future income. The platform can include means to permit the booster capital to only be used to fund prospects; means to permit payments made by a first prospect funded with booster capital to be used only to fund other prospects; means to permit the other prospects to be chosen by the first prospect; means to permit the booster to specify what types of projects the booster capital can be used for; and/or means to permit all funds received from a backer to be treated as booster capital if the amount of money is below a threshold amount. Means can be included to provide perks to a booster at the discretion of the recipient after receiving booster capital.

In accordance with further implementations, the platform can further include means to permit funds to be transferred from an account of the backer to an escrow account via processor after the backer capital offer input is received; means to permit at least some of the funds to be transferred from the escrow account into the prospect's account via processor after the prospect selects the backer and assents to the funding agreement; means to permit the funds to be returned to the backer's account via processor if they are not selected by the prospect; means to permit a hold to be placed on funds in an account via processor of the backer after the backer capital offer input is received; means to permit at least some of the funds to be transferred from the backer's account into at least one of an escrow account and the prospect's account via processor after the prospect selects the backer and assents to the funding agreement; means to permit the hold to be released on the funds in the backer's account via processor if the backer is not selected by the prospect; means to permit the social networking platform to initiate an ACH transaction via processor after the backer capital offer input is received; means to permit the social networking platform to instruct a financial institution via processor to make a claim against the backer's account after receiving authorization from the backer to do so; means to permit the social networking platform to release the ACH hold via processor if the backer is not selected by the prospect; and/or means to permit the social media platform to automatically provide tax information to backers and prospects via processor.

In some implementations, the online social media platform can include means to permit amounts paid back by the prospect during the first year of repayment required by the personal equity funding agreement to be based on computations from an income projection estimate performed via processor on the social networking platform. If desired, the platform can include means to permit the social media platform to receive by processor actual income input from the prospect at the end of the first year of repayment, the social media platform to compare the actual income input of the prospect with the projected income of the prospect via processor, and the social media platform to determine via processor any amounts to be paid to or from the prospect in order to satisfy the requirements of the personal equity funding agreement.

The platform can further include means to permit the prospect to make quarterly, monthly, or annual payments to the backer via processor under the personal equity funding agreement; means to permit funds received in the backer's account from the prospect to be removed or reinvested by the backer via processor; means to permit the portion of payments to be automatically reinvested in other prospects via processor; means to permit the other prospects to be selected by the backer via processor; means to permit the other prospects to be selected by the prospect via processor; means to permit the other prospects to be selected by an administrator of the social media platform via processor; means to permit the prospect to specify what types of activities the payments can be used to pay for via processor; means to permit the portion of payments to be used to purchase mentorship outside of the prospect's network; and/or means to permit the portion of payments to be expressed in a non-monetary denomination.

In accordance with further implementations, the platform can include means to permit the non-monetary denomination to include points or credits. Means can be provided to permit capital that is unused by a prospect to be automatically deposited via processor into a general fund managed by an administrator of the social media platform. The platform can similarly include means to permit money invested by a backer to be automatically applied to at least one prospect via processor; means to permit the at least one prospect to become automatically fully funded via processor once having reached a predetermined percentage of desired funding; means to permit the predetermined percentage of desired funding to range from 0 to 99 percent in increments of one percent; means to permit criteria determining the automatic application of the money to be established by the backer via processor; means to permit information disclosed by the prospect to include a description of any moral obligations or philosophical opinions the prospect has that could impact their ability to fulfill their obligations under the funding agreement; and/or means to permit the pre-existing financial obligations of the prospect to include at least one of (i) a description of all legal debts to which the prospect is obligated, (ii) any alimony payments for which the prospect is responsible and (ii) a description of any civil judgments against the prospect

If desired, the platform can include means to permit the criteria to be evaluated via processor to generate the backer rating via processor by analyzing feedback received from prospects with whom the backer has worked or third parties that know the backer. The platform can similarly include means to permit a backer to provide backer level input via processor relating to a level of commitment desired by the backer, wherein different backer levels require increasing amounts of commitment on the part of the backer; means to provide at least three backer levels to be provided via processor; means to provide a first, basic backer level that requires only providing capital to the prospect; means to provide a second, intermediate backer level that requires at least one of (i) periodic communications between the backer and prospect, and (ii) providing professional introductions by the backer to the prospect; means to provide a third, upper backer level that requires at least one of (i) a weekly telephone conference with the prospect to discuss the prospect's progress, (ii) in-person mentorship meetings with the backer and prospect at regular time intervals, and (iii) active endorsement of the prospect by the backer in a public forum; means to permit the backer to change their backer level via processor during the term of the personal equity funding agreement; and/or means to permit the remuneration to the backer to be affected by the backer choosing to change their backer level. The effect on the backer's remuneration of the backer changing the backer level can be specified, for example, in the personal equity funding agreement. Choosing a higher backer level can result in the backer being provided with privileges not available at a lower backer level.

The disclosure further provides an online social media platform, including means for facilitating an introduction on the social media platform via processor between a prospect and a backer that wishes to invest capital and mentoring in the prospect, means for establishing an online connection between the prospect and backer via processor on the social media platform to facilitate the investment of at least one of (i) capital and (ii) mentoring in the prospect, means for providing a set of online tools on the social media platform via processor to generate a map of circles of influence relating to at least one of the prospect and the backer, and means for displaying the map via processor.

The platform can similarly include means to permit the map to illustrate via processor who the backer and prospect are affiliated with; means to permit the circles of influence to be determined via processor based on a common interest of a plurality of users of the social media platform; means to permit the recommendation to be generated via processor at least in part due to at least one material factor; means to permit the at least one material factor to include at least one of (i) a shared passion of the backer and prospect, (ii) a common educational institution shared by the backer and prospect, (iii) a common region of origin shared by the backer and the prospect, (iv) a common profession of the backer and prospect, and (v) a common favorite sports team of the backer and prospect; and/or means to permit the backer to be a brand name manufacturer or an institution, and means for permitting the backer to advertise that they are sponsoring the prospect.

The disclosure also provides an online social media platform, including means for facilitating an introduction on the social media platform via processor between a prospect and a backer that wishes to invest capital and mentoring in the prospect, means for establishing an online connection between the prospect and backer via processor on the social media platform to facilitate the investment of at least one of (i) capital and (ii) mentoring in the prospect, and means for providing a first set of online tools on the social media platform via processor to define a contractual relationship that delineates a plurality of parameters that define the investment of at least one of (i) capital and (ii) mentoring, wherein the contractual relationship specifies that future payments of the prospect under the contract are to be used for charitable purposes.

The platform can similarly include means to permit the future payments of the prospect to be directed into a not-for-profit institution for funding of other prospects; means to permit the future payments of the prospect to be directed into a trust for funding of other prospects; and/or means to permit funds to be provided to the prospect under the personal equity funding agreement on a prepaid payment card.

The disclosure also provides an online social media platform comprising means for facilitating an introduction on the social media platform via processor between a prospect and a backer that wishes to invest capital and mentoring in the prospect, means for establishing an online connection between the prospect and backer via processor on the social media platform to facilitate the investment of at least one of (i) capital and (ii) mentoring in the prospect, and means for providing an online discussion board portal on the social media platform via processor where a prospect can initiate a discussion with one or more individuals on the social networking platform.

The platform can similarly include means to permit the prospect to define a sub-community of users within the social media platform to participate with the prospect on the discussion board portal; means to permit the users to include backers with whom the prospect has entered into a personal equity funding agreement; means to permit a message to be generated and routed to at least one individual when the prospect initiates a discussion on the discussion board portal; means to permit the message to only be routed to backers that wish to receive the message; means to permit a backer at a first level of mentoring participation with the prospect to automatically opt out of receiving the message; means to permit a backer at a second level of mentoring participation with the prospect that is higher than the first level involved to automatically opt into of receiving the message; means to permit the discussion board portal to be displayed within a profile page of the prospect; means to permit the discussion to include a question that the prospect wants answered; means to permit the prospect to be able to direct the question to all users of the social media platform; and/or means for directing the question to an administrator for approval prior to directing the message to all users of the social media platform.

If desired, the platform can include means to permit the prospect to set permissions to permit different users to view the discussion portal; means for directing a discussion thread on the portal to a second online social media platform; means to permit the second online social media platform to be the Facebook® platform, the LinkedIn® platform, the Twitter® platform, or another platform; means to permit the personal equity funding agreement to provide for a penalty if one of the parties to the personal equity funding agreement does not abide by the terms of the agreement; means to permit the penalty to include at least one of (i) being denied contact with other users of the platform, (ii) having a quality rating of the non-abiding party degraded, (iii) being denied the ability to enter into another personal equity funding agreement until the defect is cured and (iv) a monetary penalty; and/or means to permit the personal equity funding agreement to not close and be funded until a prospect's funding goal is reached.

In further accordance with the disclosure, processor-readable tangible non-transient media storing computer programs for operating an online social media platform are provided. The programs can include, for example, instructions for receiving prospect profile information from a first prospect via processor. The prospect profile information can include personal prospect profile information to be verified, and prospect profile information relating to at least one aspiration of the prospect. The computer programs can further include, for example, instructions for storing the prospect profile information in a prospect database, instructions for verifying the personal prospect profile information, instructions for generating verification information to confirm verification of the personal prospect profile information, instructions for storing the verification information in the prospect database, instructions for populating an online prospect profile page with the prospect profile information, and instructions for making the online prospect profile page accessible to be viewed by at least one registered user of the online social media platform.

In accordance with further aspects, the computer program can further include instructions for generating a personal equity funding agreement for the prospect. The personal equity funding agreement can specify terms and conditions for obtaining at least one of monetary funding and backer services from at least one backer in exchange for at least one of a portion of the prospect's future earnings over a first predetermined time period, and prospect services of the prospect over a second predetermined time period. The instructions for generating the personal equity funding agreement include, for example, one or more of (i) instructions for receiving prospect percentage offer input from the prospect via processor, the prospect percentage offer input indicating an amount of future earnings the prospect is willing to exchange for value, (ii) instructions for receiving prospect term input from the prospect via processor, the prospect term input indicating a time period over which the prospect is willing to provide future earnings in exchange for value, (iii) instructions for receiving prospect service offer input from the prospect via processor, the prospect service offer input indicating at least one service the prospect is willing to exchange for value, (iv) instructions for receiving prospect capital request input from the prospect via processor, the prospect capital request input indicating an amount of capital the prospect seeks to obtain, (v) instructions for receiving prospect service request input from the prospect via processor, the prospect service request input indicating at least one service the prospect seeks to obtain, (vi) instructions for receiving prospect geographic input from the prospect via processor, the prospect geographic input indicating a geographic region of interest of the prospect, and (vii) instructions for receiving prospect backer input from the prospect via processor, the prospect backer input indicating at least one attribute that the prospect seeks in a prospective backer. The prospect percentage offer input can indicates a maximum amount of future earnings the prospect is willing to exchange for value. The prospect term input can indicate the maximum or minimum time period over which the prospect is willing to provide future earnings in exchange for value. The prospect capital request input can indicate the minimum amount of capital the prospect seeks to obtain.

In some embodiments, the computer program can further include instructions for making at least a portion of the information contained on the online prospect profile page accessible to be viewed by at least one backer after the prospect has assented to the personal equity funding agreement. If desired, the computer program can further include instructions for selectively revealing the identity of the prospect to at least one other user of the platform. In some implementations, the computer program can further include instructions for displaying, for example, one or more of the following on the online prospect profile page: (i) a description of a prospect goal, (ii) an amount of capital sought by the prospect to help meet the prospect goal, (iii) one or more backer services sought by the prospect to help meet the prospect goal, (iv) an amount of equity the prospect is willing to exchange for capital or backer services, (v) a description of prospect services available to be exchanged for capital or backer services, (vi) at least one geographic region in which the prospect operates, (vii) the educational background of the prospect, (viii) a picture of the prospect, (ix) a sample of the prospect's work, (x) a timeframe in which the prospect desires to accomplish a goal, (xi) prior accomplishments of the prospect, (xii) GPS coordinate information of the prospect, and the like.

In some implementations, the computer program can further include instructions for generating a prospect rating to the prospect, the prospect rating being based at least in part on the prospect profile information. The instructions for generating the prospect rating can be adapted to generate the prospect rating based, for example, on one or more of (i) a credit score or credit rating, (ii) a prior achievement of the prospect, (iii) a subjective review by an individual that is familiar with the prospect, (iv) earning potential of the prospect, and the like. In some embodiments, the services of the prospect over a predetermined time period can include, for example, (i) execution of an artistic work, (ii) execution of a literary work, (iii) execution of a cinematic work, (iv) a personal appearance, and/or (v) a consulting arrangement, among others. The instructions for verifying can be adapted to verify, for example, one or more of (i) the age of the prospect, (ii) the identity of the prospect, (iii) the social security number of the prospect, (iv) the tax identification number for the prospect, (v) a legal address of the prospect, (vi) the credit history of the prospect, (vii) a criminal background check of the prospect, (viii) at least one personal reference or recommendation of the prospect, and the like.

In some implementations, the computer program can further include instructions for providing the prospect access to a database of backers via processor. If desired, the computer program can further include instructions for permitting the prospect to request and establish a social media connection to another individual having a profile on the social media platform to permit the prospect to develop a personal network of connections within the social media platform. In some embodiments, the computer program can further include instructions for (i) importing a list of prospect contacts into a portion of the prospect's profile from a software application, (ii) providing a link on the prospect's profile page to a profile of the prospect on another computer program, (iii) providing a field on the online prospect profile page that can be populated with content provided by a viewer of the prospect profile page, (iv) providing an actuator on the online prospect profile page to permit a backer to engage in a negotiation with the prospect to enter into an agreement with the backer, and/or (v) for executing a transfer of funds from a backer to the prospect.

In some embodiments, the computer program can further include one or more of (i) instructions for receiving backer offer information relating to the prospect from at least one backer via processor, (ii) instructions for analyzing the backer offer information via processor, (iii) instructions for generating an offer from the backer to the prospect, and (iv) instructions for forwarding the offer to the prospect via processor. The instructions for receiving backer offer information can include one or more of (i) instructions for receiving backer percentage request input from the backer via processor, the backer percentage request input indicating an amount of future prospect earnings the backer wishes to receive in exchange for value, (ii) instructions for receiving backer term input from the backer via processor, the backer term input indicating a time period over which the wishes to receive future prospect earnings, (iii) instructions for receiving backer service request input from the backer via processor, the backer service request input indicating at least one prospect service the backer wishes to receive in exchange for value, (iv) instructions for receiving backer capital offer input from the backer via processor, the backer capital offer input indicating an amount of capital the backer is willing to exchange for future prospect earnings or at least one prospect service, (v) instructions for receiving backer service offer input from the backer via processor, the backer service offer input indicating at least one service the backer is willing to exchange for future prospect earnings or at least one prospect service, (vi) instructions for receiving backer geographic input from the backer via processor, the backer geographic input indicating a geographic region of interest of the backer, and (vii) instructions for receiving backer prospect input from the backer via processor, the backer prospect input indicating at least one attribute that the backer seeks in a prospective prospect.

In some implementations, the computer program can further include instructions for receiving rejection information from the prospect indicating that the prospect declined the offer via processor, and instructions for forwarding the rejection information to the backer. The computer program can further include one or more of (i) instructions for receiving revised backer offer information from the backer via processor, (ii) instructions for analyzing the revised backer offer information via processor, (iii) instructions for generating a revised offer from the backer to the prospect, and (iv) instructions for forwarding the revised offer to the prospect via processor.

In some embodiments, the computer program can further include (i) instructions for receiving counteroffer information from the prospect via processor, the counteroffer information indicating terms acceptable to the prospect, (ii) instructions for analyzing the counteroffer information via processor, (iii) instructions for generating a counteroffer from the prospect to the backer, and (iv) instructions for forwarding the counteroffer to the backer via processor. If desired, the computer program can further include (i) instructions for receiving backer offer information relating to the prospect from at least two backers, and (ii) instructions for conducting an auction via processor for at least one of future earnings of the prospect, and at least one service of the prospect.

In further implementations, the computer program can include instructions for at least one backer to input backer offer information, instructions for generating an offer using the backer offer information, and instructions for forwarding the offer to the prospect via processor. The means for generating can generate an offer including at least one of (i) backer percentage request information indicating an amount of future prospect earnings the backer wishes to receive in exchange for value, (ii) backer term information indicating a time period over which the wishes to receive future prospect earnings, (iii) backer service request information indicating at least one prospect service the backer wishes to receive in exchange for value, (iv) backer capital offer information indicating an amount of capital the backer is willing to exchange for future prospect earnings or at least one prospect service, (v) backer service offer information indicating at least one service the backer is willing to exchange for future prospect earnings or at least one prospect service, and (vi) backer geographic information indicating a geographic region of interest of the backer.

In some implementations, the computer program can further include instructions for permitting the prospect to review the offer, and instructions for permitting the prospect to forward a rejection of the offer to the backer. The program can further include instructions to permit the backer to input revised backer offer information, instructions for generating a revised offer using the backer offer information, and instructions to permit the backer to forward the revised offer to the prospect via processor. The program can further include (i) instructions for permitting the prospect to review the offer via processor, (ii) instructions to permit the prospect to prepare a counteroffer indicating terms acceptable to the prospect, and (iii) instructions to permit the prospect to forward the counteroffer to the backer via processor. The computer program can further include (i) instructions for permitting the prospect to receive a plurality of backer offers, and (ii) instructions for permitting the prospect to initiate an auction process via processor for at least one of future earnings of the prospect, and at least one service of the prospect.

In some implementations, the computer program can further include instructions for providing a portal for backers to exchange ownership interests in future earnings or services of the prospect. The computer program can further include instructions for having the prospect consent to having ownership interests in future earnings or services of the prospect transferred from a first backer to a second backer. If desired, the computer program can further include instructions for permitting an investor to invest in the future earnings of a plurality of prospects by purchasing a single financial instrument.

In some implementations, the computer program can further include instructions for permitting an individual to submit at least one of (i) a review of the prospect, (ii) a recommendation of the prospect and (iii) a rating of the prospect. The computer program can further include instructions for permitting an individual to set milestones for the prospect. The instructions for permitting an individual to set milestones for the prospect can permit milestones for the prospect to be set, for example, by one or more of (i) the prospect, (ii) an administrator of the social media platform, and (iii) a backer. The computer program can further include instructions for executing payment from the backer to the prospect upon completion of at least one of the milestones. The prospect can be at least one of (i) a film maker, (ii) a vocal performer, (iii) a sculptor, (iv) a painter, (v) an archaeologist, (vi), an athlete, (viii) a politician, (ix) a social reformer, (x) an entrepreneur, (xi) an institution, (xii) a graphic artist, (xiii) a celebrity and (xiv) an author, among others. The institution can be, for example, (i) an opera company, (ii) an educational institution, (iii) a youth organization, (iv) a charity, and the like.

In further implementations, the computer program can further include instructions for receiving backer profile information from a first backer via processor. The backer profile information can include, for example, identifying backer profile information to be verified, and backer profile information relating to at least one interest of the backer. The computer program can further include instructions for storing the backer profile information in a backer database, instructions for verifying the identifying backer profile information, instructions for generating backer verification information to confirm verification of the identifying backer profile information, instructions for storing the backer verification information in the backer database, instructions for populating an online backer profile page with the backer profile information, and instructions for making the online backer profile page accessible to be viewed by at least one registered user of the computer program, among other things. The backer can be, for example, (i) a philanthropist, (ii) an artistic institution, (iii) a professional investor, (iv) a member of the general public, (v) a political organization, (vi) an athlete, (viii) an entrepreneur, (xi) a financial institution, and/or (xii) an educational institution, among others. The artistic institution can be, for example, (i) a an opera company, (ii) a media company, (iii) a movie studio, (iv) a museum, and the like.

In some implementations, the backer profile can include information relating to, for example, one or more of (i) a backer service available to help meet the prospect achieve the prospect goal, (ii) at least one geographic region in which the backer operates, (iii) the educational background of the backer, (iv) a listing of hyperlinks to profile pages of prospects that the backer has previously worked with, and (v) a rating of the backer, among other things. The backer service can include, for example, (i) a mentoring service (ii) a networking service to help the prospect develop their network, (iii) voice lessons, (iv) acting lessons, and/or (v) dance lessons, among other things.

In some implementations, the computer program can further include instructions for operating a recommendation engine for matching the prospect with at least one prospective backer. The instructions for operating the recommendation engine can include (i) instructions for generating a recommendation via processor to identify the at least one prospective backer for the prospect by comparing the prospect profile information with backer profile information relating to the at least one prospective backer, and (ii) instructions for providing the recommendation to the prospect to initiate contact with the at least one prospective backer. The computer program can further include instructions for generating a ranking of a plurality of prospects, wherein the ranking of prospects is used by the recommendation engine to generate the recommendation. The computer program can still further include instructions for permitting the backer to request a social media connection to another individual having a profile on the social media platform to permit the backer to develop a personal network of connections within the social media platform.

In some embodiments, computer program can further include instructions to permit the prospect to establish security settings for their online profile. If desired, the computer program can further include instructions to permit at least one of the prospect and backer to enter bank account information into a database. The computer program can further include instructions for displaying content from a web page in the prospect profile. The content can be, for example, a feed from the prospect's account on a different social networking platform. In accordance with further aspects, the computer program can further include instructions for generating a prospect buyout agreement relating to the personal equity funding agreement for the prospect, the buyout agreement specifying terms and conditions for discharging the personal equity funding agreement.

The disclosure similarly provides a processor-readable tangible non-transient medium storing a computer program for operating an online social media platform, including instructions for facilitating an introduction on the social media platform via processor between a prospect and a backer that wishes to invest capital and mentoring in the prospect, instructions for establishing an online connection between the prospect and backer via processor on the social media platform to facilitate the investment of at least one of (i) capital and (ii) mentoring in the prospect, instructions for providing a first set of online tools on the social media platform via processor to define a contractual relationship that delineates a plurality of parameters that define the investment of at least one of (i) capital and (ii) mentoring, and instructions for providing a second set of online tools via processor to ensure that the prospect pays money into an account controlled by an administrator of the social media platform as a condition of the contractual relationship.

The computer program can further include instructions to permit the investment to include a capital contribution to the prospect and at least one of (i) an introduction by the backer to the prospect to a contact of the investor, (ii) a professional service to be rendered by the backer for the prospect; instructions to permit the professional service to be selected to improve a skill of the prospect; instructions to permit the professional service to include at least one of (i) a voice lesson, (ii) a mentoring session and (iii) providing publicity for the prospect; instructions to permit capital received by the prospect under the contract to include at least one of an amount received at the onset of the agreement, an amount to be paid during the term of the agreement, and amounts distributed over a predetermined time period; instructions to permit the prospect to pay money under the contract that is at least one of (i) a percentage of gross income, (ii) a percentage of after tax income and (iii) a flat fee; instructions to permit the contract to specify that the prospect pays money only if the prospect's income exceeds a threshold amount; and/or instructions to permit the threshold amount to include at least one of (i) a fixed amount, (ii) a variable amount depending on cost of living of the geographic region in which the prospect resides and (iii) an amount based on the poverty line level for the geographic region in which the prospect resides.

The computer program can similarly include instructions to permit the terms of the personal equity funding agreement to include at least one of (i) the name and current residence address of the prospect, (ii) the social security number or taxpayer ID number of the prospect, (iii) the prospect's date of birth, (iv) the prospect's marital status, (v) the educational background of prospect, (vi) the period of study of the prospect, (vii) the amount of investment sought, (viii) the date that the investment is desired, (ix) the purpose for the investment, (x) the repayment period, (xi) termination conditions of the agreement, (xii) privacy and confidentiality provisions, (xiii) an amount of future earnings to be repaid, (xiv) an upfront fee to be paid to administrator of social media platform, (xv) terms specifying prepayment of agreement by prospect, (xvi) bankruptcy provisions, (xvii) default and remedies provisions, (xviii) governing law and jurisdiction, (xix) assignability of the agreement; (xx) representations and warranties of backer and/or prospect; (xxi) an agreement to provide written permission to an administrator of the social media platform or the backer to obtain federal tax transcripts for one or a plurality of years during the term of the agreement, (xxii) written permission to deposit or remove a fixed amount of capital from a bank account of the prospect, (xxiii) written permission to permit an administrator of the social media platform or a backer to obtain payment under the funding agreement from the prospect directly from an employer or a bank account of the prospect.

The computer program can further include instructions to permit the prospect to agree to obtain permission from an individual that files taxes jointly with the prospect to provide the tax transcripts, or to file a tax return individually if that permission cannot be obtained; and/or instructions to permit the representations and warranties by the prospect to include at least one of (i) a statement that no lawsuit is pending against the prospect that would impair performance under the agreement, (ii) a statement that the prospect has not defaulted on any material contract, (iii) a statement that the prospect has filed all tax returns and paid all taxes due, (iv) a statement that the prospect has no prior criminal convictions, and (v) a statement that the prospect has not filed for personal bankruptcy.

The computer program can similarly include instructions to permit the prospect to enter two or more separate personal equity funding agreements via processor on the social media platform; instructions to permit at least two of the funding agreements to be between the prospect and a different backer; instructions to permit at least two of the funding agreements to be between the prospect and the same backer; instructions to permit the agreements to have overlapping effective time periods such that the agreements are in force simultaneously for a first time period; instructions to permit the agreements to not have overlapping effective time periods such that the agreements are in force at different times; instructions to permit a percentage of future income to be paid by the prospect under the personal equity funding agreement to be established at least in part due to at least one of (i) a review of the backer by the prospect, (ii) a projected future income of the prospect and (iii) an amount of capital to be raised by the prospect; instructions to permit the review, recommendation, or rating of the prospect to be obtained from a third party social media platform or a third party website; instructions to permit the parties to the personal equity funding agreement to be the prospect and a first group of backers in their individual capacities; instructions to permit the parties to the personal equity funding agreement to include the prospect and a group of backers operating through a legal entity; instructions to permit the legal entity to be one of a corporation, a limited liability company, and a partnership; instructions to permit the prospect services to relate to at least one of (i) an occupation of the prospect, (ii) a passion of the prospect and (iii) activities of the prospect; instructions to permit the reward to include at least one of (i) complimentary or reduced price admission to an event or project in which the prospect is participating or planning to participate and (ii) a complimentary or reduced price article relating to a passion, event or project of the prospect; instructions to permit the personal equity funding agreement to include an agreement to which the backer and prospect are parties; instructions to permit the personal equity funding agreement to include (i) a first agreement generated via processor between the backer and a third entity and (ii) a second agreement between the prospect and the third entity generated via processor; and/or instructions to permit the third entity to include at least one of (i) an individual, (ii) an organization administering the social media platform (iii) an organization controlling the social media platform, and (iii) an affiliate of the social media platform.

The computer program can further include instructions to permit at least one of the backer and the prospect to withhold their identity from the other while selecting to reveal their identity to the third entity prior to entering the agreement via processor; and/or instructions to permit at least one of the backer and the prospect to withhold their identity from the other party while selecting to reveal their identity to the third entity after entering the agreement via processor.

The disclosure also provides a processor-readable tangible non-transient medium storing a computer program for operating an online social media platform, including instructions for facilitating an introduction via processor on the social media platform between a prospect and an investor that wishes to invest capital and mentoring in the prospect, instructions for establishing an online connection between the prospect and investor via processor on the social media platform to facilitate the investment of at least one of (i) capital and (ii) mentoring in the prospect, instructions for providing a first set of online tools via processor on the social media platform to define a contractual relationship that delineates a plurality of parameters that define the investment of at least one of (i) capital and (ii) mentoring, and instructions for providing an interactive tool to the prospect via processor to help the prospect determine a suitable amount of future income to exchange for the investment.

The computer program can further include instructions to permit the interactive tool to be configured to permit the prospect to run at least one future prospect income scenario of the prospect via processor based on at least one input from the prospect; instructions to permit the at least one future prospect income scenario to be recorded via a processor to a disclosure file in a database; instructions to permit a plurality of prospect income scenarios to be recorded via processor to the disclosure file; instructions to permit all interactions of the prospect with the interactive tool to be recorded via processor to the disclosure file; and/or instructions to permit the interactive tool to be configured to illustrate rates of return of different types of investments to the prospect via processor having different risk levels to help the prospect to determine an appropriate amount of future income to exchange for the investment from the backer

The computer program can further include instructions to permit the interactive tool to include a graphical user interface having a slider that can be dragged across a range from a first point to a second point via processor, wherein the range relates to the rate of return under the personal equity funding agreement; instructions to permit the graphical user interface to be configured to provide different images via processor illustrating different types of comparable investments as a function of the rate of return as the rate of return is being adjusted while moving the slider from a first location to a second location; instructions to permit the interactive tool to be adapted to recommend an amount of future prospect income via processor for the prospect to provide in exchange for the investment from the backer; instructions to permit the interactive tool to be used by the prospect to model future income projections via processor and determine the amount of future income to exchange for the investment before entering negotiations with a backer; and/or instructions to permit the interactive tool to be configured to provide income projections via processor to the prospect, the income projections being based on at least one of (i) a career choice of a prospect, (ii) an undergraduate major choice of the prospect, (iii) a social security number of the prospect, (iv) an educational institution chosen by a prospect to attend, (v) a grade point average of the prospect, (vi) awards received by the prospect, (v) a major area of study declared by the prospect, (vi) a minor area of study declared by the prospect.

The computer program can yet further include instructions to permit the interactive tool to be configured to provide a financial disclosure summary via processor to at least one of (i) the prospect and (ii) the backer that describes at least one of: (i) the impact or potential impact on the prospect of paying a percentage of earnings over a stated time period, (ii) an income level needed to be achieved by the prospect in order for a backer to break even in an investment in the prospect, (iii) the probability that a prospect will achieve a stated income level, (iv) the possibility that the prospect's identity could become known either directly or inferentially by the backer, and (v) potential tax consequences to the prospect for receiving capital.

The computer program can still further include instructions providing at least one legal disclosure to the prospect or backer via processor from an administrator of the computer program; and/or instructions to permit the at least one disclosure to describe at least one of: (i) the condition, background or future career prospects of the prospect, (ii) the risk of loss of any funds invested in the prospect, (iii) the degree to which the legality of any agreement entered into with the prospect may or may not be enforceable, (iv) potential tax consequences from investing in a prospect. The condition, background and future career prospects of the prospect can be determined via a third party verification service via processor, for example. The computer program can further include instructions to permit a disclosure to be provided via processor to the backer that includes eligibility criteria of the prospect to engage in the funding agreement that includes at least one of (i) information about the prospect provided by way of third parties, and (ii) information that is disclosed by the prospect; and/or instructions to permit the eligibility criteria of the prospect to include at least one of (i) a description of pre-existing financial obligations of the prospect, and (ii) a description of any insolvency proceedings in which the prospect was involved personally or through a legal entity, (iii) an employment history of the prospect and (iv) a description of any criminal activity in which the prospect was involved or alleged to be involved.

The disclosure further provides a processor-readable tangible non-transient medium storing a computer program for evaluating a future career of a prospect on an computer program via processor, the program including instructions for receiving career input from the prospect via processor, instructions for analyzing the career input from the prospect via processor by comparing the career input from the prospect with benchmark career data in a database, and instructions for generating an evaluation via processor that summarizes the career prospects of the prospect.

In accordance with further aspects, the computer program can further include instructions for assigning a value or a range of values via processor to the future career of the prospect. The instructions for generating an evaluation can include instructions for assigning a rank to the prospect via processor. The instructions for generating an evaluation can include instructions for delivering at least one recommendation to the prospect via processor to modify the career input to enhance the career prospects of the prospect. The instructions for receiving career input can similarly include at least one of (i) instructions for receiving career interest data of the prospect, (ii) instructions for receiving a desired retirement age for the prospect, (iii) instructions for receiving a desired income range for the prospect, (iv) instructions for receiving a maximum debt load the prospect is willing to commit to in order to achieve the prospect's career goals, and (v) instructions for receiving a geographical region in which the prospect would like to engage in their career.

The instructions for delivering at least one recommendation can include at least one of (i) instructions for generating recommended steps to maximize future potential revenue of the prospect and (ii) instructions for generating a recommendation of a career path for the prospect. The computer program can further include instructions to permit the recommendation to include a recommendation delivered to the prospect via processor for the prospect to (i) learn another language, (ii) change a concentration of study, (iii) engage in further coursework, (iv) engage in a particular internship, (v) change educational institutions, (vi) pursue an additional degree, (vii) seek counsel of a particular backer on the platform or a particular type of backer, and (viii) change the geographic location in which the prospect wishes to work or reside.

In some implementations, the computer program can further include instructions to permit the evaluation to be generated by analyzing via processor at least one of (i) the age of the prospect, (ii) the education of the prospect, (iii) skills or experiences of the prospect, (iv) the personal contacts of the prospect, and (v) past income of the prospect. If desired, the computer program can further include instructions to permit analyzing the education of the prospect to include analyzing via processor at least one of (i) an educational institution attended by the prospect, (ii) an educational course of study taken by the prospect, (iii) internships performed by the prospect, (iv) grades of the prospect in major coursework of the prospect and (v) the overall grade point average of the prospect.

The computer program can further include instructions to permit the at least one milestone to include at least one of (i) achieving or exceeding a specified minimum grade point average, (ii) achieving or exceeding a minimum grade on a standardized test (e.g., MCAT, GMAT, GRE, LSAT), and (iii) obtaining an award for work performed.

The computer program can still further include instructions to permit the magnitude of the milestone payment to be established via processor in the personal equity funding agreement to be dependent on performance of the prospect.

In accordance with another aspect, the computer program can include instructions to permit the profile page of the backer to include at least one of (i) a list of social media contacts, (ii) a list of business contacts; (iii) a list of personal contacts, (iv) a field showing prospects invested in by the backer, (v) a histogram illustrating any backers that the backer may have had in the past, (vi) recommendations of the backer by prospects, (vii) recommendations of the backer by third parties, (viii) a field indicating a rating of the backer, (ix) a field explaining a rating of the backer. The computer program can include instructions to permit the contacts of the backer listed on the backer profile page to be organized and categorized via processor based on the professional activities of the contacts; instructions for assigning a backer rating to the backer via processor based on at least one of (i) objective criteria and (ii) subjective criteria; instructions to permit the criteria to include at least one of (i) whether the backer adhered to the financial terms of the personal equity funding agreement, (ii) whether the backer was responsive to a communication from a prospect within a predetermined time frame, (iii) whether the backer followed through on a promise to a prospect, (iv) a rating on the quality of the results of a prospect's interactions with the backer, and (v) public visibility of the backer; instructions to permit the basis of the subjective criteria to include at least one of (i) emotional supportiveness toward the prospect, (ii) demonstration of initiative to help the prospect, (iii) the quality of advice given to the prospect, (iv) the quality of contacts provided to the prospect, (v) whether the backer actively introduced the prospect to at least one contact and the quality of the introduction, (vi) the quality of engagements that the backer arranged for the prospect, (vii) the quality of commercial sponsors the backer arranged for the prospect, (viii) the attentiveness of the backer toward the prospect, and (ix) the degree to which the backer kept commitments to the prospect; instructions to permit only individuals that have had direct interactions with the backer through the computer program to rate the backer via processor; instructions to permit the personal equity funding agreement to be discharged for monetary compensation via a buy out of the existing agreement via processor; instructions to permit the value of the monetary compensation to be established through a bidding process via processor; instructions for permitting the bidding process to be initiated by the prospect via processor; instructions for permitting the bidding process to be initiated by the prospect via processor to achieve at least one of (i) obtaining additional capital and (ii) buying out an existing agreement with a backer; instructions to permit the prospect to make it known to others via processor that the prospect is initiating the bidding process; instructions to permit the monetary compensation to be established through a bidding process initiated by the backer via processor; instructions to permit the prospect to reveal to at least one other individual via processor that the prospect is soliciting a valuation to buy out of an existing agreement with the backer; and/or instructions to require the backer to submit a bid via processor to establish valuation. The requirement for the backer to submit a bid via processor to establish valuation can be triggered by the backer not wishing to terminate the agreement that is in place.

In accordance with another aspect, the computer program can include instructions for providing conditions via processor to prevent the backer from overpricing the value of the buyout, including at least one of (i) instructions for requiring the backer to provide additional capital to the prospect based on the price bid by the backer, (ii) instructions for requiring the backer to pay a premium to the prospect on the value already obtained by the backer under the existing agreement, and (iii) instructions for requiring the backer to pay the prospect the difference or a fraction of the difference of the amount bid less amounts already paid to the prospect. The computer program can include instructions to permit the bidding process to involve other backers on the platform who are otherwise not engaged in a funding agreement with the prospect; and/or instructions for at least one of (i) the prospect soliciting bids via processor over a predetermined time period, (ii) the prospect receiving one or more bids via processor (iii), the prospect selecting one of the bids via processor, (iv) the prospect selecting an average of the bids via processor, and (v) computing the buyout valuation from the average of the bids via a processor. The instructions for the bidding process can include instructions for analyzing a population of bids via processor, instructions for computing a mean of the bids in the population via processor, instructions for discarding bids that fall more than the standard deviation from the mean via processor, and instructions for averaging the remaining bids to determine the buyout valuation via processor.

In accordance with further aspects, the computer program can include instructions for assessing a penalty via processor to at least one of the prospect and the backer for exiting the agreement early. The conditions for assessing the penalty can be specified in the personal equity funding agreement. The penalty can include at least one of (i) a fixed percentage of the computed buyout value, (ii) a fixed percentage of a highest bid received in the bidding process, and (iii) a flat fee.

The computer program can similarly include instructions for permitting the prospect to initiate the buyout process via processor wherein the penalty is borne by the prospect; and/or instructions for permitting the backer to initiate the buyout process via processor wherein the penalty is borne by the backer. The backer can be a party to the personal equity funding agreement sought to be terminated by the bidding process.

The computer program can also include instructions to permit the backer that initiates the buyout process to be a new backer that is not a party to the original personal equity funding agreement via processor; instructions for permitting the prospect to initiate the bidding process via processor, wherein the penalty is not assessed against the prospect when the backer has a backer rating that is below a threshold value reflecting that the backer is ineffective; instructions to permit the bidding process to take place via processor (i) over a predetermined time period (ii) at a randomly selected time by the online social media platform and/or (iii) on demand by the prospect, backer, or an administrator of the online social media platform; instructions to permit the personal equity funding agreement to be valued through a bidding process via processor without canceling the agreement; instructions for establishing a contest by the backer via processor, wherein the prospect is invited to apply to win the contest via processor, wherein a prize for winning the contest includes receiving at least one of capital and services from the backer; and/or instructions for permitting the backer to specify parameters for the contest via processor, the parameters including at least one of (i) a time period during which submissions from prospects will be accepted (ii) the nature of the prize (iii) the time of the drawing and (iv) at least one action that the prospect has to perform that will be evaluated by the backer in determining the winner of the contest.

In accordance with another aspect, the computer program can include instructions to permit the backer profile page to include advice for prospects on preparing for and submitting applications to the contest; instructions for selecting content for delivery to the backer profile page via processor in accordance with a plurality of parameters; instructions to permit the content to include at least one of (i) newsfeeds, (ii) recommended social media connections, (iii) product placement, and (iv) advertisements for generating revenue; instructions to permit the plurality of parameters to include at least one of (i) a school attended by the backer or that the backer is following, (ii) an industry in which the prospect or backer is involved, (iii) the gender of the backer, (iv) people that the backer follow or are connected to on social media sites, and (iv) consumer activity of the backer; and/or instructions for logging behavioral data of users of the online social media platform via processor. The behavioral data can be logged via processor via at least one of a graphical user interface, gestures on a touch-sensitive interface, movement of a pointing device or cursor, and pupil tracking. The computer program can further include instructions for analyzing the behavioral data via processor to determine appropriate content to send to the user.

The disclosure further provides a processor-readable tangible non-transient medium storing a computer program for operating an online social media platform, the program including instructions for facilitating an introduction on the social media platform via processor between a prospect and a backer that wishes to invest capital and mentoring in the prospect, instructions for establishing an online connection between the prospect and backer via processor on the social media platform to facilitate the investment of at least one of (i) capital and (ii) mentoring in the prospect, and instructions for providing a first set of online tools on the social media platform via processor to define a contractual relationship that delineates a plurality of parameters that define the investment of at least one of (i) capital and (ii) mentoring, wherein the contractual relationship specifies that future payments of the prospect are to be used to fund other prospects within the online social media platform.

In accordance with another aspect, the computer program can include instructions for directing future payments of the prospect via processor into at least one of (i) a trust or other financial instrument, (ii) a nonprofit or not-for-profit institution or entity; and (iii) a corporation or other for profit entity. The payment can then be divided among one or more backers, and/or one or more prospects. The computer program can further include instructions for permitting the prospect to decide which other prospects are funded by the paying prospect's payments via processor; instructions for tracing money paid by the prospect via processor to each prospect that the prospect funds with their payments to show the progression of successive investments of the money paid by the prospect; instructions for computing via processor the return on the money invested by the prospect in other prospects; instructions for displaying via processor a virtual account for the prospect showing the amount of revenue generated by the prospect's investment in other prospects; instructions for displaying via processor a virtual account for the backer showing the amount of revenue generated by the backer's investment in the prospect, and further prospects chosen by the prospect; instructions for displaying a virtual account balance via processor including the sum of all revenues generated as a result of the backer's initial investment.

The computer program can also include instructions for generating an incremental reward via processor for the backer when an investment by the backer into at least one prospect produces a monetary return based on an affiliation that the online social media platform has with a third party; instructions to permit the third party to be a sponsor of the social media platform; and/or instructions to permit the third party to be an airline, wherein the incremental reward includes airline reward points for the airline, or the third party to be a company producing retail merchandise, wherein the incremental reward permit a recipient to purchase the retail merchandise.

In accordance with another aspect, the computer program can include instructions for receiving booster capital from a booster via processor, wherein the booster capital is provided by the booster via processor without commitment to remunerate the booster; instructions to permit the booster to include at least one of (i) a wealthy individual, (ii) a person of influence, (iii) a person of notoriety, and (iv) a philanthropic organization; instructions to permit the booster capital to include at least one of (i) an initial source of capital collected to fund the prospect (ii) an immediate transfer of liquid assets (iii) a pledge of assets in the future, and (v) a pledge of life insurance proceeds or future income; instructions to permit the booster capital to only be used to fund prospects; instructions to permit payments made by a first prospect funded with booster capital to be used only to fund other prospects; instructions to permit the other prospects to be chosen by the first prospect; instructions to permit the booster to specify what types of projects the booster capital can be used for; instructions to permit all funds received from a backer to be treated as booster capital if the amount of money is below a threshold amount; and/or instructions to provide perks to a booster at the discretion of the recipient after receiving booster capital.

The computer program can similarly include instructions to permit funds to be transferred from an account of the backer to an escrow account via processor after the backer capital offer input is received; instructions to permit at least some of the funds to be transferred from the escrow account into the prospect's account via processor after the prospect selects the backer and assents to the funding agreement; instructions to permit the funds to be returned to the backer's account via processor if they are not selected by the prospect; instructions to permit a hold to be placed on funds in an account via processor of the backer after the backer capital offer input is received; instructions to permit at least some of the funds to be transferred from the backer's account into at least one of an escrow account and the prospect's account via processor after the prospect selects the backer and assents to the funding agreement; instructions to permit the hold to be released on the funds in the backer's account via processor if the backer is not selected by the prospect; instructions to permit the social networking platform to initiate an ACH transaction via processor after the backer capital offer input is received; instructions to permit the social networking platform to instruct a financial institution via processor to make a claim against the backer's account after receiving authorization from the backer to do so; instructions to permit the social networking platform to release the ACH hold via processor if the backer is not selected by the prospect; instructions to permit the social media platform to automatically provide tax information to backers and prospects via processor; and/or instructions to permit amounts paid back by the prospect during the first year of repayment required by the personal equity funding agreement to be based on computations from an income projection estimate performed via processor on the social networking platform. The computer program can be provided with instructions to permit the social media platform to receive by processor actual income input from the prospect at the end of the first year of repayment, the social media platform to compare the actual income input of the prospect with the projected income of the prospect via processor, and the social media platform to determine via processor any amounts to be paid to or from the prospect in order to satisfy the requirements of the personal equity funding agreement.

The computer program can include instructions to permit the prospect to make quarterly, monthly, or annual payments to the backer via processor under the personal equity funding agreement; instructions to permit funds received in the backer's account from the prospect to be removed or reinvested by the backer via processor; instructions to permit the portion of payments to be automatically reinvested in other prospects via processor; instructions to permit the other prospects to be selected by the backer via processor; instructions to permit the other prospects to be selected by the prospect via processor; instructions to permit the other prospects to be selected by an administrator of the social media platform via processor; instructions to permit the prospect to specify what types of activities the payments can be used to pay for via processor; instructions to permit the portion of payments to be used to purchase mentorship outside of the prospect's network; instructions to permit the portion of payments to be expressed in a non-monetary denomination; instructions to permit the non-monetary denomination to include points or credits; instructions to permit capital that is unused by a prospect to be automatically deposited via processor into a general fund managed by an administrator of the social media platform; instructions to permit money invested by a backer to be automatically applied to at least one prospect via processor; instructions to permit the at least one prospect to become automatically fully funded via processor once having reached a predetermined percentage of desired funding; instructions to permit the predetermined percentage of desired funding to range from 0 to 99 percent in increments of one percent; instructions to permit criteria determining the automatic application of the money to be established by the backer via processor; instructions to permit information disclosed by the prospect to include a description of any moral obligations or philosophical opinions the prospect has that could impact their ability to fulfill their obligations under the funding agreement; instructions to permit the pre-existing financial obligations of the prospect to include at least one of (i) a description of all legal debts to which the prospect is obligated, (ii) any alimony payments for which the prospect is responsible and (ii) a description of any civil judgments against the prospect; and/or instructions to permit the criteria to be evaluated via processor to generate the backer rating via processor by analyzing feedback received from prospects with whom the backer has worked or third parties that know the backer.

The computer program can be provided with instructions to permit a backer to provide backer level input via processor relating to a level of commitment desired by the backer, wherein different backer levels require increasing amounts of commitment on the part of the backer; instructions to provide at least three backer levels to be provided via processor; instructions to provide a first, basic backer level that requires only providing capital to the prospect; instructions to provide a second, intermediate backer level that requires at least one of (i) periodic communications between the backer and prospect, and (ii) providing professional introductions by the backer to the prospect; instructions to provide a third, upper backer level that requires at least one of (i) a weekly telephone conference with the prospect to discuss the prospect's progress, (ii) in-person mentorship meetings with the backer and prospect at regular time intervals, and (iii) active endorsement of the prospect by the backer in a public forum; instructions to permit the backer to change their backer level via processor during the term of the personal equity funding agreement; and/or instructions to permit the remuneration to the backer to be affected by the backer choosing to change their backer level. The effect on the backer's remuneration of the backer changing the backer level can be specified in the personal equity funding agreement. Choosing a higher backer level can result in the backer being provided with privileges not available at a lower backer level.

The disclosure also provides a processor-readable tangible non-transient medium storing a computer program for operating an online social media platform, the computer program including instructions for facilitating an introduction on the social media platform via processor between a prospect and a backer that wishes to invest capital and mentoring in the prospect, instructions for establishing an online connection between the prospect and backer via processor on the social media platform to facilitate the investment of at least one of (i) capital and (ii) mentoring in the prospect, instructions for providing a set of online tools on the social media platform via processor to generate a map of circles of influence relating to at least one of the prospect and the backer, and instructions for displaying the map via processor.

The computer program can also be provided with instructions to permit the map to illustrate via processor who the backer and prospect are affiliated with; instructions to permit the circles of influence to be determined via processor based on a common interest of a plurality of users of the social media platform; instructions to permit the recommendation to be generated via processor at least in part due to at least one material factor; instructions to permit the at least one material factor to include at least one of (i) a shared passion of the backer and prospect, (ii) a common educational institution shared by the backer and prospect, (iii) a common region of origin shared by the backer and the prospect, (iv) a common profession of the backer and prospect, and (v) a common favorite sports team of the backer and prospect; and/or instructions to permit the backer to be a brand name manufacturer or an institution, and instructions for permitting the backer to advertise that they are sponsoring the prospect.

The disclosure also provides a processor-readable tangible non-transient medium storing a computer program for operating an online social media platform, wherein the computer program includes instructions for facilitating an introduction on the social media platform via processor between a prospect and a backer that wishes to invest capital and mentoring in the prospect, instructions for establishing an online connection between the prospect and backer via processor on the social media platform to facilitate the investment of at least one of (i) capital and (ii) mentoring in the prospect, and instructions for providing a first set of online tools on the social media platform via processor to define a contractual relationship that delineates a plurality of parameters that define the investment of at least one of (i) capital and (ii) mentoring, wherein the contractual relationship specifies that future payments of the prospect under the contract are to be used for charitable purposes.

The computer program can further be provided with instructions to permit the future payments of the prospect to be directed into a not-for-profit institution for funding of other prospects; instructions to permit the future payments of the prospect to be directed into a trust for funding of other prospects; and/or instructions to permit funds to be provided to the prospect under the personal equity funding agreement on a prepaid payment card.

The disclosure further provides a processor-readable tangible non-transient medium storing a computer program for operating an online social media platform, the computer program including instructions for facilitating an introduction on the social media platform via processor between a prospect and a backer that wishes to invest capital and mentoring in the prospect, instructions for establishing an online connection between the prospect and backer via processor on the social media platform to facilitate the investment of at least one of (i) capital and (ii) mentoring in the prospect, and instructions for providing an online discussion board portal on the social media platform via processor where a prospect can initiate a discussion with one or more individuals on the social networking platform.

The computer program can also include instructions to permit the prospect to define a sub-community of users within the social media platform to participate with the prospect on the discussion board portal; instructions to permit the users to include backers with whom the prospect has entered into a personal equity funding agreement; instructions to permit a message to be generated and routed to at least one individual when the prospect initiates a discussion on the discussion board portal; instructions to permit the message to only be routed to backers that wish to receive the message; instructions to permit a backer at a first level of mentoring participation with the prospect to automatically opt out of receiving the message; instructions to permit a backer at a second level of mentoring participation with the prospect that is higher than the first level involved to automatically opt into of receiving the message; instructions to permit the discussion board portal to be displayed within a profile page of the prospect instructions to permit the discussion to include a question that the prospect wants answered; instructions to permit the prospect to be able to direct the question to all users of the social media platform; instructions for directing the question to an administrator for approval prior to directing the message to all users of the social media platform; instructions to permit the prospect to set permissions to permit different users to view the discussion portal; instructions for directing a discussion thread on the portal to a second online social media platform; instructions to permit the second online social media platform to be the Facebook® platform, the LinkedIn® platform, the Twitter® platform, or another platform; instructions to permit the personal equity funding agreement to provide for a penalty if one of the parties to the personal equity funding agreement does not abide by the terms of the agreement; instructions to permit the penalty to include at least one of (i) being denied contact with other users of the platform, (ii) having a quality rating of the non-abiding party degraded, (iii) being denied the ability to enter into another personal equity funding agreement until the defect is cured and (iv) a monetary penalty; and instructions to permit the personal equity funding agreement to not close and be funded until a prospect's funding goal is reached.

The disclosure further provides computing devices having one or more processors, memory, a display screen and one or more programs, wherein the one or more programs are stored in the memory and configured to be executed by the one or more processors, the one or more programs including instructions for operating an online social media platform. In accordance with some embodiments, the one or more programs include instructions for displaying a graphical input interface for receiving prospect profile input from a first prospect via processor. The prospect profile input can include, for example, personal prospect profile information to be verified, and prospect profile information relating to at least one aspiration of the prospect. The programs can further include, for example, instructions for populating an online prospect profile page with the prospect profile information, and instructions for displaying the online prospect profile page accessible to be viewed by at least one registered user of the online social media platform.

In some implementations, the one or more programs can further include instructions for generating and displaying a graphical input interface for receiving personal equity funding agreement input for the prospect. The interface can permit inputting, for example, (i) prospect percentage offer input from the prospect, the prospect percentage offer input indicating an amount of future earnings the prospect is willing to exchange for value, (ii) prospect term input from the prospect, the prospect term input indicating a time period over which the prospect is willing to provide future earnings in exchange for value, (iii) prospect service offer input from the prospect, the prospect service offer input indicating at least one service the prospect is willing to exchange for value, (iv) prospect capital request input from the prospect, the prospect capital request input indicating an amount of capital the prospect seeks to obtain, (v) prospect service request input from the prospect, the prospect service request input indicating at least one service the prospect seeks to obtain, (vi) prospect geographic input from the prospect, the prospect geographic input indicating a geographic region of interest of the prospect, and (vii) prospect backer input from the prospect, the prospect backer input indicating at least one attribute that the prospect seeks in a prospective backer.

In some implementations of the computing device, the prospect percentage offer input can indicate a maximum amount of future earnings the prospect is willing to exchange for value. The prospect term input can indicate the maximum or minimum time period over which the prospect is willing to provide future earnings in exchange for value. The prospect capital request input can indicate the minimum amount of capital the prospect seeks to obtain. If desired, the one or more programs can further include instructions permitting the prospect to selectively reveal at least one aspect of the identity of the prospect to at least one other user of the online social media platform. In some implementations, the one or more programs can further include instructions for generating and displaying, for example, one or more of the following on the online prospect profile page: (i) a description of a prospect goal, (ii) an amount of capital sought by the prospect to help meet the prospect goal, (iii) one or more backer services sought by the prospect to help meet the prospect goal, (iv) an amount of equity the prospect is willing to exchange for capital or backer services, (v) a description of prospect services available to be exchanged for capital or backer services, (vi) at least one geographic region in which the prospect operates, (vii) the educational background of the prospect, (viii) a picture of the prospect, (ix) a sample of the prospect's work, (x) a timeframe in which the prospect desires to accomplish a goal, (xi) prior accomplishments of the prospect and (xii) GPS coordinate information of the prospect, among other things.

In accordance with some embodiments of the computing device, the one or more programs can further include instructions for generating and displaying a graphical input interface for receiving prospect rating input for generating a prospect rating. The instructions for generating and displaying a graphical input interface for receiving prospect rating input can be adapted to receive at least one of (i) credit score or credit rating input, (ii) prior achievement input of the prospect, (iii) subjective review input by an individual that is familiar with the prospect and (iv) earning potential input of the prospect, among other things. The one or more programs can further include instructions to generate and display a graphical user interface embodying a listing of backers to the prospect. The one or more programs can still further include instructions for generating and displaying a graphical user interface to the prospect that permits the prospect to request a social media connection to another individual having a profile on the social media platform to permit the prospect to develop a personal network of connections within the social media platform.

In accordance with further implementations of the computing device, the one or more programs further include instructions for generating and displaying a graphical user interface to the prospect that permits the prospect to import a list of prospect contacts into a portion of the prospect's profile from another software application. The one or more programs can further include instructions for generating and displaying a graphical user interface to the prospect that permits the prospect to establish a link on the prospect's profile page to a profile of the prospect on another computing device. The one or more programs can yet further include instructions for generating and displaying a field that can be populated with content provided by viewer of the prospect profile page. If desired, the one or more programs of the computing device can further include instructions for generating and displaying an actuator to permit a backer to engage in a negotiation with the prospect to enter into an agreement with the backer. In accordance with another aspect, the one or more programs can include instructions for generating and displaying a graphical user interface to a backer that permits the backer to execute a transfer of funds to the prospect. In accordance with further aspects, the computing device can be a mobile computing device, such as a tablet or a smart phone, or can be a personal computer or other terminal or client.

In accordance with still further aspects of the computing device, the one or more programs can yet further include instructions for generating and displaying a graphical input interface for receiving backer offer input. The interface preferably permits inputting at least one of (i) backer percentage request input from the backer, the backer percentage request input indicating an amount of future prospect earnings the backer wishes to receive in exchange for value, (ii) backer term input from the backer, the backer term input indicating a time period over which the wishes to receive future prospect earnings, (iii) backer service request input from the backer, the backer service request input indicating at least one prospect service the backer wishes to receive in exchange for value, (iv) backer capital offer input from the backer, the backer capital offer input indicating an amount of capital the backer is willing to exchange for future prospect earnings or at least one prospect service, (v) backer service offer input from the backer, the backer service offer input indicating at least one service the backer is willing to exchange for future prospect earnings or at least one prospect service, (vi) backer geographic input from the backer, the backer geographic input indicating a geographic region of interest of the backer, and (vii) backer prospect input from the backer, the backer prospect input indicating at least one attribute that the backer seeks in a prospective prospect.

In accordance with some implementations of the computing device, the one or more programs can further include instructions for generating and displaying a graphical input interface for receiving prospect rejection information from the prospect indicating that the prospect declined the offer. The one or more programs can further include instructions for generating and displaying a graphical input interface for receiving revised backer offer information from the backer via processor. If desired, the one or more programs may include instructions for generating and displaying a graphical input interface for receiving counteroffer information indicating terms acceptable to the prospect. In some embodiments, the one or more programs can further include instructions for generating and displaying a graphical input interface for receiving backer offer information relating to the prospect from at least two backers.

In accordance with additional implementations of the computing device, the one or more programs can further include instructions for generating and displaying a graphical input interface for receiving backer offer input. The backer offer input can include, for example, (i) backer percentage request information indicating an amount of future prospect earnings the backer wishes to receive in exchange for value, (ii) backer term information indicating a time period over which the wishes to receive future prospect earnings, (iii) backer service request information indicating at least one prospect service the backer wishes to receive in exchange for value, (iv) backer capital offer information indicating an amount of capital the backer is willing to exchange for future prospect earnings or at least one prospect service, (v) backer service offer information indicating at least one service the backer is willing to exchange for future prospect earnings or at least one prospect service, and (vi) backer geographic information indicating a geographic region of interest of the backer.

In some implementations of the computing device, the one or more programs can further include instructions for generating and displaying a graphical interface that displays an offer to the prospect, the offer being based on the backer offer input, and one or more selectable actuators for assenting to the offer, declining the offer, or making a counteroffer to the backer. The one or more programs can further include instructions for generating and displaying a graphical interface that provides at least one of (i) a field and (ii) an actuator to permit the backer to input revised backer offer information. If desired, the one or more programs can further include instructions for generating and displaying a graphical interface that permits the prospect to review a plurality of backer offers, and, if desired, that permits the prospect to initiate an auction process via processor for at least one of (i) future earnings of the prospect, and (ii) at least one service of the prospect.

In accordance with further implementations of the computing device, the one or more programs can further include instructions for generating and displaying a portal for backers to exchange ownership interests in future earnings or services of the prospect. The one or more programs can further include instructions for generating and displaying a graphical interface that permits the prospect to consent to having ownership interests in future earnings or services of the prospect transferred from a first backer to a second backer. The one or more programs further include instructions for generating and displaying a graphical interface that permits an investor to invest in the future earnings of a plurality of prospects by purchasing a single financial instrument. The one or more programs can yet further include instructions for generating and displaying a graphical interface that permits an individual to submit at least one of (i) a review of the prospect, (ii) a recommendation of the prospect and (iii) a rating of the prospect.

In accordance with further implementations of the computing device, the one or more programs further include instructions for generating and displaying a graphical interface that permits an individual to set milestones for the prospect. The interface can permit the milestones for the prospect to be set by at least one of (i) the prospect, (ii) an administrator of the social media platform, and (iii) a backer, among others. The one or more programs can further include instructions for generating and displaying a graphical interface that permits the backer to initiate and execute a payment to the prospect upon completion of at least one of the milestones.

In accordance with yet further implementations of the computing device, the one or more programs can further include instructions for displaying a graphical input interface for receiving backer profile input from a first backer via processor. The backer profile information includes (i) identifying backer profile information to be verified, and (ii) backer profile information relating to at least one interest of the backer. The one or more programs can further include instructions for populating an online backer profile page with the backer profile information, and instructions for displaying the online backer profile page to at least one registered user of the online social media platform. The one or more programs can further include instructions for generating and displaying at least one of the following on the online backer profile page: (i) a backer service available to help meet the prospect achieve the prospect goal, (ii) at least one geographic region in which the backer operates, (iii) the educational background of the backer, (iv) a listing of hyperlinks to profile pages of prospects that the backer has previously worked with and (v) a rating of the backer, among other things. The backer service can include, for example, at least one of (i) a mentoring service (ii) a networking service to help the prospect develop their network, (iii) voice lessons, (iv) acting lessons, (v) dance lessons, and the like.

In accordance with yet further implementations of the computing device, the one or more programs can further include instructions for generating and displaying a recommendation to the backer to initiate contact with at least one prospective backer. The one or more programs can yet further include instructions for generating and displaying ranking of a plurality of prospects, wherein the ranking of prospects is used at least in part to generate the recommendation. If desired, the one or more programs can further include instructions for generating and displaying a graphical user interface to permit the backer to request a social media connection to another individual having a profile on the social media platform to permit the backer to develop a personal network of connections within the social media platform.

In accordance with still further embodiments of the computing device, the one or more programs can further include instructions for generating and displaying a graphical user interface that permits the prospect to establish security settings for their online profile. If desired, the one or more programs can further include instructions for generating and displaying a graphical user interface that permits at least one of the prospect and backer to enter bank account information into a database. In some embodiments, the one or more programs can further include instructions for generating and displaying content from a web page in the prospect or profile or a backer profile. The content can be, for example, a feed from the prospect's or backer's account on a different social networking platform. In accordance with still further aspects, the one or more programs can include instructions for generating and displaying a graphical user interface that permits a prospect to specify one or more terms for a buyout agreement relating to the personal equity funding agreement for the prospect, the buyout agreement specifying terms and conditions for discharging the personal equity funding agreement.

The disclosure also provides a computing device having one or more processors, memory, a display screen and one or more programs, wherein the one or more programs are stored in the memory and configured to be executed by the one or more processors, the one or more programs including instructions for operating an online social media platform. The one or more programs include instructions for generating and displaying a graphical interface for facilitating an introduction on the social media platform via processor between a prospect and a backer that wishes to invest capital and mentoring in the prospect, instructions for generating and displaying a graphical interface for establishing an online connection between the prospect and backer via processor on the social media platform to facilitate the investment of at least one of (i) capital and (ii) mentoring in the prospect, instructions for generating and displaying a graphical interface for providing a first set of online tools on the social media platform via processor to define a contractual relationship that delineates a plurality of parameters that define the investment of at least one of (i) capital and (ii) mentoring; and instructions for generating and displaying a graphical interface for providing a second set of online tools via processor to ensure that the prospect pays money into an account controlled by an administrator of the social media platform as a condition of the contractual relationship.

In further accordance with the disclosure, the one or more programs of the computing device can further include: instructions for generating and displaying a graphical input interface to permit a user to designate that the investment includes a capital contribution to the prospect and at least one of (i) an introduction by the backer to the prospect to a contact of the investor, (ii) a professional service to be rendered by the backer for the prospect; instructions for generating and displaying a graphical input interface to permit a user to designate that the professional service to be selected is for improving a skill of the prospect; instructions to permit the professional service to include at least one of (i) a voice lesson, (ii) a mentoring session and (iii) providing publicity for the prospect; instructions for generating and displaying a graphical input interface to permit a user to designate that capital received by the prospect under the contract includes at least one of an amount received at the onset of the agreement, an amount to be paid during the term of the agreement, and amounts distributed over a predetermined time period; instructions for generating and displaying a graphical input interface to permit a user to designate that the prospect will pay money under the contract that is at least one of (i) a percentage of gross income, (ii) a percentage of after tax income and (iii) a flat fee; instructions for generating and displaying a graphical input interface to permit a user to designate that the prospect pays money under the contract only if the prospect's income exceeds a threshold amount; and/or instructions for generating and displaying a graphical input interface to permit a user to designate that the threshold amount includes at least one of (i) a fixed amount, (ii) a variable amount depending on cost of living of the geographic region in which the prospect resides and (iii) an amount based on the poverty line level for the geographic region in which the prospect resides.

In further accordance with the disclosure, the one or more programs of the computing device can further include: instructions for generating and displaying a graphical input interface to permit a user to designate that the terms of the personal equity funding agreement include at least one of (i) the name and current residence address of the prospect, (ii) the social security number or taxpayer ID number of the prospect, (iii) the prospect's date of birth, (iv) the prospect's marital status, (v) the educational background of prospect, (vi) the period of study of the prospect, (vii) the amount of investment sought, (viii) the date that the investment is desired, (ix) the purpose for the investment, (x) the repayment period, (xi) termination conditions of the agreement, (xii) privacy and confidentiality provisions, (xiii) an amount of future earnings to be repaid, (xiv) an upfront fee to be paid to administrator of social media platform, (xv) terms specifying prepayment of agreement by prospect, (xvi) bankruptcy provisions, (xvii) default and remedies provisions, (xviii) governing law and jurisdiction, (xix) assignability of the agreement; (XX) representations and warranties of backer and/or prospect; (xxi) an agreement to provide written permission to an administrator of the social media platform or the backer to obtain federal tax transcripts for one or a plurality of years during the term of the agreement, (xxii) written permission to deposit or remove a fixed amount of capital from a bank account of the prospect, (xxiii) written permission to permit an administrator of the social media platform or a backer to obtain payment under the funding agreement from the prospect directly from an employer or a bank account of the prospect.

In further accordance with the disclosure, the one or more programs of the computing device can further include: instructions for generating and displaying a graphical input interface to permit a user to designate that the prospect will agree to obtain permission from an individual that files taxes jointly with the prospect to provide the tax transcripts, or to file a tax return individually if that permission cannot be obtained; and/or instructions for generating and displaying a graphical input interface to permit a user to designate that the representations and warranties by the prospect include at least one of (i) a statement that no lawsuit is pending against the prospect that would impair performance under the agreement, (ii) a statement that the prospect has not defaulted on any material contract, (iii) a statement that the prospect has filed all tax returns and paid all taxes due, (iv) a statement that the prospect has no prior criminal convictions, and (v) a statement that the prospect has not filed for personal bankruptcy.

In further accordance with the disclosure, the one or more programs of the computing device can further include: instructions for generating and displaying a graphical input interface to permit a user to designate that the prospect enter two or more separate personal equity funding agreements via processor on the social media platform; instructions for generating and displaying a graphical input interface to permit a user to designate that at least two of the funding agreements be between the prospect and a different backer; instructions for generating and displaying a graphical input interface to permit a user to designate that at least two of the funding agreements be between the prospect and the same backer; instructions for generating and displaying a graphical input interface to permit a user to designate that the agreements have overlapping effective time periods such that the agreements are in force simultaneously for a first time period; instructions for generating and displaying a graphical input interface to permit a user to designate that the agreements not have overlapping effective time periods such that the agreements are in force at different times; instructions for generating and displaying a graphical input interface to permit a user to designate that a percentage of future income be paid by the prospect under the personal equity funding agreement to be established at least in part due to at least one of (i) a review of the backer by the prospect, (ii) a projected future income of the prospect and (iii) an amount of capital to be raised by the prospect; instructions for generating and displaying a graphical input interface to permit a user to designate that the review, recommendation, or rating of the prospect be obtained from a third party social media platform or a third party website; instructions for generating and displaying a graphical input interface to permit a user to designate that the parties to the personal equity funding agreement be the prospect and a first group of backers in their individual capacities; instructions for generating and displaying a graphical input interface to permit a user to designate that the parties to the personal equity funding agreement include the prospect and a group of backers operating through a legal entity; instructions for generating and displaying a graphical input interface to permit a user to designate that the legal entity be one of a corporation, a limited liability company, and a partnership; instructions for generating and displaying a graphical input interface to permit a user to designate that the prospect services relate to at least one of (i) an occupation of the prospect, (ii) a passion of the prospect and (iii) activities of the prospect; and/or instructions for generating and displaying a graphical input interface to permit a user to designate that the reward include at least one of (i) complimentary or reduced price admission to an event or project in which the prospect is participating or planning to participate and (ii) a complimentary or reduced price article relating to a passion, event or project of the prospect.

In still further accordance with the disclosure, the one or more programs of the computing device can further include: instructions for generating and displaying a graphical input interface to permit a user to designate that the personal equity funding agreement include an agreement to which the backer and prospect are parties; instructions for generating and displaying a graphical input interface to permit a user to designate that the personal equity funding agreement include (i) a first agreement generated via processor between the backer and a third entity and (ii) a second agreement between the prospect and the third entity generated via processor; instructions for generating and displaying a graphical input interface to permit a user to designate that the third entity include at least one of (i) an individual, (ii) an organization administering the social media platform (iii) an organization controlling the social media platform, and (iii) an affiliate of the social media platform; instructions for generating and displaying a graphical input interface to permit a user to designate that at least one of the backer and the prospect withhold their identity from the other while selecting to reveal their identity to the third entity prior to entering the agreement via processor; and/or instructions for generating and displaying a graphical input interface to permit a user to designate that at least one of the backer and the prospect withhold their identity from the other party while selecting to reveal their identity to the third entity after entering the agreement via processor.

The disclosure further provides computing device having one or more processors, memory, a display screen and one or more programs, wherein the one or more programs are stored in the memory and configured to be executed by the one or more processors, the one or more programs including instructions for operating an online social media platform. The one or more programs include instructions for generating and displaying a graphical input interface for facilitating an introduction via processor on the social media platform between a prospect and an investor that wishes to invest capital and mentoring in the prospect, instructions for generating and displaying a graphical input interface for establishing an online connection between the prospect and investor via processor on the social media platform to facilitate the investment of at least one of (i) capital and (ii) mentoring in the prospect, instructions for generating and displaying a graphical input interface for providing a first set of online tools via processor on the social media platform to define a contractual relationship that delineates a plurality of parameters that define the investment of at least one of (i) capital and (ii) mentoring, and instructions for generating and displaying a graphical input interface for providing an interactive tool to the prospect via processor to help the prospect determine a suitable amount of future income to exchange for the investment.

In further accordance with the disclosure, the one or more programs of the computing device can further include: instructions for generating and displaying a graphical input interface to permit a user to designate that the interactive tool be configured to permit the prospect to run at least one future prospect income scenario of the prospect via processor based on at least one input from the prospect; instructions for generating and displaying a graphical input interface to permit a user to designate that the at least one future prospect income scenario be recorded via a processor to a disclosure file in a database; instructions for generating and displaying a graphical input interface to permit a user to designate that a plurality of prospect income scenarios be recorded via processor to the disclosure file; instructions for generating and displaying a graphical input interface to permit a user to designate that all interactions of the prospect with the interactive tool be recorded via processor to the disclosure file; instructions for generating and displaying a graphical input interface to permit a user to designate that the interactive tool illustrate rates of return of different types of investments to the prospect via processor having different risk levels to help the prospect to determine an appropriate amount of future income to exchange for the investment from the backer; instructions to permit the interactive tool to include a graphical user interface having a slider that can be dragged across a range from a first point to a second point via processor, wherein the range relates to the rate of return under the personal equity funding agreement; instructions to permit the graphical user interface to be configured to provide different images via processor illustrating different types of comparable investments as a function of the rate of return as the rate of return is being adjusted while moving the slider from a first location to a second location; instructions for generating and displaying a graphical interface to recommend an amount of future prospect income via processor for the prospect to provide in exchange for the investment from the backer; instructions for generating and displaying a graphical interface to permit a user to model future income projections via processor and determine the amount of future income to exchange for the investment before entering negotiations with a backer; and/or instructions for generating and displaying a graphical interface to permit a user to generate prospect income projections via processor, the income projections being based on at least one of (i) a career choice of a prospect, (ii) an undergraduate major choice of the prospect, (iii) a social security number of the prospect, (iv) an educational institution chosen by a prospect to attend, (v) a grade point average of the prospect, (vi) awards received by the prospect, (v) a major area of study declared by the prospect, (vi) a minor area of study declared by the prospect.

In still further accordance with the disclosure, the one or more programs of the computing device can further include: instructions for generating and displaying a graphical interface to permit a user to generate a financial disclosure summary via processor and send the summary to at least one of (i) the prospect and (ii) the backer that describes at least one of: (i) the impact or potential impact on the prospect of paying a percentage of earnings over a stated time period, (ii) an income level needed to be achieved by the prospect in order for a backer to break even in an investment in the prospect, (iii) the probability that a prospect will achieve a stated income level, (iv) the possibility that the prospect's identity could become known either directly or inferentially by the backer, and (v) potential tax consequences to the prospect for receiving capital; instructions for generating and displaying a graphical interface to permit the prospect or backer to receive at least one legal disclosure via processor from an administrator of the computer program; and/or instructions for generating and displaying a graphical interface to display a disclosure that describes at least one of: (i) the condition, background or future career prospects of the prospect, (ii) the risk of loss of any funds invested in the prospect, (iii) the degree to which the legality of any agreement entered into with the prospect may or may not be enforceable, (iv) potential tax consequences from investing in a prospect. The condition, background and future career prospects of the prospect can be determined, for example via a third party verification service via processor.

In yet accordance with the disclosure, the one or more programs of the computing device can further include: instructions for generating, displaying and providing a disclosure via processor to the backer that includes eligibility criteria of the prospect to engage in the funding agreement that includes at least one of (i) information about the prospect provided by way of third parties, and (ii) information that is disclosed by the prospect; and/or instructions to permit the eligibility criteria of the prospect to include at least one of (i) a description of pre-existing financial obligations of the prospect, and (ii) a description of any insolvency proceedings in which the prospect was involved personally or through a legal entity, (iii) an employment history of the prospect and (iv) a description of any criminal activity in which the prospect was involved or alleged to be involved.

The disclosure also provides a computing device having one or more processors, memory, a display screen and one or more programs, wherein the one or more programs are stored in the memory and configured to be executed by the one or more processors, the one or more programs including instructions for evaluating a future career of a prospect on an computer program via processor. The one or more programs can include instructions for generating and displaying a graphical interface for receiving career input from the prospect via processor, instructions for analyzing the career input from the prospect via processor by comparing the career input from the prospect with benchmark career data in a database, and instructions for generating and displaying a graphical interface for displaying an evaluation via processor that summarizes the career prospects of the prospect.

In yet accordance with the disclosure, the one or more programs of the computing device can further include instructions for assigning a value or a range of values via processor to the future career of the prospect. The instructions for generating an evaluation can include, for example: instructions for assigning a rank to the prospect via processor; and/or instructions for delivering at least one recommendation to the prospect via processor to modify the career input to enhance the career prospects of the prospect.

The instructions for receiving career input can include at least one of (i) instructions for receiving career interest data of the prospect, (ii) instructions for receiving a desired retirement age for the prospect, (iii) instructions for receiving a desired income range for the prospect, (iv) instructions for receiving a maximum debt load the prospect is willing to commit to in order to achieve the prospect's career goals, and (v) instructions for receiving a geographical region in which the prospect would like to engage in their career. The instructions for delivering at least one recommendation can include at least one of (i) instructions for generating and displaying recommended steps to maximize future potential revenue of the prospect and (ii) instructions for generating and displaying a recommendation of a career path for the prospect.

In yet accordance with the disclosure, the one or more programs of the computing device can further include: instructions for generating and displaying a graphical interface to permit a user to view a recommendation delivered to the prospect via processor for the prospect to (i) learn another language, (ii) change a concentration of study, (iii) engage in further coursework, (iv) engage in a particular internship, (v) change educational institutions, (vi) pursue an additional degree, (vii) seek counsel of a particular backer on the platform or a particular type of backer, and (viii) change the geographic location in which the prospect wishes to work or reside; instructions to permit the evaluation to be generated by analyzing via processor at least one of (i) the age of the prospect, (ii) the education of the prospect, (iii) skills or experiences of the prospect, (iv) the personal contacts of the prospect, and (v) past income of the prospect; instructions to permit analyzing the education of the prospect to include analyzing via processor at least one of (i) an educational institution attended by the prospect, (ii) an educational course of study taken by the prospect, (iii) internships performed by the prospect, (iv) grades of the prospect in major coursework of the prospect and (v) the overall grade point average of the prospect; instructions to permit the at least one milestone to include at least one of (i) achieving or exceeding a specified minimum grade point average, (ii) achieving or exceeding a minimum grade on a standardized test (e.g., MCAT, GMAT, GRE, LSAT), and (iii) obtaining an award for work performed; instructions for generating and displaying a graphical interface via processor to permit a user to specify the magnitude of the milestone payment to be established in the personal equity funding agreement to be dependent on performance of the prospect; and/or instructions for generating and displaying a graphical interface to permit a user to view the profile page of the backer, wherein the profile page of the backer includes at least one of (i) a list of social media contacts, (ii) a list of business contacts; (iii) a list of personal contacts, (iv) a field showing prospects invested in by the backer, (v) a histogram illustrating any backers that the backer may have had in the past, (vi) recommendations of the backer by prospects, (vii) recommendations of the backer by third parties, (viii) a field indicating a rating of the backer, (ix) a field explaining a rating of the backer. The contacts of the backer listed on the backer profile can be organized and displayed via processor based on the professional activities of the contacts.

In still further accordance with the disclosure, the one or more programs of the computing device can further include: instructions for assigning a backer rating to the backer via processor based on at least one of (i) objective criteria and (ii) subjective criteria, and displaying the backer rating on the social media platform; instructions to permit the criteria to include at least one of (i) whether the backer adhered to the financial terms of the personal equity funding agreement, (ii) whether the backer was responsive to a communication from a prospect within a predetermined time frame, (iii) whether the backer followed through on a promise to a prospect, (iv) a rating on the quality of the results of a prospect's interactions with the backer, and (v) public visibility of the backer; instructions to permit the basis of the subjective criteria to include at least one of (i) emotional supportiveness toward the prospect, (ii) demonstration of initiative to help the prospect, (iii) the quality of advice given to the prospect, (iv) the quality of contacts provided to the prospect, (v) whether the backer actively introduced the prospect to at least one contact and the quality of the introduction, (vi) the quality of engagements that the backer arranged for the prospect, (vii) the quality of commercial sponsors the backer arranged for the prospect, (viii) the attentiveness of the backer toward the prospect, and (ix) the degree to which the backer kept commitments to the prospect; instructions to permit only individuals that have had direct interactions with the backer through the computer program to rate the backer via processor; instructions to permit the personal equity funding agreement to be discharged for monetary compensation via a buy out of the existing agreement via processor; instructions to permit the value of the monetary compensation to be established through a bidding process via processor; instructions for generating and displaying a graphical interface via processor to permit a user to provide prospect bidding input for initiating the bidding process by the prospect; instructions for generating and displaying a graphical interface via processor for permitting the bidding process to be initiated by the prospect via processor to achieve at least one of (i) obtaining additional capital and (ii) buying out an existing agreement with a backer; instructions for generating and displaying a graphical interface via processor to permit the prospect to make it known to others via processor that the prospect is initiating the bidding process; instructions for generating and displaying a graphical interface via processor to permit the monetary compensation to be established through a bidding process initiated by the backer via processor; instructions for generating and displaying a graphical interface via processor to permit the prospect to reveal to at least one other individual via processor that the prospect is soliciting a valuation to buy out of an existing agreement with the backer; and/or instructions for generating and displaying a graphical interface via processor to require the backer to submit a bid via processor to establish valuation. The requirement for the backer to submit a bid via processor to establish valuation can be triggered by the backer not wishing to terminate the agreement that is in place.

In yet further accordance with the disclosure, the one or more programs of the computing device can further include: instructions for providing conditions via processor to prevent the backer from overpricing the value of the buyout, including at least one of (i) instructions for requiring the backer to provide additional capital to the prospect based on the price bid by the backer, (ii) instructions for requiring the backer to pay a premium to the prospect on the value already obtained by the backer under the existing agreement, and (iii) instructions for requiring the backer to pay the prospect the difference or a fraction of the difference of the amount bid less amounts already paid to the prospect; instructions for generating and displaying a graphical interface via processor to permit the bidding process to involve other backers on the platform who are otherwise not engaged in a funding agreement with the prospect; and/or instructions for generating and displaying a graphical interface via processor for at least one of (i) the prospect soliciting bids via processor over a predetermined time period, (ii) the prospect receiving one or more bids via processor (iii), the prospect selecting one of the bids via processor, (iv) the prospect selecting an average of the bids via processor, and (v) computing the buyout valuation from the average of the bids via a processor.

The one or more programs of the computing device can further include instructions for the bidding process, which in turn can include instructions for analyzing a population of bids via processor, instructions for computing a mean of the bids in the population via processor, instructions for discarding bids that fall more than the standard deviation from the mean via processor, and instructions for averaging the remaining bids to determine the buyout valuation via processor.

The one or more programs of the computing device can still further include: instructions for generating and displaying a graphical interface via processor for assessing a penalty via processor to at least one of the prospect and the backer for exiting the agreement early. The conditions for assessing the penalty can be specified in the personal equity funding agreement. The penalty can include at least one of (i) a fixed percentage of the computed buyout value, (ii) a fixed percentage of a highest bid received in the bidding process, and (iii) a flat fee. The one or more programs can further include: instructions for generating and displaying a graphical interface via processor for permitting the prospect to initiate the buyout process via processor wherein the penalty is borne by the prospect; and/or instructions for generating and displaying a graphical interface via processor for permitting the backer to initiate the buyout process via processor wherein the penalty is borne by the backer. The backer can be a party to the personal equity funding agreement sought to be terminated by the bidding process.

The one or more programs of the computing device can further include: instructions for generating and displaying a graphical interface via processor to permit the backer that initiates the buyout process to be a new backer that is not a party to the original personal equity funding agreement via processor; instructions for generating and displaying a graphical interface via processor for permitting the prospect to initiate the bidding process via processor, wherein the penalty is not assessed against the prospect when the backer has a backer rating that is below a threshold value reflecting that the backer is ineffective; instructions for generating and displaying a graphical interface via processor to permit the bidding process to take place via processor (i) over a predetermined time period (ii) at a randomly selected time by the online social media platform and/or (iii) on demand by the prospect, backer, or an administrator of the online social media platform; instructions for generating and displaying a graphical interface via processor to permit the personal equity funding agreement to be valued through a bidding process via processor without canceling the agreement; instructions for generating and displaying a graphical interface via processor for establishing a contest by the backer via processor, wherein the prospect is invited to apply to win the contest via processor, wherein a prize for winning the contest includes receiving at least one of capital and services from the backer; instructions for generating and displaying a graphical interface via processor for permitting the backer to specify parameters for the contest via processor, the parameters including at least one of (i) a time period during which submissions from prospects will be accepted (ii) the nature of the prize (iii) the time of the drawing and (iv) at least one action that the prospect has to perform that will be evaluated by the backer in determining the winner of the contest; instructions for generating and displaying a graphical interface via processor to permit the backer profile page to include advice for prospects on preparing for and submitting applications to the contest; instructions for generating and displaying a graphical interface via processor for selecting content for delivery to the backer profile page via processor in accordance with a plurality of parameters; instructions for generating and displaying a graphical interface via processor to permit the content to include at least one of (i) newsfeeds, (ii) recommended social media connections, (iii) product placement, and (iv) advertisements for generating revenue; instructions for generating and displaying a graphical interface via processor to permit the plurality of parameters to include at least one of (i) a school attended by the backer or that the backer is following, (ii) an industry in which the prospect or backer is involved, (iii) the gender of the backer, (iv) people that the backer follow or are connected to on social media sites, and (iv) consumer activity of the backer; and/or instructions for generating and displaying a graphical interface via processor for logging behavioral data of users of the online social media platform via processor. The behavioral data can be logged via processor via at least one of a graphical user interface, gestures on a touch-sensitive interface, movement of a pointing device or cursor, and pupil tracking. The one or more programs can further include: instructions for generating and displaying a graphical interface via processor for analyzing the behavioral data via processor to determine appropriate content to send to the user.

The disclosure further provides a computing device having one or more processors, memory, a display screen and one or more programs, wherein the one or more programs are stored in the memory and configured to be executed by the one or more processors, the one or more programs including instructions for operating an online social media platform. The one or more programs include instructions for generating and displaying a graphical interface via processor for facilitating an introduction on the social media platform via processor between a prospect and a backer that wishes to invest capital and mentoring in the prospect, instructions for generating and displaying a graphical interface via processor for establishing an online connection between the prospect and backer via processor on the social media platform to facilitate the investment of at least one of (i) capital and (ii) mentoring in the prospect, and instructions for generating and displaying a graphical interface via processor for providing a first set of online tools on the social media platform via processor to define a contractual relationship that delineates a plurality of parameters that define the investment of at least one of (i) capital and (ii) mentoring, wherein the contractual relationship specifies that future payments of the prospect are to be used to fund other prospects within the online social media platform.

The one or more programs of the computing device can further include: instructions for generating and displaying a graphical interface via processor for directing future payments of the prospect via processor into at least one of (i) a trust or other financial instrument, (ii) a nonprofit or not-for-profit institution or entity; and (iii) a corporation or other for profit entity; instructions for generating and displaying a graphical interface via processor for permitting the prospect to decide which other prospects are funded by the paying prospect's payments via processor; instructions for generating and displaying a graphical interface via processor for tracing money paid by the prospect via processor to each prospect that the prospect funds with their payments to show the progression of successive investments of the money paid by the prospect; instructions for generating and displaying a graphical interface via processor for computing the return on the money invested by the prospect in other prospects; instructions for displaying via processor a virtual account for the prospect showing the amount of revenue generated by the prospect's investment in other prospects; instructions for displaying via processor a virtual account for the backer showing the amount of revenue generated by the backer's investment in the prospect, and further prospects chosen by the prospect; instructions for displaying a virtual account balance via processor including the sum of all revenues generated as a result of the backer's initial investment; instructions for generating and displaying an incremental reward via processor for the backer when an investment by the backer into at least one prospect produces a monetary return based on an affiliation that the online social media platform has with a third party; and/or instructions for generating and displaying a graphical interface via processor to permit the third party to be a sponsor of the social media platform.

The one or more programs can further include instructions for generating and displaying a graphical interface via processor to permit the third party to be an airline, wherein the incremental reward includes airline reward points for the airline, or the third party to be a company producing retail merchandise, wherein the incremental reward permit a recipient to purchase the retail merchandise.

The one or more programs of the computing device can further include: instructions for generating and displaying a graphical interface via processor for receiving booster capital from a booster via processor, wherein the booster capital is provided by the booster via processor without commitment to remunerate the booster; instructions for generating and displaying a graphical interface via processor to permit the booster to include at least one of (i) a wealthy individual, (ii) a person of influence, (iii) a person of notoriety, and (iv) a philanthropic organization; instructions for generating and displaying a graphical interface via processor to permit the booster capital to include at least one of (i) an initial source of capital collected to fund the prospect (ii) an immediate transfer of liquid assets (iii) a pledge of assets in the future, and (v) a pledge of life insurance proceeds or future income; instructions for generating and displaying a graphical interface via processor to permit the booster capital to only be used to fund prospects; instructions for generating and displaying a graphical interface via processor to permit payments made by a first prospect funded with booster capital to be used only to fund other prospects; instructions for generating and displaying a graphical interface via processor to permit the other prospects to be chosen by the first prospect; instructions for generating and displaying a graphical interface via processor to permit the booster to specify what types of projects the booster capital can be used for; instructions for generating and displaying a graphical interface via processor to permit all funds received from a backer to be treated as booster capital if the amount of money is below a threshold amount; instructions for generating and displaying a graphical interface via processor to provide perks to a booster at the discretion of the recipient after receiving booster capital; instructions for generating and displaying a graphical interface via processor to permit funds to be transferred from an account of the backer to an escrow account via processor after the backer capital offer input is received; instructions for generating and displaying a graphical interface via processor s to permit at least some of the funds to be transferred from the escrow account into the prospect's account via processor after the prospect selects the backer and assents to the funding agreement; instructions for generating and displaying a graphical interface via processor to permit the funds to be returned to the backer's account via processor if they are not selected by the prospect; instructions for generating and displaying a graphical interface via processor to permit a hold to be placed on funds in an account via processor of the backer after the backer capital offer input is received; instructions for generating and displaying a graphical interface via processor to permit at least some of the funds to be transferred from the backer's account into at least one of an escrow account and the prospect's account via processor after the prospect selects the backer and assents to the funding agreement; instructions for generating and displaying a graphical interface via processor to permit the hold to be released on the funds in the backer's account via processor if the backer is not selected by the prospect; instructions for generating and displaying a graphical interface via processor to permit the social networking platform to initiate an ACH transaction via processor after the backer capital offer input is received; instructions for generating and displaying a graphical interface via processor to permit the social networking platform to instruct a financial institution via processor to make a claim against the backer's account after receiving authorization from the backer to do so; instructions for generating and displaying a graphical interface via processor to permit the social networking platform to release the ACH hold via processor if the backer is not selected by the prospect; instructions for generating and displaying a graphical interface via processor to permit the social media platform to automatically provide tax information to backers and prospects via processor; and/or instructions for generating and displaying a graphical interface via processor to permit amounts paid back by the prospect during the first year of repayment required by the personal equity funding agreement to be based on computations from an income projection estimate performed via processor on the social networking platform.

The one or more programs can further include instructions for generating and displaying a graphical interface via processor to permit, the social media platform to receive by processor actual income input from the prospect at the end of the first year of repayment, the social media platform to compare the actual income input of the prospect with the projected income of the prospect via processor, and the social media platform to determine via processor any amounts to be paid to or from the prospect in order to satisfy the requirements of the personal equity funding agreement.

The one or more programs of the computing device can further include: instructions for generating and displaying a graphical interface via processor to permit the prospect to make quarterly, monthly, or annual payments to the backer via processor under the personal equity funding agreement; instructions for generating and displaying a graphical interface via processor to permit funds received in the backer's account from the prospect to be removed or reinvested by the backer via processor; instructions for generating and displaying a graphical interface via processor to permit the portion of payments to be automatically reinvested in other prospects via processor; instructions for generating and displaying a graphical interface via processor to permit the other prospects to be selected by the backer via processor; instructions for generating and displaying a graphical interface via processor to permit the other prospects to be selected by the prospect via processor; instructions for generating and displaying a graphical interface via processor to permit the other prospects to be selected by an administrator of the social media platform via processor; instructions for generating and displaying a graphical interface via processor to permit the prospect to specify what types of activities the payments can be used to pay for via processor; instructions for generating and displaying a graphical interface via processor to permit the portion of payments to be used to purchase mentorship outside of the prospect's network; instructions for generating and displaying a graphical interface via processor to permit the portion of payments to be expressed in a non-monetary denomination; instructions to permit the non-monetary denomination to include points or credits; instructions for generating and displaying a graphical interface via processor to permit capital that is unused by a prospect to be automatically deposited via processor into a general fund managed by an administrator of the social media platform; instructions for generating and displaying a graphical interface via processor to permit money invested by a backer to be automatically applied to at least one prospect via processor; instructions to permit the at least one prospect to become automatically fully funded via processor once having reached a predetermined percentage of desired funding; instructions for generating and displaying a graphical interface via processor to permit the predetermined percentage of desired funding to range from 0 to 99 percent in increments of one percent; instructions for generating and displaying a graphical interface via processor to permit criteria determining the automatic application of the money to be established by the backer via processor; instructions for generating and displaying a graphical interface via processor to permit information disclosed by the prospect to include a description of any moral obligations or philosophical opinions the prospect has that could impact their ability to fulfill their obligations under the funding agreement; instructions for generating and displaying a graphical interface via processor to permit the pre-existing financial obligations of the prospect to include at least one of (i) a description of all legal debts to which the prospect is obligated, (ii) any alimony payments for which the prospect is responsible and (ii) a description of any civil judgments against the prospect; instructions to permit the criteria to be evaluated via processor to generate the backer rating via processor by analyzing feedback received from prospects with whom the backer has worked or third parties that know the backer; instructions for generating and displaying a graphical interface via processor to permit a backer to provide backer level input via processor relating to a level of commitment desired by the backer, wherein different backer levels require increasing amounts of commitment on the part of the backer; instructions for generating and displaying a graphical interface via processor to provide at least three backer levels to be provided via processor; instructions for generating and displaying a graphical interface via processor to provide a first, basic backer level that requires only providing capital to the prospect; instructions for generating and displaying a graphical interface via processor to provide a second, intermediate backer level that requires at least one of (i) periodic communications between the backer and prospect, and (ii) providing professional introductions by the backer to the prospect; instructions for generating and displaying a graphical interface via processor to provide a third, upper backer level that requires at least one of (i) a weekly telephone conference with the prospect to discuss the prospect's progress, (ii) in-person mentorship meetings with the backer and prospect at regular time intervals, and (iii) active endorsement of the prospect by the backer in a public forum; instructions for generating and displaying a graphical interface via processor to permit the backer to change their backer level via processor during the term of the personal equity funding agreement; and/or instructions to permit the remuneration to the backer to be affected by the backer choosing to change their backer level. The effect on the backer's remuneration of the backer changing the backer level can be specified in the personal equity funding agreement, for example. Choosing a higher backer level can result in the backer being provided with privileges not available at a lower backer level.

The disclosure also provides a computing device having one or more processors, memory, a display screen and one or more programs, wherein the one or more programs are stored in the memory and configured to be executed by the one or more processors, the one or more programs including instructions for operating an online social media platform. The one or more programs include instructions for generating and displaying a graphical interface via processor for facilitating an introduction on the social media platform via processor between a prospect and a backer that wishes to invest capital and mentoring in the prospect, instructions for generating and displaying a graphical interface via processor for establishing an online connection between the prospect and backer via processor on the social media platform to facilitate the investment of at least one of (i) capital and (ii) mentoring in the prospect, instructions for generating and displaying a graphical interface via processor for providing a set of online tools on the social media platform via processor to generate a map of circles of influence relating to at least one of the prospect and the backer, and instructions for generating and displaying a graphical interface via processor for displaying the map via processor.

The one or more programs of the computing device can further include: instructions for generating and displaying a graphical interface via processor to permit the map to illustrate via processor who the backer and prospect are affiliated with; instructions for generating and displaying a graphical interface via processor to permit the circles of influence to be determined via processor based on a common interest of a plurality of users of the social media platform; instructions for generating and displaying a graphical interface via processor to permit the recommendation to be generated via processor at least in part due to at least one material factor; instructions for generating and displaying a graphical interface via processor to permit the at least one material factor to include at least one of (i) a shared passion of the backer and prospect, (ii) a common educational institution shared by the backer and prospect, (iii) a common region of origin shared by the backer and the prospect, (iv) a common profession of the backer and prospect, and (v) a common favorite sports team of the backer and prospect; and/or instructions for generating and displaying a graphical interface via processor to permit the backer to be a brand name manufacturer or an institution, and instructions for permitting the backer to advertise that they are sponsoring the prospect.

The disclosure also provides a computing device having one or more processors, memory, a display screen and one or more programs, wherein the one or more programs are stored in the memory and configured to be executed by the one or more processors, the one or more programs including instructions for operating an online social media platform. The one or more programs include instructions for generating and displaying a graphical interface via processor for facilitating an introduction on the social media platform via processor between a prospect and a backer that wishes to invest capital and mentoring in the prospect, instructions for generating and displaying a graphical interface via processor for establishing an online connection between the prospect and backer via processor on the social media platform to facilitate the investment of at least one of (i) capital and (ii) mentoring in the prospect, and instructions for generating and displaying a graphical interface via processor for providing a first set of online tools on the social media platform via processor to define a contractual relationship that delineates a plurality of parameters that define the investment of at least one of (i) capital and (ii) mentoring, wherein the contractual relationship specifies that future payments of the prospect under the contract are to be used for charitable purposes.

The one or more programs of the computing device can further include instructions for generating and displaying a graphical interface via processor to permit the future payments of the prospect to be directed into a not-for-profit institution for funding of other prospects; instructions for generating and displaying a graphical interface via processor to permit the future payments of the prospect to be directed into a trust for funding of other prospects; instructions for generating and displaying a graphical interface via processor to permit funds to be provided to the prospect under the personal equity funding agreement on a prepaid payment card.

The disclosure provides a computing device having one or more processors, memory, a display screen and one or more programs, wherein the one or more programs are stored in the memory and configured to be executed by the one or more processors, the one or more programs including instructions for operating an online social media platform. The one or more programs include instructions for generating and displaying a graphical interface via processor for facilitating an introduction on the social media platform via processor between a prospect and a backer that wishes to invest capital and mentoring in the prospect, instructions for generating and displaying a graphical interface via processor for establishing an online connection between the prospect and backer via processor on the social media platform to facilitate the investment of at least one of (i) capital and (ii) mentoring in the prospect, and instructions for generating and displaying a graphical interface via processor including an online discussion board portal on the social media platform via processor where a prospect can initiate a discussion with one or more individuals on the social networking platform.

The one or more programs of the computing device can further include: instructions for generating and displaying a graphical interface via processor to permit the prospect to define a sub-community of users within the social media platform to participate with the prospect on the discussion board portal; instructions for generating and displaying a graphical interface via processor to permit the users to include backers with whom the prospect has entered into a personal equity funding agreement; instructions for generating and displaying a graphical interface via processor to permit a message to be generated and routed to at least one individual when the prospect initiates a discussion on the discussion board portal; instructions for generating and displaying a graphical interface via processor to permit the message to only be routed to backers that wish to receive the message; instructions for generating and displaying a graphical interface via processor to permit a backer at a first level of mentoring participation with the prospect to automatically opt out of receiving the message; instructions for generating and displaying a graphical interface via processor to permit a backer at a second level of mentoring participation with the prospect that is higher than the first level involved to automatically opt into of receiving the message; instructions for generating and displaying a graphical interface via processor to permit the discussion board portal to be displayed within a profile page of the prospect; instructions for generating and displaying a graphical interface via processor to permit the discussion to include a question that the prospect wants answered; instructions for generating and displaying a graphical interface via processor to permit the prospect to be able to direct the question to all users of the social media platform; instructions for generating and displaying a graphical interface via processor for directing the question to an administrator for approval prior to directing the message to all users of the social media platform; instructions for generating and displaying a graphical interface via processor to permit the prospect to set permissions to permit different users to view the discussion portal; instructions for generating and displaying a graphical interface via processor for directing a discussion thread on the portal to a second online social media platform; instructions for generating and displaying a graphical interface via processor to permit the second online social media platform to be the Facebook® platform, the LinkedIn® platform, the Twitter® platform, or another platform; instructions for generating and displaying a graphical interface via processor to permit the personal equity funding agreement to provide for a penalty if one of the parties to the personal equity funding agreement does not abide by the terms of the agreement; instructions for generating and displaying a graphical interface via processor to permit the penalty to include at least one of (i) being denied contact with other users of the platform, (ii) having a quality rating of the non-abiding party degraded, (iii) being denied the ability to enter into another personal equity funding agreement until the defect is cured and (iv) a monetary penalty; and/or instructions for generating and displaying a graphical interface via processor to permit the personal equity funding agreement to not close and be funded until a prospect's funding goal is reached.

The accompanying drawings, which are incorporated in and constitute part of this specification, are included to illustrate and provide a further understanding of the methods and systems of the disclosure. Together with the description, the drawings serve to explain the principles of the disclosed embodiments.

### BRIEF DESCRIPTION OF THE DRAWINGS

The accompanying drawings illustrate various non-limiting, example, innovative aspects in accordance with the present descriptions:

FIGS. 1A-1D show block diagrams illustrating exemplary aspects of embodiments of a Pave™ community and social network in accordance with the present disclosure;

FIGS. 2A-2B show aspects of exemplary PAVE™ profile pages in accordance with the present disclosure;

FIGS. 3A-3D show data flow diagrams illustrating aspects of a PAVE™ community and social network in accordance with the present disclosure;

FIGS. 4A-4E show logic flow diagrams illustrating aspects of embodiments of the PAVE™ community and social network in accordance with the present disclosure;

FIG. 5 shows a block diagram illustrating aspects of an exemplary embodiment of a PAVE™ controller in accordance with the present disclosure;

FIG. 6 shows a simplified schematic block diagram illustrating aspects of a PAVE™ Backer Offer Information Receiving (“PBOIR”) Component in accordance with the disclosure.

FIG. 7 illustrates a simplified Pave™ Personal Equity Funding Agreement Negotiation (“PPEFAN”) component in accordance with the disclosure.

FIG. 8 illustrates a simplified Pave™ Backer Profile Verification (“PBPV”) component in accordance with the disclosure.

FIG. 9 illustrates a Pave™ Matching Engine (“PME”) component in accordance with the disclosure.

FIG. 10 illustrates aspects of a buyout or valuation procedure for the funding agreement.

FIG. 11 illustrates aspects of formation of a Pave™ agreement in accordance with the disclosure.

FIG. 12 is a view of a first portion of a Pave™ prospect profile page in accordance with the disclosure.

FIG. 13 is a view of a second portion of a Pave™ prospect profile page in accordance with the disclosure.

FIG. 14 is a view of a third portion of a Pave™ prospect profile page in accordance with the disclosure.

FIG. 15 is a view of a fourth portion of a Pave™ prospect profile page in accordance with the disclosure.

FIG. 16 illustrates aspects of a Pave™ income estimator and disclosure schedule in accordance with the disclosure.

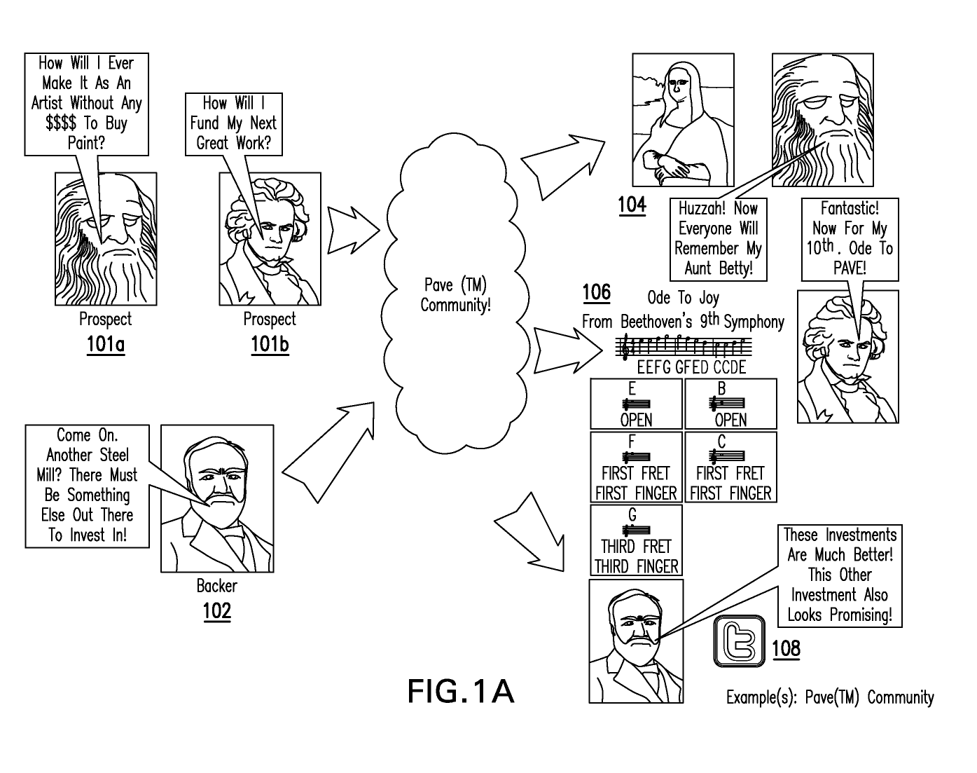

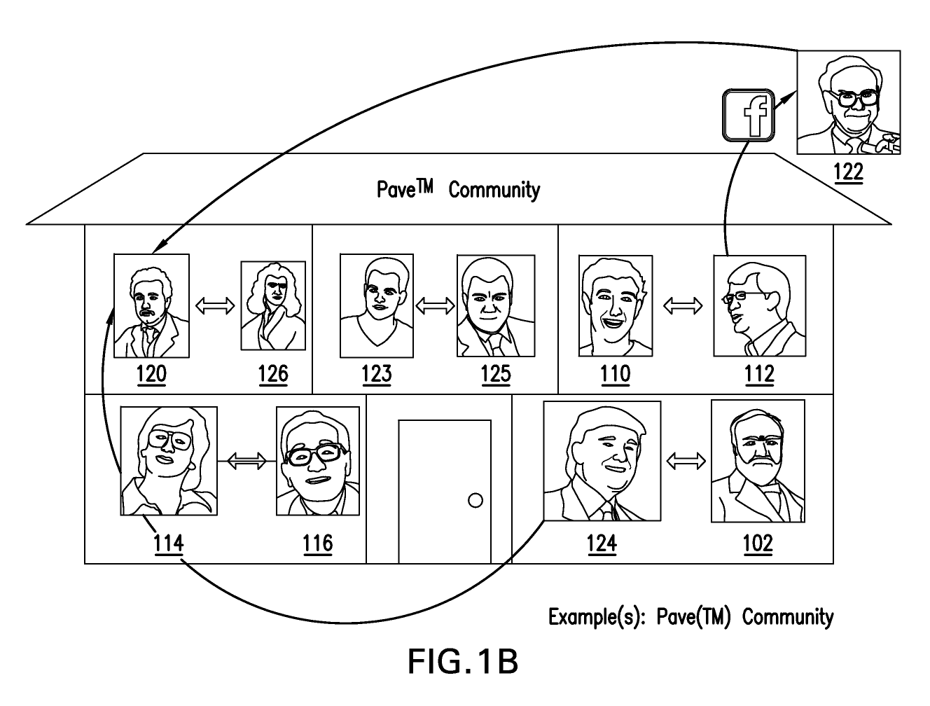

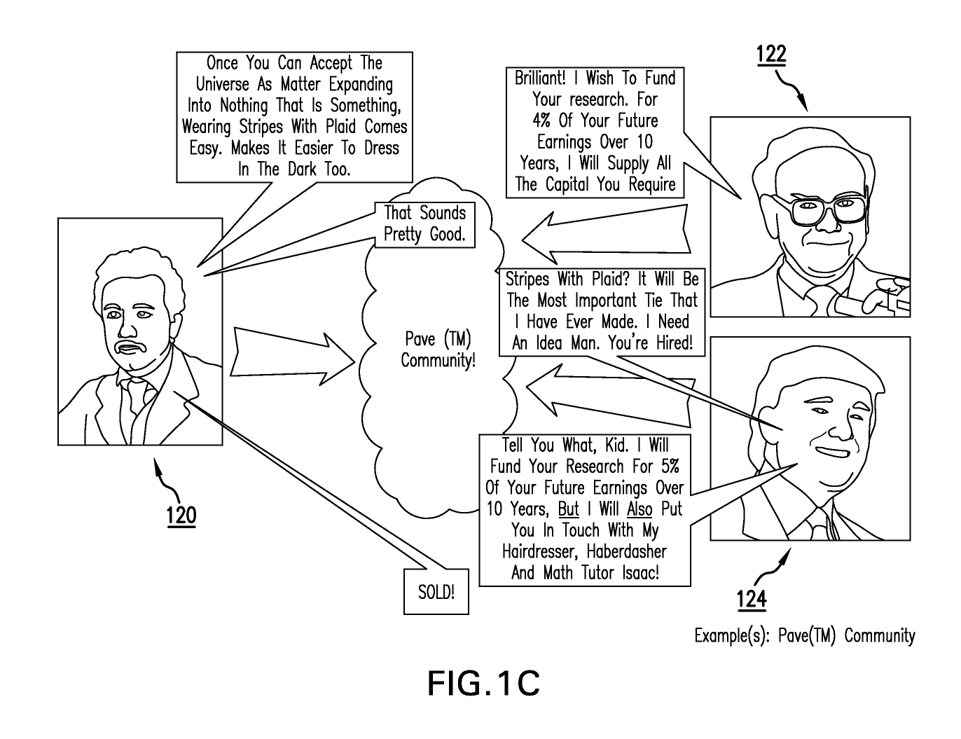

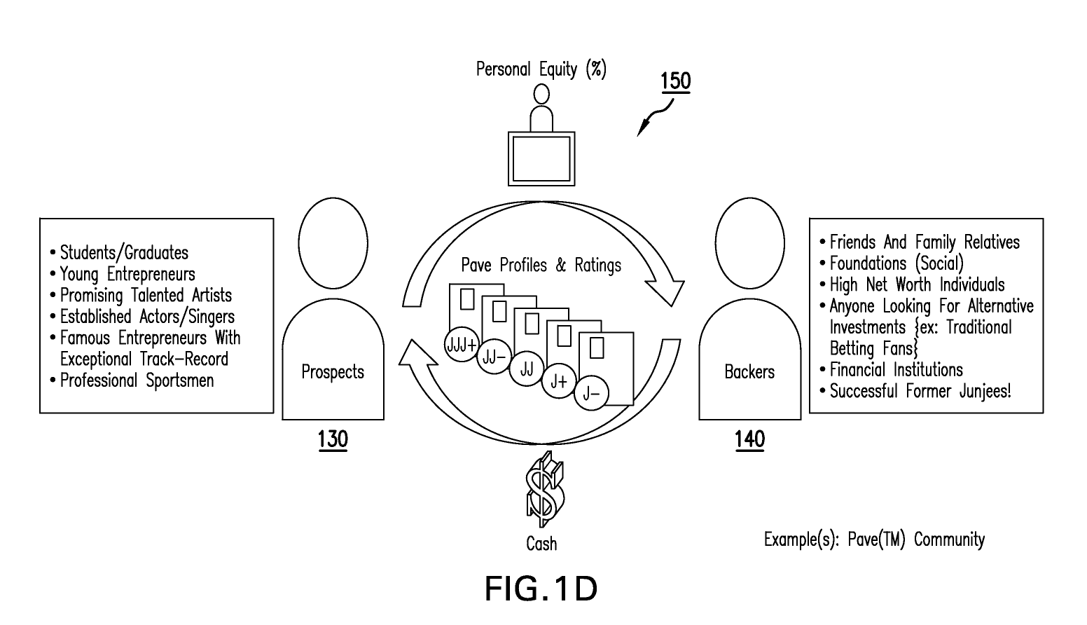

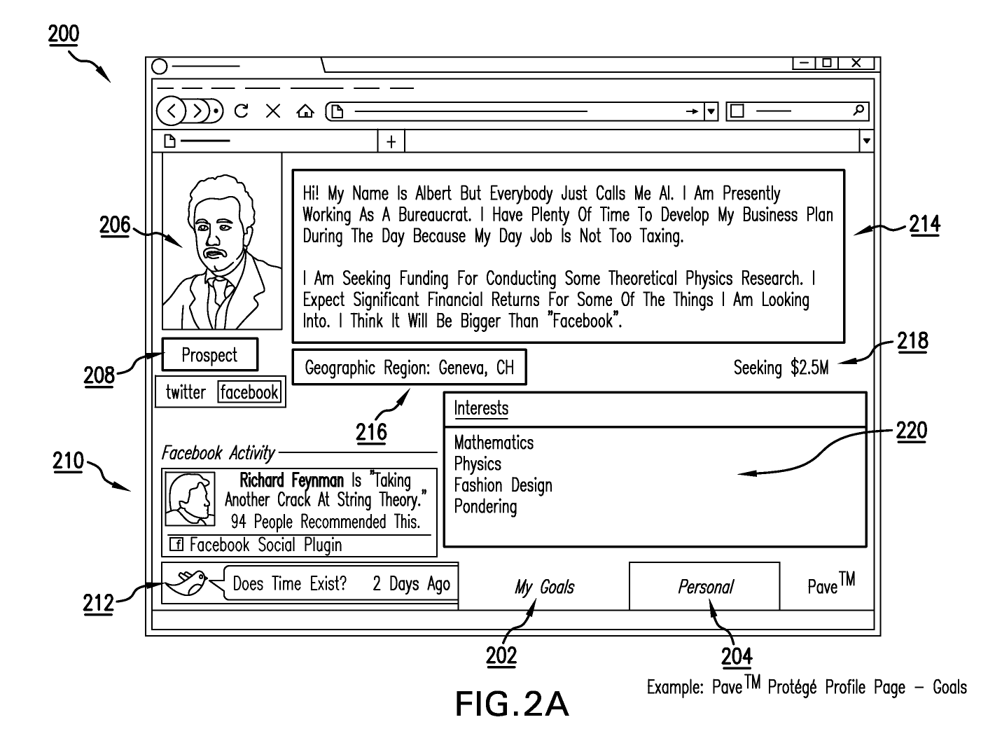

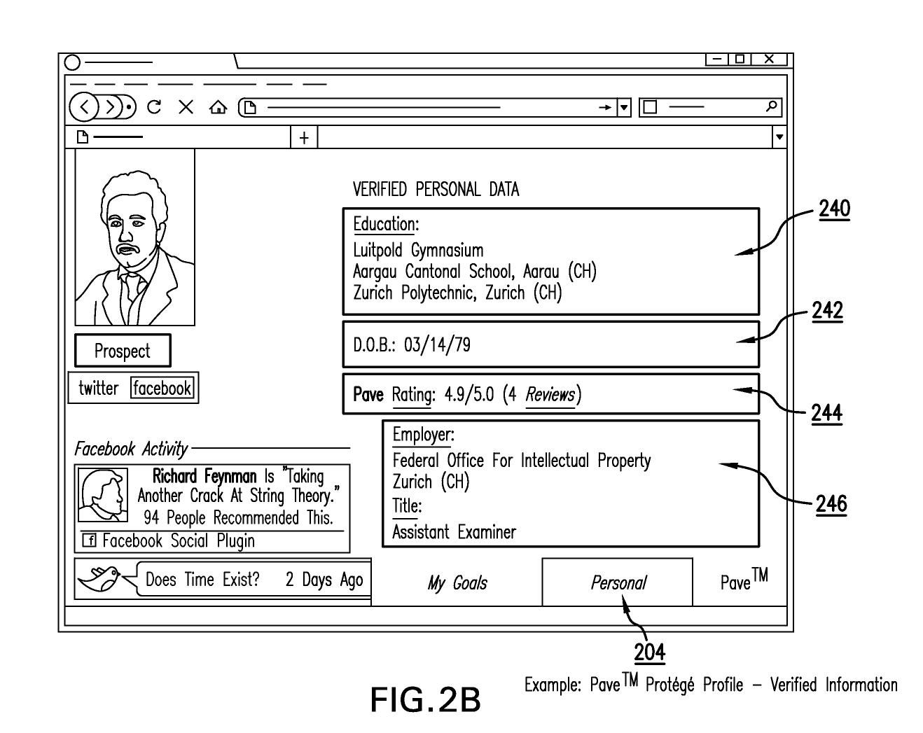

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The APPARATUSES, METHODS AND SYSTEMS FOR PROVIDING DYNAMIC PAGE CONTENT (hereinafter “PAVE™” community and social network or components) transform aspects of relationships between participants of the PAVE™ community and social network, via PAVE™ components, in response to participant inputs. It will be understood that while some embodiments disclosed herein have been illustrated in the Figures, that the full technical description herein is enabling and supports all disclosed embodiments.

FIGS. 1A-1D show block diagrams illustrating exemplary aspects of a PAVE™ community and social network in some embodiments of the PAVE™. With reference to FIG. 1A, in some implementations, a prospect or prospective prospect 101a, 101b seeking capital and/or services to further at least one goal are provided. Such individuals may be anyone seeking funding or mentoring, such as, for example, a film maker, a vocal performer, a sculptor, painter or other artist, an archaeologist, an athlete (e.g., boxer/fighter), a politician, social reformer or entrepreneur, an institution (e.g., opera company, educational institution, youth organization, charity, etc.), a graphic artist, celebrity, author, student or the like.

Similarly, one or more backers are also provided. The backers are individuals or entities having capital or access to capital and/or services of value. Backers can include, by way of example only, a philanthropist, an artistic institution, a professional investor, a member of the general public, a political organization, an athlete, an entrepreneur, a financial institution, an educational institution, a former prospect that previously participated in the social network, media company, movie studio, museum, opera company, or the like.

Thus, by way of embodiments of the Pave™ community and social network, prospects and backers may collaborate to help the prospects to succeed in their goals and endeavors, as illustrated in FIG. 2B. While a prospect (e.g., 120, 123, 110, 114, 124) may only seek a capital contribution initially, the prospect may also come to learn, by participating in the Pave™ community, that they will also benefit from services of those backers more experienced in their field (e.g., 126, 125, 112, 116, 102), or in fields that are important to the prospect. Thus, while the prospect may seek advance capital payment(s) in exchange for future prospect income, the prospect may come to also desire services of backers, such as services relating to, for example, mentoring in any relevant field, networking and contact building via the backer, professional lessons for aspiring artists (e.g., voice lessons, acting lessons, dance lessons and the like), or any other service of benefit to the prospect. For the disclosed embodiments result in financial remuneration to the backer if the prospect is successful, the backer has a vested interest in making sure that the prospect is successful. Prospects or backers (e.g., 112) that have become enthusiastic about the community may also invite friends and colleagues (e.g., 122) to join the community where they can network and get to know others in the community.

In some instances, there may be more than one backer (122, 124) interested in funding a prospect (120), as illustrated in FIG. 1B-1C. In such instances, the prospect can have the choice of not only obtaining capital in exchange for future income and/or services, but may obtain invaluable mentoring or other services (e.g., introductions to others of influence) that can prove critical in becoming successful and attaining goals. Thus, while a prospect 120 may receive an attractive offer for capital requiring a relatively lower commitment later in time from a first backer (e.g., 122), a second backer (e.g., 124) may also offer valuable services to the prospect. Thus, as illustrated in FIG. 1D, in various embodiments, the disclosed social networking platform 150 and related methods can provide for a community including prospects 130 (e.g., “Prospects”) and backers 140 (e.g., “Backers”) that can leverage off of each other's talent and connections, providing a synergistic result.

In accordance with many embodiments, the online social media platform will include profile pages for prospects and backers to permit prospects to form social networking connections with prospects and backers, and permit backers to connect with other backers as well as prospects.

For purposes of illustration, and not limitation, as embodied herein, FIGS. 2A-2B illustrate an exemplary online user profile 200 for a prospect. In some embodiments, the profile can include a plurality of pages 202, 204, as depicted. FIG. 2A illustrates an exemplary goals page of a prospect including outward facing information that the prospect wishes other members of the community to see. Such a profile page 202 can include, for example, a photograph 206 of the prospect, and may include identifying information 208. While an actual name could be used in some embodiments, it is also possible to use a nickname, or even an identifying number. The identifying number can be defined by the prospect and/or the social networking system. In some embodiments, the prospect can reveal their identity to the entire community, or to only some members of the community, as desired.

In further accordance with FIG. 2A, if desired, the profile page 202 can include other embedded objects such as frames or other objects including feeds (210, 212) from other websites (e.g., social networking sites) and the like. Preferably, profile page 202 includes one or more fields 214, 220 for including a mission statement, interests and/or objectives of the prospect. Any other desired information can be included on the page 202 as described herein, including, for example, an amount of funding 218 desired by the prospect, the geographic location 216 of the prospect, and the like.

FIG. 2B illustrates a further page 204 of the prospect profile 200 illustrating information that has been verified, for example, by or by way of an administrator of the social networking platform 150. Such verified information can include, for example, educational information 240 of the prospect 120, indicating where the prospect attended school and any degrees received, vital statistics 242 of the prospect, such as date of birth, an objective and/or subjective rating 244 of the prospect 120 as disclosed herein, employment information 246 indicating present and/or past employment positions, and the like. In some implementations, PAVE™ social networking platforms may be utilized for authentication/verification purposes, and for providing digital consent for disclosure of personal and/or private information, such as actual usage information or other information. Backers may be provided with similar profiles 200, as described elsewhere herein.

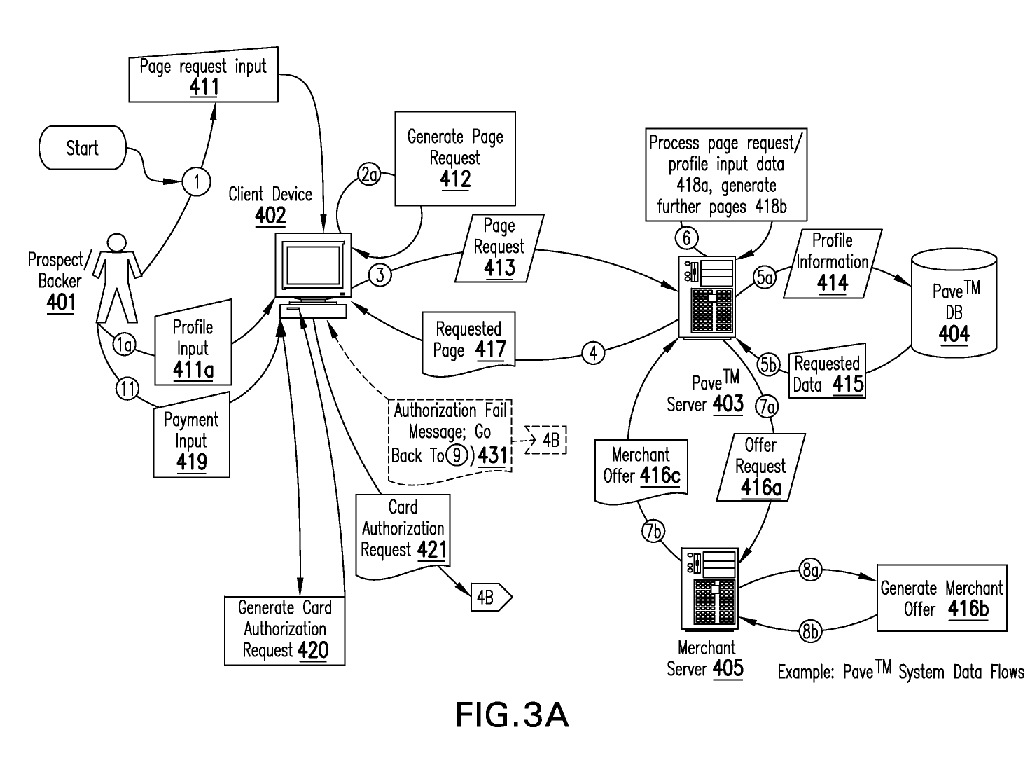

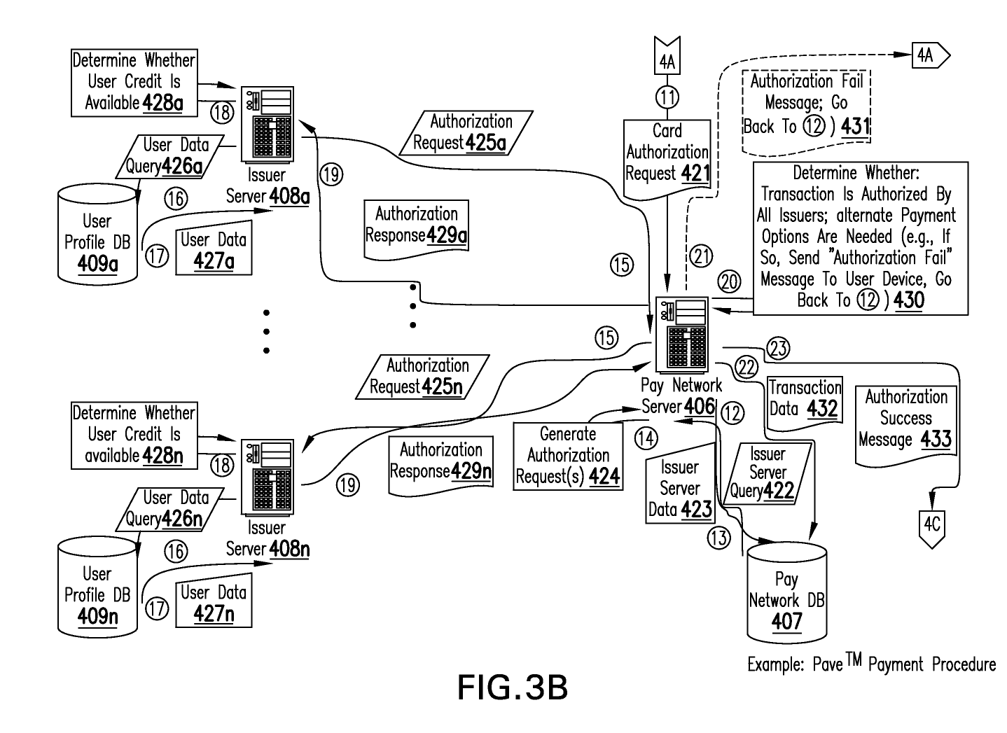

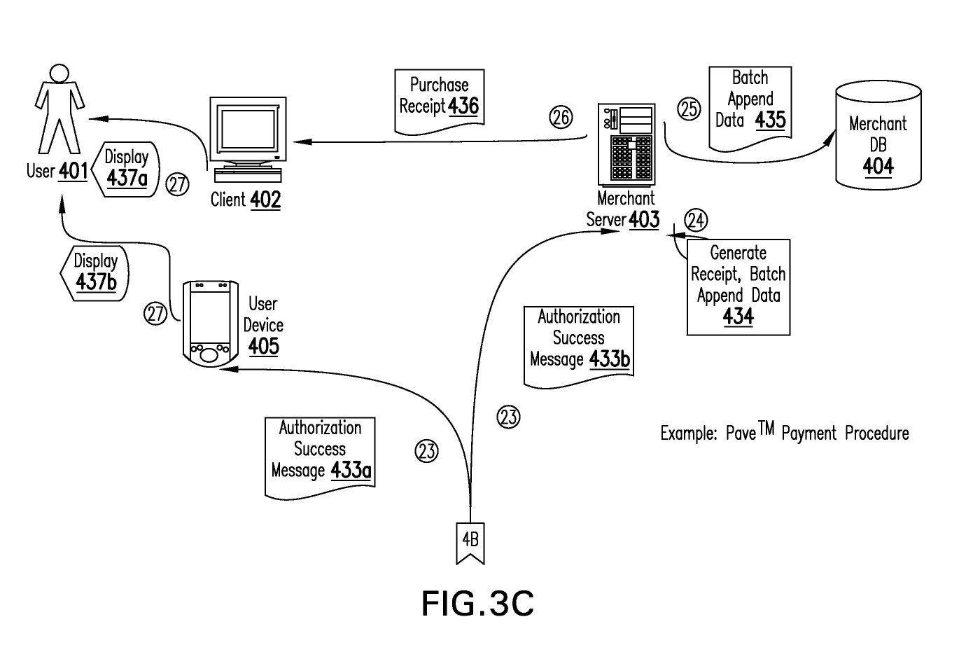

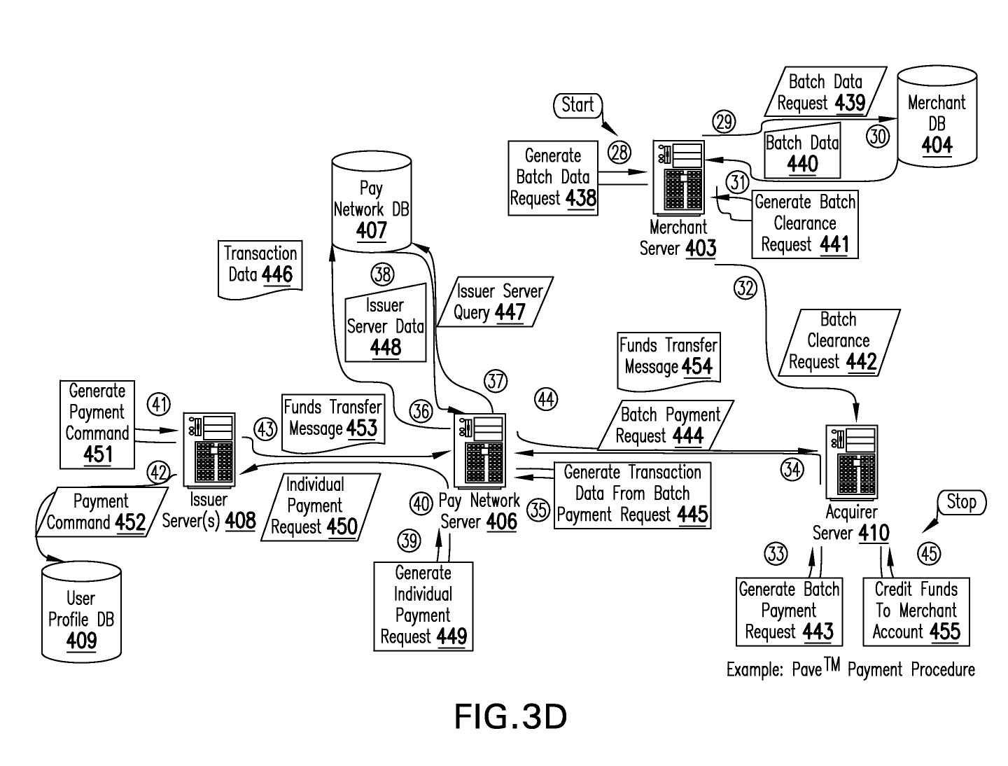

FIGS. 3A-D show data flow diagrams illustrating exemplary systems and procedures for providing a PAVE™ social networking platform in accordance with the disclosure. With reference to FIG. 3A, in some implementations, a user 401, such as a prospect or backer, may desire to request a page from and/or to provide input to a server (e.g., a Pave™ server 403). The user 401 may communicate with the server 403 via a client such as, but not limited to: a personal computer, mobile device, television, point-of-sale terminal, kiosk, ATM, and/or the like (e.g., 402). For example, the user 401 may provide user input, e.g., page request input 411, into the client 402 indicating the user's desire to request a page, or to provide input (e.g., with regard to providing the parameters for a prospect funding agreement or any other inputs described herein such as transferring funds). For example, a user 401 at a desktop station or in transit may submit a request for a page, for example, by typing or copying a URL into a browser, by clicking or touching on an object, or the like. The client 402 may then generate a page request, e.g., 412, and provide the page request to the behavior adapter server 403 via step 413. For example, the client 402 may provide a (Secure) Hypertext Transfer Protocol (“HTTP(S)”) GET message including the page details for the behavior adapter server in the form of data formatted according to the eXtensible Markup Language (“XML”). Below is an example HTTP(S) GET message including an XML-formatted page request for the behavior adapter server:

GET /<<prospectpagetemplate>> HTTP/1.1
Host: <<Pave.com>>
User-Agent: Mozilla/5.0 (Macintosh; Intel Mac OS X 10.7; rv:8.0)
Gecko/20100101 Firefox/8.0
Accept: text/html,application/xhtml+xml,application/xml;q=0.9,*/*;q=0.8
Accept-Language: en-us,en;q=0.5
Accept-Encoding: gzip, deflate
Accept-Charset: ISO-8859-1,utf-8;q=0.7,*;q=0.7
Referer: <<http://www.Pave.com/prospectpagetemplate >>
Cache-Control: max-stale=0
Connection: Keep-Alive
X-BlueCoat-Via: b629d7b84667d49e

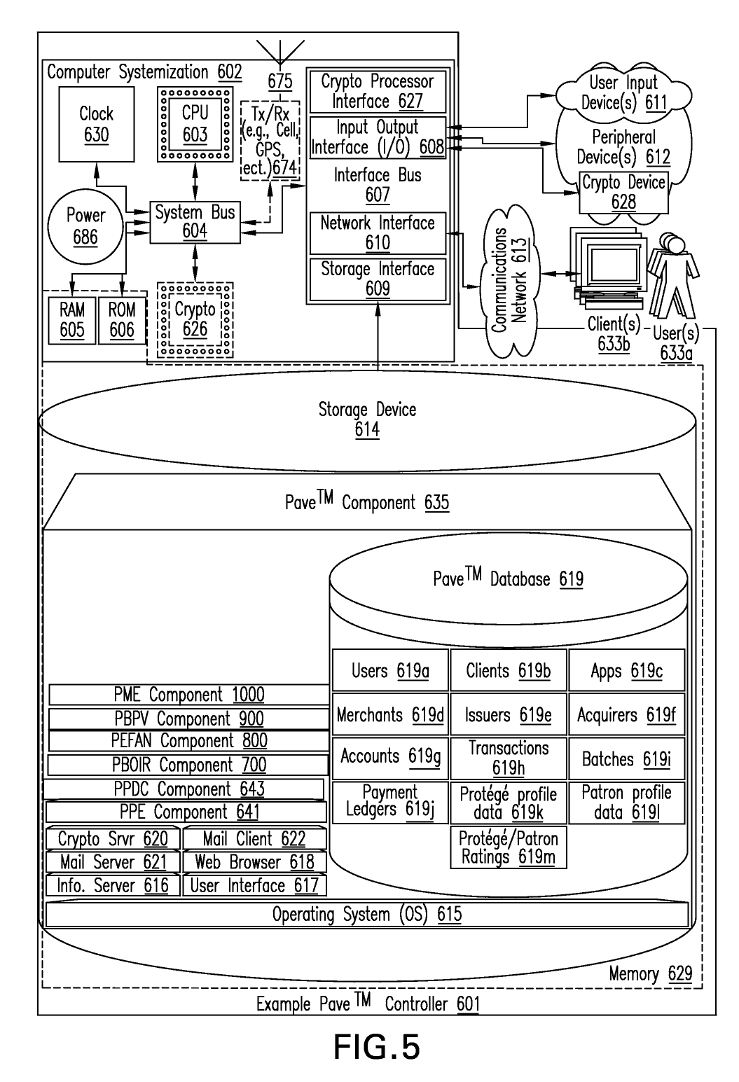

In some implementations, the social network platform (e.g., Pave™) server 403 may obtain the page request from the client 402, and extract the page detail (e.g., XML data) from the page request. For example, the behavior adapter server 403 may utilize a parser such as the example parsers described below in the discussion with reference to FIG. 5.

If the user 401 has requested a page from the server 403 in the first instance, a page containing a PAVE™ user interface can be assembled into a HTML or other document and delivered to the user as a requested page response 417.

Once received by the client, the client 402 displays the PAVE™ user interface to the user 401. The user then interacts with the PAVE™ user interface, such as by providing various inputs (such as for preparing backer or prospect profiles, for forming terms of a prospect funding agreement, for negotiating agreements, or any other action contemplated herein) including by moving a cursor about the user interface by using a pointing device, or by interacting with a touch screen, and making entries by keyboard, touch screen and the like. The user 401 can be provided with user interfaces of various types, including those having pull down menus, check boxes, radio buttons, actuators and the like.

In some implementations, the server 403 may query, e.g., 414, a (e.g., Pave™) database, e.g., 404, to store or obtain various data, e.g., 415, such as prospect or backer profile data, prospect funding agreement information, funding or financial information, and the like. For example, the database 404 may be a relational database responsive to Structured Query Language (“SQL”) commands. The behavior adapter server may execute a hypertext preprocessor (“PHP”) script including SQL commands to query the database for various data. An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“PROSPECTPROFILEDATA.SQL”); // select database
table to search
//create query
$query = “SELECT funding_percentage FROM Prospectprofiledata”;
$result = mysql_query($query); // perform the search query
mysql_close(“PROSPECTPROFILE.SQL”); // close database access
?>

In some implementations, the Pave™ server 403 can generate and send an offer request 416a to a merchant server 405. Merchant server 405 can then in turn generate a merchant offer 416b for goods, services or the like and send the merchant offer 416c to the Pave™ server 403 to include the merchant offer as a content object within a portion of the user interface that is sent to the user 401.

Thus, after receiving an updated page request and/or user data 415, the Pave™ server 403 can generate and send an updated page in an updated page response 417. The updated page can include more or less content than the earlier page and adjust the position and size of the content. A page accompanying such a response 417 can further include a merchant offer (from step 8(b)) illustrated in FIG. 3A, among other things.

Content or other recommended items can be supplied to a prospect or backer in accordance with a variety of criteria as discussed herein. In some implementations, the client device executing an application displaying the social networking platform to a user may generate, maintain, update and/or store data pertaining to the user's interaction with the platform (e.g., an application state, an app data structure, a block of memory with data variables, a Flash movie clip indicating eye/pupil viewing patterns, etc.). For example, the application may store a data structure encoded according to the JavaScript Object Notation (“JSON”) format. An exemplary JSON-encoded data structure is provided below:

“app_data”
{
“app_id”: “A236269”,
“app_name”: “logger”,
“user_id”: “jqpublic”,
“user_name”: “John Q. Public”,
“website_id”: “AHWJ20100630”,
“md5_auth”, “f585e3efede0c3b400b25908f8fa3f6d”,
“user_action”: {

“timestamp”: “2011-01-10 09:23:47”,
“action_type”: “halfclick”,
“xy_coordinates”: “342, 151”,
″geographic_coordinates″: ″37 23.516 −122 02.625″,
″perceived_pupil_vector_xy″:″315, 146″,

}

As will be appreciated, the JSON-encoded data structure can include data relating to a variety of variables, including, for example: (i) each instance of mouse hovering at a particular x-y location, a time stamp relating to when the hovering began and the duration of such hovering, (ii) each instance of a mouse half click/single click/1.5 clicks/2.0 clicks and 2.5 clicks and so on, including a timestamp of when the clicking even occurred and the location of such event, (iii) the geolocation of the user and/or client including a time stamp as to when the user was that location, (iv) pupil tracking activity of the user including a time stamp, time increment, computed x-y location of the screen the user is computed to be viewing, and the like.

In some implementations, the logging application may provide data stored on a client device (e.g., 402) for the server 403 or other servers. For example, an Adobe® Flash object may include ActionScript™ 3.0 commands to create a Secure Sockets Layer (“SSL”) connection with a server, generate a message including a JSON-encoded data structure such as illustrated in the example above, and send the message via the secure SSL connection to the server. Exemplary commands, written substantially in the form of ActionScript™ 3.0, to create a secure SSL connection to a server, load data from a locally stored JSON-encoded data file, and send a message including the JSON-encoded data via the SSL connection to the server, are provided below:

// import required packages
import flash.events.*;
import flash.net.socket;
import flash.net.URLLoader;
import flash.net.URLRequest;
import com.adobe.serialization.json.*;
// obtain server socket policy file, create socket connection to server port
system.security.loadPolicyFile(“xmlsocket://utilities.visa.com:208”);
msg = new socket( );
msg.connect(“https:// utilities.visa.com”, 255);
// load data as text string from .json file
var loader:URLLoader = new URLLoader( );
var request:URLRequst = new URLRequest( );
request.URL = “data.json”;
loader.dataformat = “text”
loader.load(request)
// transmit data to server via secure SSL connection, then close socket
msg.writeMultiByte(loader.data, “UTF-8”);
msg.close( );

In some implementations, the server (e.g., 403) receiving data from the client device 402 executing the app may obtain the data, extract variables from the data if needed, and store the data and/or variables in a user profile having a plurality of fields as described herein in database 404. For example, with reference to the exemplary client transmission of JSON-encoded data via a SSL connection provided above, the server may be executing a Hypertext Preprocessor (“PHP”) script. The PHP script may implement a SSL socket server which listens to incoming communications on a server port to which the client device sends the JSON-encoded data. Upon identifying an incoming communication, the PHP script may read the incoming message from the client device, parse the received JSON-encoded text data to extract information from the JSON-encoded text data into PHP script variables, and store the data and/or extracted information in a relational database accessible using the Structured Query Language (“SQL”). An exemplary listing, written substantially in the form of PHP/SQL commands, to accept JSON-encoded text data from a client device via a SSL connection, parse the text data to extract variables, and store the data to a database, is provided below:

<?PHP
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in database 404
mysql_connect(″254.93.179.112″,$DBserver,$password); // access
database server
mysql_select(″PROSPECTUSAGEDATA.SQL″); // select database to
append
mysql_query(“INSERT INTO prospect_usage_info (transmission)
VALUES ($data)”); // add data to prospect_usage_info table in
Usagedata database
mysql_close(″PROSPECTUSAGEDATA.SQL″); // close connection to
database
?>

Thus, as set forth above, the usage data/input from a user 401 can include a compilation of the x-y coordinates of the cursor over time, and/or a compilation/recording of the screen touches of the user 401. This data can then be processed by the server 403. Processing the data can include transforming the cursor data into a usage map of the user interface in terms of x-y coordinates by correlating the x-y data over time with the x-y coordinates of each element of content in the graphical user interface. The processing can additionally or alternatively include computing the amount of time that the cursor occupied each region of the user interface. This data can then be stored in tabular format, for example, in the database 404. The usage data may be provided in batches in specific time increments (e.g., every second, five seconds, ten seconds, twenty seconds, or the like) by action of the logging program or when user 401 requests a further page.

The usage data can then be used to determine if certain types of content should or should not be provided to the user 401. The usage data can also be compared with earlier usage data, and/or with respect to a model intended to predict the type of content a user 401 would be expected to interact with. If the user 401 is interacting with the user interface in a manner that is determined to be favorable, the content may not be updated.

In some implementations, the logging program (e.g., applet) can interact with a user-facing camera of the client 402, such as a webcam on a tablet or desktop PC, or a camera on a smart phone (e.g., iPhone3, iPhone4, etc.) to track the eye movement of a user such that the usage data additionally or alternatively includes a user's eye movements. The camera in the client 402 can thus be adapted via the logging program to focus on one or both eyes and record their movement as the user 401 views the user interface. In some embodiments, the logging program can be adapted and configured to use contrast to locate the center of the pupil of the user 401. Two types of eye tracking techniques that can be used include bright pupil and dark pupil. For example, in the case of bright pupil, if illumination (e.g., from the screen of client 402) incident upon the eyes of the user 401 is coaxial with the optical path to the screen, then the eye of the user 401 can act as a retroreflector as the light reflects off the retina creating a bright pupil effect similar to red eye. User eye tracking can be used to supplement the tracking of the x-y coordinates of the cursor or screen touches of the user 401.

In some implementations, a user 401 can be a backer that selects to initiate a payment process or other action by way of the PAVE™ user interface, such as by interacting with an object in a user interface (e.g., an actuator in a prospect profile 200) to make a payment to a prospect.

Upon obtaining the user payment input 418, the user device may generate a card authorization request, e.g., 420. For example, the user device may provide a card authorization request, e.g., 421, on behalf of the user, a HTTP(S) GET message including the payment details for a pay network server, e.g., 406, in the form of XML-formatted data. Below is an example HTTP(S) GET message including an XML-formatted card authorization request for the pay network server:

GET /purchase.php HTTP/1.1
Host: www.Pave.com
Content-Type: Application/XML
Content-Length: 1306
<?XML version = “1.0” encoding = “UTF-8”?>
<payment_order>

<order_ID>4NFU4RG94</order_ID>
<alerts_URL>www.Pave.com/fundingcarts.php?sessionID=AEBB4356</alerts_URL>
<timestamp>2011-02-22 15:22:43</timestamp>
<backer_ID>john.q.public@gmail.com</backer_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<payment_details>

<num_payments>1</num_payments>
<payment>

<payment_type>milestone</payment_type>
<payment_params>

<payment_memo>MilestoneOne</payment_memo>

</product_params>

</product>

</payment_details>
<payee_params>

<payee_id>3FBCR4INC</payee_id>
<payee_name>Pave, Inc.</payee_name>
<payee_auth_key>1NNF484MCP59CHB27365</payee_auth_key>

</payee_params>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>
<confirm_type>email</confirm_type>
<contact_info>john.q.public@gmail.com</contact_info>

</account_params>

</payment_order>

In some implementations, the card authorization request generated by the user device 402 may include a minimum of information required to process the payment transaction. For example, this may improve the efficiency of communicating the payment transaction request, and may also advantageously improve the privacy protections provided to the user and/or payee. For example, in some implementations, the card authorization request may include at least a payee ID, a session ID for the user's payment session with the payee, and a device ID of a device (e.g., smartphone) of the user 401 that is linked to a user's account.

In some implementations, the user 401 may select to conduct the transaction using a one-time anonymized credit card number. For example, the PAVE™ interface may utilize a pre-designated anonymized set of card details. As another example, the PAVE™ platform may generate, e.g., in real-time, a one-time anonymous set of card details to securely complete the payment transaction. In such implementations, the PAVE™ platform may automatically set the user profile settings such that the any personal identifying information of the user will not be provided to other entities. In some implementations, the user may be required to enter a user name and password to enable the anonymization features.

With reference to FIG. 3B, in some implementations, the pay network server may process the transaction so as to transfer funds for the purchase into an account stored on an acquirer of the payee. For example, the acquirer may be a financial institution maintaining an account of the merchant. For example, the proceeds of transactions processed by the merchant may be deposited into an account maintained by at a server of the acquirer.

In some implementations, the pay network server may generate a query, e.g., 422, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 408a-n, of the issuer(s) may maintain details of the user's account. In some implementations, a database, e.g., pay network database 407, may store details of the issuer server(s) associated with the issuer(s). For example, the database may be a relational database responsive to Structured Query Language (“SQL”) commands. The pay network server may query the pay network database for issuer server(s) details. For example, the pay network server may execute a hypertext preprocessor (“PHP”) script including SQL commands to query the database for details of the issuer server(s). An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address
mac_address auth_key port_num
security_settings_list FROM IssuerTable WHERE account_num LIKE
′%′ $accountnum”;
$result = mysql_query($query); // perform the search query
mysql_close(“ISSUERS.SQL”); // close database access
?>

In response to obtaining the issuer server query, e.g., 422, the pay network database may provide, e.g., 423, the requested issuer server data to the pay network server. In some implementations, the pay network server may utilize the issuer server data to generate authorization request(s), e.g., 424, for each of the issuer server(s) selected based on the pre-defined payment settings associated with the user's virtual wallet, and/or the user's payment options input, and provide the card authorization request(s), e.g., 425a-n, to the issuer server(s), e.g., 408a-n. In some implementations, the authorization request(s) may include details such as, but not limited to: the costs to the user involved in the transaction, card account details of the user, user billing and/or shipping information, and/or the like. For example, the pay network server may provide a HTTP(S) POST message including an XML-formatted authorization request similar to the example listing provided below:

POST /authorization.php HTTP/1.1
Host: www.issuer.com
Content-Type: Application/XML
Content-Length: 624
<?XML version = “1.0” encoding = “UTF-8”?>
<card_query_request>

<query_ID>VNEI39FK</query_ID>
<timestamp>2011-02-22 15:22:44</timestamp>
<payment_summary>

<num_payments>1</num_payments>
<payment>

<payment_summary>MilestoneOne</payment_summary>

</payment>

</payment_summary>
<transaction_cost>$5000.00</transaction_cost>
<account_params>

<account_type>checking</account_type>
<account_num>1234567890123456</account_num>

</account_params>
<payee_params>

<payee_id>3FBCR4INC</payee_id>
<payee_name>Pave, Inc.</payee_name>
<payee_auth_key>1NNF484MCP59CHB27365</payee_auth_key>

</payee_params>

</card_query_request>

In some implementations, an issuer server may parse the authorization request(s), and based on the request details may query a database, e.g., user profile database 409a-n, for data associated with an account linked to the user. For example, the issuer server may issue PHP/SQL commands similar to the example provided below:

<?PHP
header(′Content-Type: text/plain′);
mysql_connect(“254.93.179.112”,$DBserver,$password); // access
database server
mysql_select_db(“USERS.SQL”); // select database table to search
//create query for user data
$query = “SELECT user_id user_name user_balance account_type
FROM UserTable WHERE account_num LIKE ′%′
$accountnum”;
$result = mysql_query($query); // perform the search query
mysql_close(“USERS.SQL”); // close database access
?>

In some implementations, on obtaining the user data, e.g., 427a-n, the issuer server may determine whether the user can pay for the transaction using funds available in the account, e.g., 428a-n. For example, the issuer server may determine whether the user has a sufficient balance remaining in the account, sufficient credit associated with the account, and/or the like. Based on the determination, the issuer server(s) may provide an authorization response, e.g., 429a-n, to the pay network server. For example, the issuer server(s) may provide a HTTP(S) POST message similar to the examples above. In some implementations, if at least one issuer server determines that the user cannot pay for the transaction using the funds available in the account, see e.g., 430-431, the pay network server may request payment options again from the user (e.g., by providing an authorization fail message 431 to the user device and requesting the user device to provide new payment options), and re-attempt authorization for the purchase transaction. In some implementations, if the number of failed authorization attempts exceeds a threshold, the pay network server may abort the authorization process, and provide an “authorization fail” message to the merchant server, user device and/or client.

With reference to FIG. 3C, in some implementations, the pay network server may obtain the authorization message including a notification of successful authorization, see e.g., 430, 433, and parse the message to extract authorization details. Upon determining that the user possesses sufficient funds for the transaction, the pay network server may generate a transaction data record, e.g., 432, from the authorization request and/or authorization response, and store the details of the transaction and authorization relating to the transaction in a transactions database.

For example, the pay network server may issue PHP/SQL commands similar to the example listing below to store the transaction data in a database:

<?PHP
header(′Content-Type: text/plain′);
mysql_connect(″254.92.185.103”,$DBserver,$password); // access
database server
mysql_select(″TRANSACTIONS.SQL″); // select database to append
mysql_query(“INSERT INTO PaymentTable (timestamp,
payment_summary_list, transaction_cost, account_params_list,
account_name, account_type, account_num, billing_addres, zipcode,
phone, sign, merchant_params_list, merchant_id, merchant_name,
merchant_auth_key)
VALUES (time( ),$transaction_cost, $account_params_list,
$account_name, $account_type, $account_num, $billing_addres,
$zipcode, $phone, $sign, $payee_params_list, $payee_id,
$payee_name, $payee_auth_key)”); // add data to table in database
mysql_close(″TRANSACTIONS.SQL″); // close connection to database
?>

In some implementations, the pay network server may forward an authorization success message, e.g., 433a-b, to the user device and/or payee server. The payee may obtain the authorization message, and determine from it that the user possesses sufficient funds in the card account to conduct the transaction. The payee server may add a record of the transaction for the user to a batch of transaction data relating to authorized transactions. For example, the payee may append the XML data pertaining to the user transaction to an XML data file comprising XML data for transactions that have been authorized for various users, e.g., 434, and store the XML data file, e.g., 435, in a database, e.g., Pave™ database 404. For example, a batch XML data file may be structured similar to the example XML data structure template provided below:

<?XML version = “1.0” encoding = “UTF-8”?>
<payee_data>

<payee_id>3FBCR4INC</payee_id>
<payee_name>Pave, Inc. </payee_name>
<payee_auth_key>1NNF484MCP59CHB27365</payee_auth_key>
<account_number>123456789</account_number>

</payee_data>
<transaction_data>

<transaction 1>

...

</transaction 1>
<transaction 2>

...

</transaction 2>

.
.
.

<transaction n>

...

/transaction n>

</transaction_data>

In some implementations, the server may also generate a purchase receipt, e.g., 434, and provide the purchase receipt to the client, e.g., 436. The client 402 may render and display, e.g., 437a, the purchase receipt for the user. In some implementations, the user device may also provide a notification of successful authorization to the user, e.g., 437b. For example, the client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 3D, in some implementations, the Pave™ server 403 may initiate clearance of a batch of authorized transactions. For example, the Pave™ server 403 may generate a batch data request, e.g., 438, and provide the request, e.g., 439, to a database, e.g., database 404. For example, the merchant server may utilize PHP/SQL commands similar to the examples provided above to query a relational database. In response to the batch data request, the database may provide the requested batch data, e.g., 440. The server may generate a batch clearance request, e.g., 441, using the batch data obtained from the database, and provide, e.g., 442, the batch clearance request to an acquirer server, e.g., 410. For example, the merchant server may provide a HTTP(S) POST message including XML-formatted batch data in the message body for the acquirer server. The acquirer server may generate, e.g., 443, a batch payment request using the obtained batch clearance request, and provide the batch payment request to the pay network server, e.g., 444. The pay network server may parse the batch payment request, and extract the transaction data for each transaction stored in the batch payment request, e.g., 445. The pay network server may store the transaction data, e.g., 446, for each transaction in a database, e.g., pay network database 407. For each extracted transaction, the pay network server may query, e.g., 447-448, a database, e.g., pay network database 407, for an address of an issuer server. For example, the pay network server may utilize PHP/SQL commands similar to the examples provided above. The pay network server may generate an individual payment request, e.g., 449, for each transaction for which it has extracted transaction data, and provide the individual payment request, e.g., 450, to the issuer server, e.g., 408. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$5000.00</pay_amount>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<payee_params>

<payee_id>3FBCR4INC</payee_id>
<payee_name>Pave, Inc.</payee_name>
<payee_auth_key>1NNF484MCP59CHB27365</payee_auth_key>

</payee_params>
<payment_summary>

<num_payments>1</num_payments>
<payment>

<payment_summary>Milestone1</payment_summary>

</payment>

</payment_summary>

</pay_request>

In some implementations, the issuer server may generate a payment command, e.g., 451. For example, the issuer server may issue a command to deduct funds from the user's account (or add a charge to the user's credit card account). The issuer server may issue a payment command, e.g., 452, to a database storing the user's account information, e.g., user profile database 409. The issuer server may provide a funds transfer message, e.g., 453, to the pay network server, which may forward, e.g., 454, the funds transfer message to the acquirer server. An example HTTP(S) POST funds transfer message is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some implementations, the acquirer server may parse the funds transfer message, and correlate the transaction (e.g., using the request_ID field in the example above) to the payee. The acquirer server may then transfer the funds specified in the funds transfer message to an account of the payee, e.g., 455.

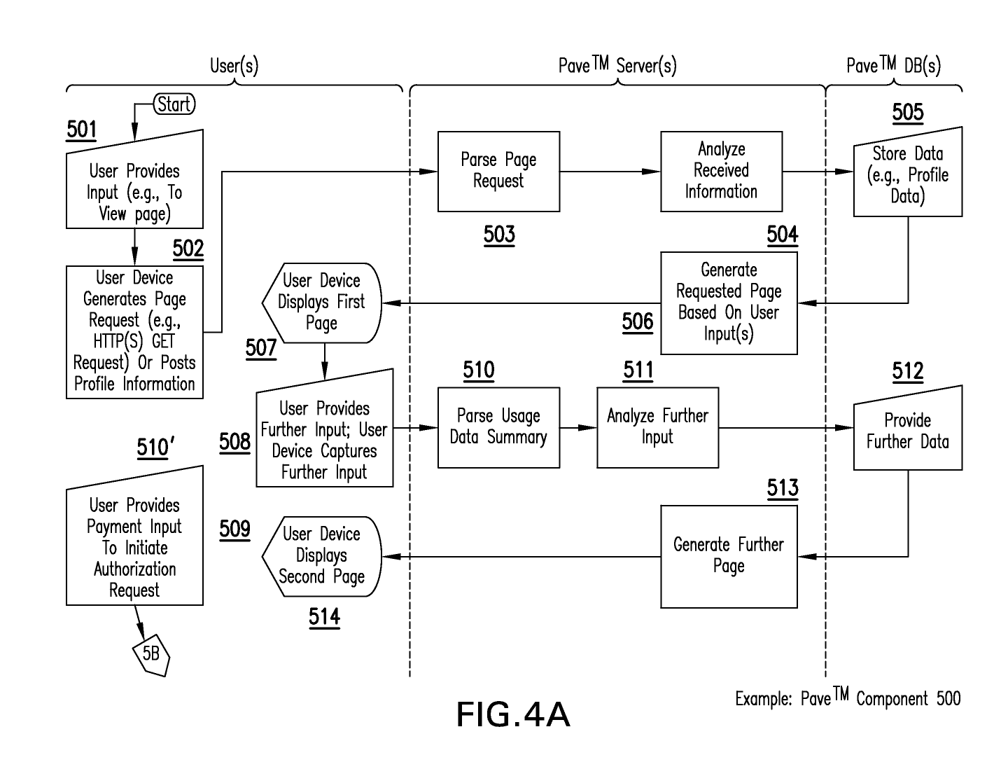

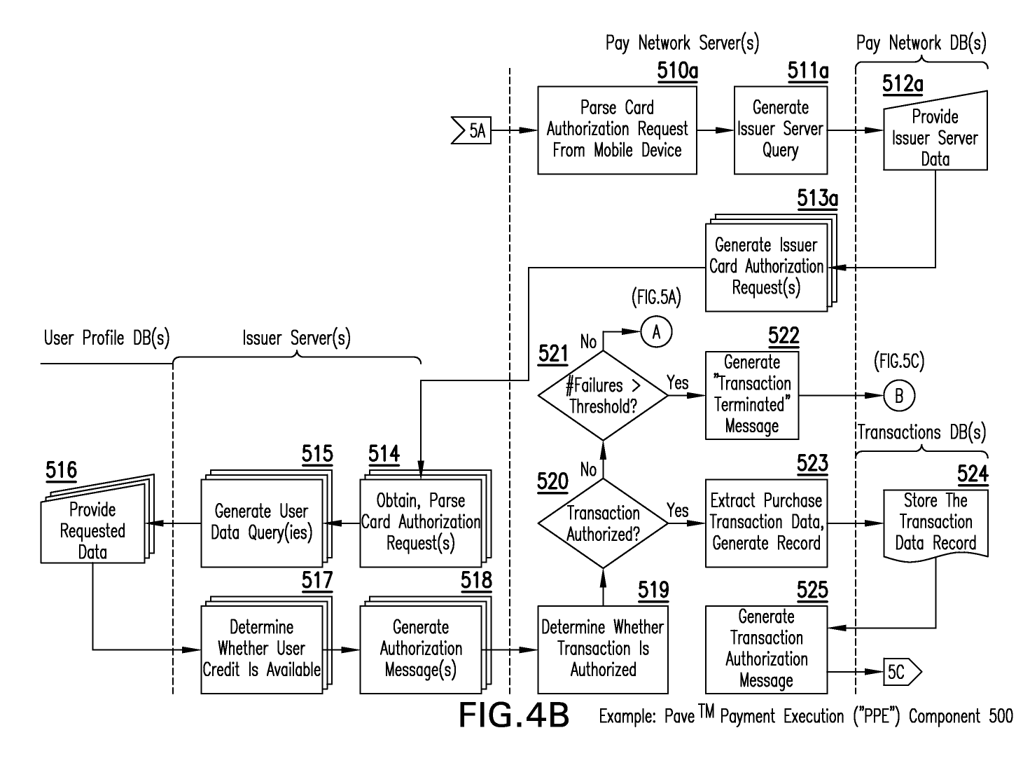

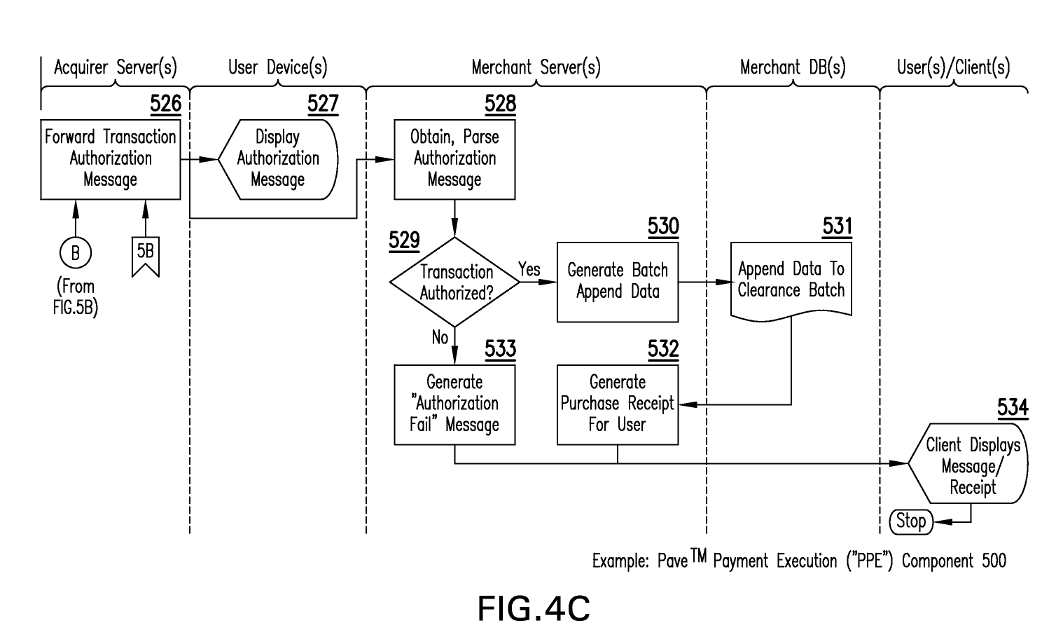

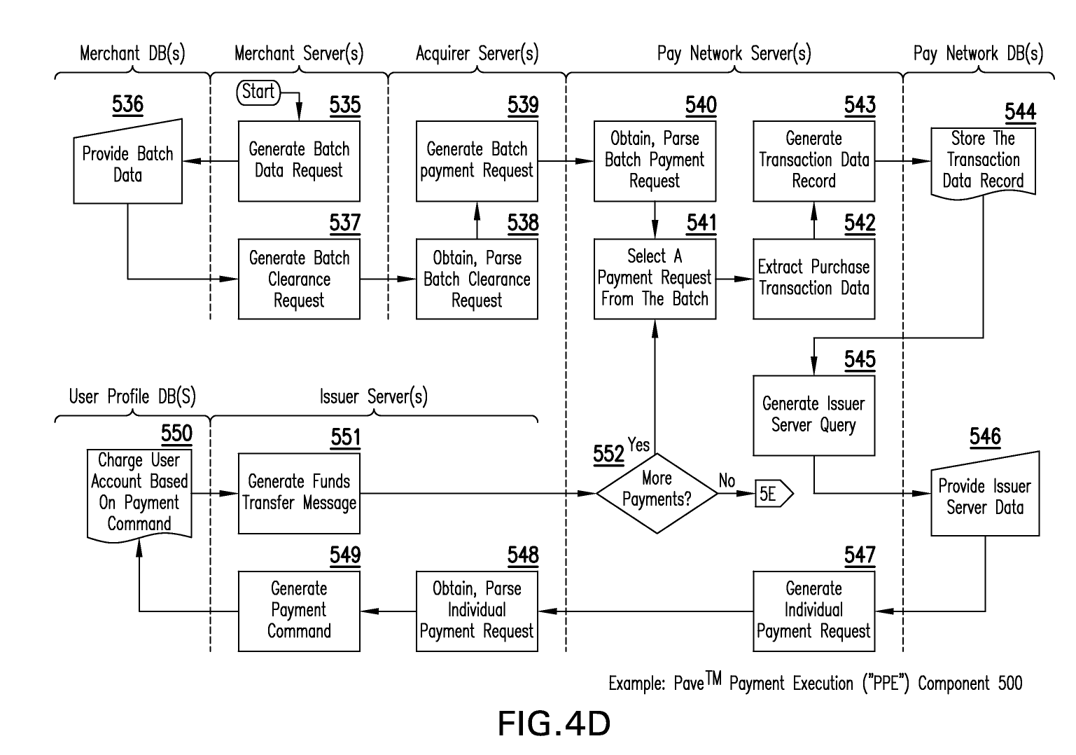

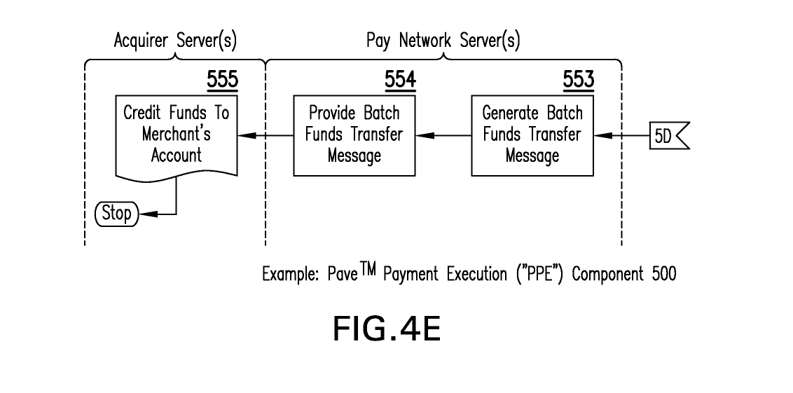

FIGS. 4A-E show logic flow diagrams illustrating example aspects of executing a PAVE™ user interface or social networking application in some embodiments of the PAVE™ component 600. For example, with reference to FIG. 4A, an exemplary PAVE™ Profile Data Collection (“JPDC”) Component 500a is illustrated, whereas FIGS. 4B-E illustrate aspects of an exemplary PAVE™ Payment Execution (“JPE”) component 500c.

In some implementations, a user (e.g., 401) may desire to view a page on a remote server (e.g., Pave™ server 403). The user may communicate with the behavior adapter server via a client (e.g., 402). For example, the user may provide user input, e.g., 501, into the client indicating the user's desire to request the page. The client (e.g. 402) may generate a page request, e.g., 502, and provide the page request to the behavior adapter server or to post information (e.g, prospect or backer profile information, prospect funding agreement information, or any other information as set forth herein). The server 403 may obtain the page request from the client, and parse and extract the page detail (e.g., XML data) from the request, e.g., 503. For example, the server (e.g., 403) may utilize a parser such as the example parsers described below in the discussion with reference to FIG. 5. The Pave™ server 403 may extract the page data, as well as the client data from the page request.

In response to obtaining the page request, GUI request or other data or information, the server 403 may generate, e.g., 506, the requested page to be sent to the user. For example, preparing the first page can includes defining the layout of the first page and populating it with the appropriate objects, data and/or other information as described herein. Any desired arrangement and content can be used.

In further accordance with FIG. 4A, once the first page is rendered, the server 403 may provide the page to the client device for display, e.g., 506. The client (e.g., 402) may then obtain and display the page on a display screen associated with the client device 507.

With further reference to FIG. 4A, the user 401 can then provide additional input 508 (e.g., via keyboard entry and/or mouse clicks in checkboxes or with respect to actuators or other objects) to be sent to the Pave™ server 403. For example, the user 401 may provide usage input into the user device or client, e.g., 508.

The Pave™ social networking platform server 403 then parses the usage data summary 511 and can then forward the usage data to the database 512. This usage data can then be stored in a database at 513.

With reference to FIG. 4B, in some implementations, the user may provide payment input that causes the client (e.g., 402) to make a card authorization request 510 in the event the user wishes to initiate a payment transaction by way of the PAVE™ user interface, for example, to the administrator of the social networking platform or to a prospect, for example. The pay network server may parse the card authorization request, e.g., 510a, and generate a query, e.g., 511a, for issuer server(s) corresponding to the user-selected payment options. In some implementations, a pay network database may store details of the issuer server(s) associated with the issuer(s). In response to obtaining the issuer server query, the pay network database may provide, e.g., 512a, the requested issuer server data to the pay network server. In some implementations, the pay network server may utilize the issuer server data to generate authorization request(s), for each of the issuer server(s), and provide the card authorization request(s) to the issuer server(s).

In some implementations, an issuer server may parse the authorization request(s), and based on the request details may query a user profile database for data associated with an account linked to the user. In some implementations, on obtaining the user data, the issuer server may determine whether the user can pay for the transaction using funds available in the account, e.g., 517. For example, the issuer server may determine whether the user has a sufficient balance remaining in the account, sufficient credit associated with the account, and/or the like. Based on the determination, the issuer server(s) may provide an authorization response, e.g., 518, to the pay network server. In some implementations, if at least one issuer server determines, e.g., 519, that the user cannot pay for the transaction using the funds available in the account, see e.g., 520, option “No,” the pay network server may request payment options again from the user (see e.g., 521, option “No,” by providing an authorization fail message to the user device and requesting the user device to provide new payment options), and re-attempt authorization for the purchase transaction. In some implementations, if the number of failed authorization attempts exceeds a threshold, see, e.g., 521, option “Yes,” the pay network server may abort the authorization process, and provide an “authorization fail” message to the merchant server, user device and/or client, e.g., 522.

In some implementations, the pay network server may obtain the authorization message including a notification of successful authorization, see e.g., 520, option “Yes,”, and parse the message to extract authorization details. Upon determining that the user possesses sufficient funds for the transaction, the pay network server may generate a transaction data record, e.g., 523, from the authorization request and/or authorization response, and store, e.g., 524, the details of the transaction and authorization relating to the transaction in a transactions database.

With reference to FIG. 4C, in some implementations, the pay network server may forward an authorization success message, e.g., 525, to the user device and/or payee server, sometimes via the acquirer server, e.g. 526. The payee may parse the authorization message, e.g., 528, and determine from it that the user possesses sufficient funds in the card account to conduct the transaction, see, e.g., 529. The payee server may add a record of the transaction for the user to a batch of transaction data relating to authorized transactions, see, e.g., 530-531. In some implementations, the payee server may also generate a purchase receipt, e.g., 532, and provide the purchase receipt to the client. The client may render and display, e.g., 534, the purchase receipt for the user. In some implementations, the user device 405 may also provide a notification of successful authorization to the user.

With reference to FIGS. 4D-E, in some implementations, the payee (e.g., Pave™) server may initiate clearance of a batch of authorized transactions. For example, the payee server may generate a batch data request, e.g., 535, and provide the request, e.g., 536, to a database, e.g., payee database. In response to the batch data request, the database may provide the requested batch data, e.g., 536. The server may generate a batch clearance request, e.g., 537, using the batch data obtained from the database, and provide the batch clearance request to an acquirer server. The acquirer server may generate, e.g., 539, a batch payment request using the obtained batch clearance request, and provide the batch payment request to the pay network server. The pay network server may parse the batch payment request, and extract the transaction data for each transaction stored in the batch payment request, e.g., 540-542. The pay network server may store the transaction data, e.g., 543-544, for each transaction in a database, e.g., pay network database. For each extracted transaction, the pay network server may query, e.g., 545-546, a database, e.g., pay network database, for an address of an issuer server. The pay network server may generate an individual payment request, e.g., 547, for each transaction for which it has extracted transaction data, and provide the individual payment request to the associated issuer server.

In some implementations, the issuer server may generate a payment command, e.g., 548-549. For example, the issuer server may issue a command to deduct funds from the user's account (or add a charge to the user's credit card account). The issuer server may issue a payment command, e.g., 549, to a database storing the user's account information, e.g., user profile database. The issuer server may provide a funds transfer message, e.g., 551, to the pay network server, which may forward the funds transfer message to the acquirer server. In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 553-555.

### Pave™ Controller

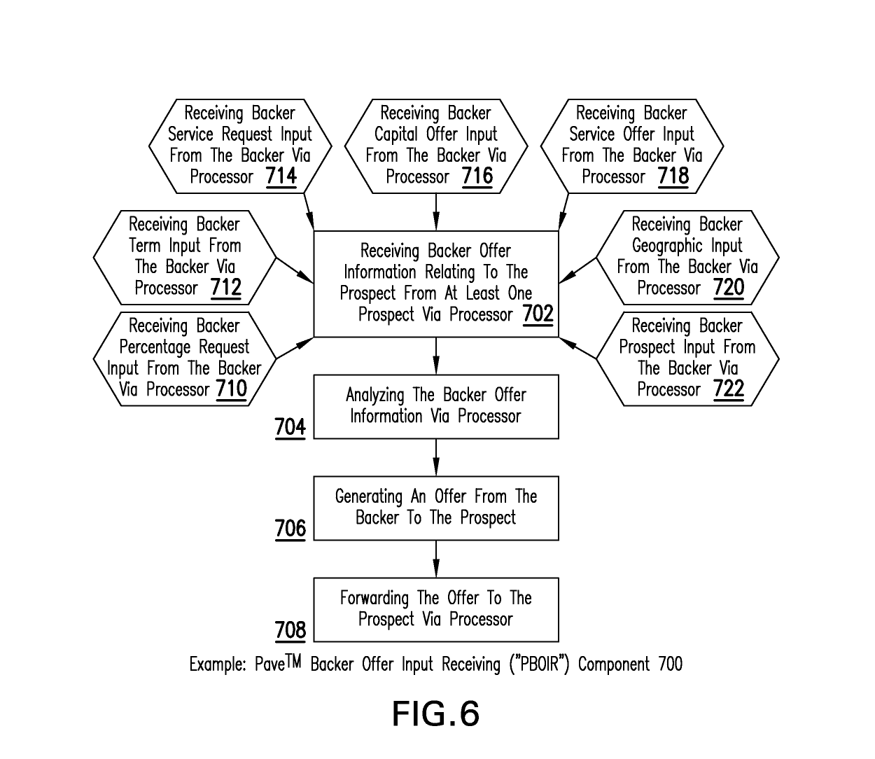

FIG. 6 illustrates inventive aspects of a PAVE™ controller 601 in a block diagram. In this embodiment, the PAVE™ controller 601 may serve to aggregate, process, store, search, serve, identify, instruct, generate, match, and/or facilitate interactions with a computer through various technologies, and/or other related data.

Typically, a user or users, e.g., 633a, which may be people or groups of users as described herein and/or other systems, may engage information technology systems (e.g., computers) to facilitate information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PAVE™ controller 601 may be connected to and/or communicate with entities such as, but not limited to: one or more users from user input devices 611; peripheral devices 612; an optional cryptographic processor device 628; and/or a communications network 613. For example, the PAVE™ controller 601 may be connected to and/or communicate with users, e.g., 633a, operating client device(s), e.g., 633b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PAVE™ controller 601 may be based on computer systems that may comprise, but are not limited to, components such as: a computer systemization 602 connected to memory 629.

### Computer Systemization

A computer systemization 602 may comprise a clock 630, central processing unit (“CPU(s)” and/or “processor(s)” (these terms are used interchangeable throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effect communications, operations, storage, etc. Optionally, the computer systemization may be connected to an internal power source 686; e.g., optionally the power source may be internal. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing PAVE™ controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PAVE™ controller and beyond through various interfaces. Should processing requirements dictate a greater amount speed and/or capacity, distributed processors (e.g., Distributed PAVE™ embodiments), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the PAVE™ implementations may be achieved by implementing a microcontroller such as CAST's R8051XC2 microcontroller; Intel's MCS 51 (i.e., 8051 microcontroller); and/or the like. Also, to implement certain features of the PAVE™ embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PAVE™ component collection (distributed or otherwise) and/or features may be implemented via the microprocessor and/or via embedded components; e.g., via ASIC, coprocessor, DSP, FPGA, and/or the like. Alternately, some implementations of the PAVE™ may be implemented with embedded components that are configured and used to achieve a variety of features or signal processing.

Depending on the particular implementation, the embedded components may include software solutions, hardware solutions, and/or some combination of both hardware/software solutions. For example, PAVE™ features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PAVE™ features. A hierarchy of programmable interconnects allow logic blocks to be interconnected as needed by the PAVE™ system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the PAVE™ may be developed on regular FPGAs and then migrated into a fixed version that more resembles ASIC implementations. Alternate or coordinating implementations may migrate PAVE™ controller features to a final ASIC instead of or in addition to FPGAs. Depending on the implementation all of the aforementioned embedded components and microprocessors may be considered the “CPU” and/or “processor” for the PAVE™.

### Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the PAVE™ thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

### Interface Adapters

Interface bus(ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the PAVE™ controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed PAVE™), architectures may similarly be employed to pool, load balance, and/or otherwise increase the communicative bandwidth required by the PAVE™ controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks. Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 611 often are a type of peripheral device 612 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 612 may be connected and/or communicate to I/O and/or other facilities of the like such as network interfaces, storage interfaces, directly to the interface bus, system bus, the CPU, and/or the like. Peripheral devices may be external, internal and/or part of the PAVE™ controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 628), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the PAVE™ controller may be embodied as an embedded, dedicated, and/or monitor-less (i.e., headless) device, wherein access would be provided over a network interface connection.

Cryptographic units such as, but not limited to, microcontrollers, processors 626, interfaces 627, and/or devices 628 may be attached, and/or communicate with the PAVE™ controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the PAVE™ controller and/or a computer systemization may employ various forms of memory 629. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server); the PAVE™ component(s) 635; the JPE component 641, the JPDC component 643; and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

### Operating System

The operating system component 615 is an executable program component facilitating the operation of the PAVE™ controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the PAVE™ controller to communicate with other entities through a communications network 613. Various communication protocols may be used by the PAVE™ controller as a subcarrier transport mechanism for interaction, such as, but not limited to: multicast, TCP/IP, UDP, unicast, and/or the like.

### Information Server

An information server component 616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PAVE™ controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PAVE™ database 619, operating systems, other program components, user interfaces, Web browsers, and/or the like.

Access to the PAVE™ database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PAVE™. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PAVE™ as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the PAVE™ enabled nodes. The combined application may be nugatory on systems employing standard Web browsers.

### Mail Server

A mail server component 621 is a stored program component that is executed by a CPU 603. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the PAVE™.

Access to the PAVE™ mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 622 is a stored program component that is executed by a CPU 603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the PAVE™ may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the PAVE™ component to engage in secure transactions if so desired. The cryptographic component facilitates the secure accessing of resources on the PAVE™ and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Pave™ Database

The PAVE™ database component 619 (which may contain, for example, consumer transaction history database 404) may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the PAVE™ database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the PAVE™ database is implemented as a data-structure, the use of the PAVE™ database 619 may be integrated into another component such as the PAVE™ component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-j. A Users (e.g., backers and prospects) table 619a may include fields such as, but not limited to: user_id, ssn, dob, first_name, last_name, age, state, address_firstline, address_secondline, zipcode, devices_list, contact_info, contact_type, alt_contact_info, alt_contact_type, education_information, grade_point, and/or the like to refer to any type of enterable data or selections discussed herein. The Users table may support and/or track multiple entity accounts on a PAVE™ social networking platform. A Clients table 619b may include fields such as, but not limited to: user_id, client_id, client_ip, client_type, client_model, operating_system, os_version, app_installed_flag, and/or the like. An Apps table 619c may include fields such as, but not limited to: app_ID, app_name, app_type, OS_compatibilities_list, version, timestamp, developer_ID, and/or the like. A Merchants table for merchants associated with the social networking platform 619d may include fields such as, but not limited to: merchant_id, merchant_name, provi merchant_address, ip_address, mac_address, auth_key, port_num, security_settings_list, and/or the like. An Issuers table 619e may include fields such as, but not limited to: issuer_id, issuer_name, issuer_address, ip_address, mac_address, auth_key, port_num, security_settings_list, and/or the like. An Acquirers table 619f may include fields such as, but not limited to: account_firstname, account_lastname, account_type, account_num, account_balance_list, billingaddress_line1, billingaddress_line2, billing_zipcode, billing_state, shipping_preferences, shipping_address_line1, shipping_address_line2, shipping_zipcode, shipping_state, and/or the like. An Accounts table 619g may include fields such as, but not limited to: user_id, account_num, account_name, issuer_acquirer_flag, institution_name, and/or the like. A Transactions table 619h may include fields such as, but not limited to: order_id, user_id, timestamp, transaction_cost, payment_details_list, backer_id, administrator_id, prospect_id, milestone_number, client_id, client_ip, client_type, client_model, operating_system, os_version, app_installed_flag, user_id, account_firstname, account_lastname, account_type, account_num, and/or the like. A Batches table 619i may include fields such as, but not limited to: batch_id, transaction_id_list, timestamp_list, cleared_flag_list, clearance_trigger_settings, and/or the like. A Payment Legers table 619j may include fields such as, but not limited to: request_id, timestamp, payment_amount, batch_id, transaction_id, clear_flag, deposit_account, transaction_summary, backer_name, backer_account, and/or the like. A Prospect Profile Data table 619k may also be provided and include fields such as, but not limited to: prospect_id, timestamp, field_endeavor, prospect_age, birth_date, pro spect_ssn, annual_income, graphic_coordinates, funding_percentage, capital_sought, service_description, prospect_rating, educational_background, repayment_period, offered_services, connection_id, and/or the like. A Backer Profile Data table 619l may also be provided and include fields such as, but not limited to: backer_id, timestamp, field_endeavor, backer_age, birth_date, backer_ssn, annual_income, graphic_coordinates, funding_percentage, capital_sought, service_description, backer_rating, educational_background, repayment_period, offered_services, connection_id, and/or the like. A Backer/Prospect Rating table 619m may also be provided and include fields such as, but not limited to: rater_id, rater_rating, applied_criteria, timestamp, average_rating and/or the like.

In one embodiment, the PAVE™ database 404 may interact with other database systems. For example, employing a distributed database system, queries and data access by search PAVE™ component may treat the combination of the PAVE™ database, an integrated data security layer database as a single database entity.

In one embodiment, user programs may contain various user interface primitives, which may serve to update the PAVE™ platform. Also, various accounts may require custom database tables depending upon the environments and the types of clients the PAVE™ system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-j. The PAVE™ system may be configured to keep track of various settings, inputs, and parameters via database controllers.

The PAVE™ database may communicate to and/or with other components in a component collection, including itself, and/or facilities of the like. Most frequently, the PAVE™ database communicates with the PAVE™ component, other program components, and/or the like. The database may contain, retain, and provide information regarding other nodes and data.

### The Pave™ Components

The PAVE™ component 635 is a stored program component that is executed by a CPU. In one embodiment, the PAVE™ component incorporates any and/or all combinations of the aspects of the PAVE™ systems discussed in the previous figures. As such, the PAVE™ component affects accessing, obtaining and the provision of information, services, transactions, and/or the like across various communications networks.

The PAVE™ component may transform the views of prospect and backer profiles and the interconnected networks that they develop over time. In one embodiment, the PAVE™ component 635 takes inputs (e.g., prospect and/or backer data input relating to various criteria, goals and agreement terms) etc., and transforms the inputs via various components (e.g., JPE Component 641, JPDC Component 643), into outputs (e.g., requested page response 413, updated page response 417, card authorization request 421, authorization fail message 431, authorization response 429a-n, transaction data 432, authorization success message 433a-b, batch append data 435, purchase receipt 436, funds transfer message 453-454, and/or the like).

The PAVE™ component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PAVE™ server employs a cryptographic server to encrypt and decrypt communications. The PAVE™ component may communicate to and/or with other components in a component collection, including itself, and/or facilities of the like. Most frequently, the PAVE™ component communicates with the PAVE™ database, operating systems, other program components, and/or the like. The PAVE™ may contain, communicate, generate, obtain, and/or provide program component, system, user, and/or data communications, requests, and/or responses.

### Distributed Pave™ Embodiments

The structure and/or operation of any of the PAVE™ node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PAVE™ controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1
   where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PAVE™ controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm.IBMDI.doc/referenceguide295.htm

and other parser implementations:
http://publib.boulder.ibm.com/infocenter/tivihelp/v2r1/index.jsp?topic=/com.ibm.IBMDI.doc/referenceguide259.htm
   all of which are hereby expressly incorporated by reference.

FIG. 6 illustrates an example of an implementation of a Pave™ backer offer input data (“PBOID”) logical component 710 when a backer joins the online social media platform and is matched with a potential prospect. The process begins with the system receiving backer offer information relating to the prospect from at least one backer via processor 702, analyzing the backer offer information via processor 704, generating an offer from the backer to the prospect 706 and forwarding the offer to the prospect via processor 708.

A backer may input certain factors that are factored into the backer offer information. As illustrated, the system receives backer percentage request input from the backer via processor 710. The backer percentage request input indicates an amount of future prospect earnings the backer wishes to receive in exchange for value, such as 1-10% in increments of 0.1%. The system can also receive backer term input from the backer via processor at 712. The backer term input can indicate, for example, a time period over which the backer wishes to receive future prospect earnings, such as one to ten years in one year increments. The system can also receive backer service request input from the backer via processor at 714. The backer service request input can indicate, for example, at least one prospect service the backer wishes to receive in exchange for value. The system can also receive backer capital offer input from the backer via processor at 716. The backer capital offer input can indicate an amount of capital the backer is willing to exchange for (i) future prospect earnings or (ii) at least one prospect service. The system can also receive backer service offer input from the backer via processor at 718. The backer service offer input can indicate at least one service the backer is willing to exchange for (i) future prospect earnings or (ii) at least one prospect service, for example. As further illustrated, the system can further receive backer geographic input from the backer via processor at 720. The backer geographic input can indicate, for example, a geographic region of interest of the backer. The system can still further receive backer prospect input from the backer via processor at 722. The backer prospect input can indicate, for example, at least one attribute that the backer seeks in a prospective prospect.

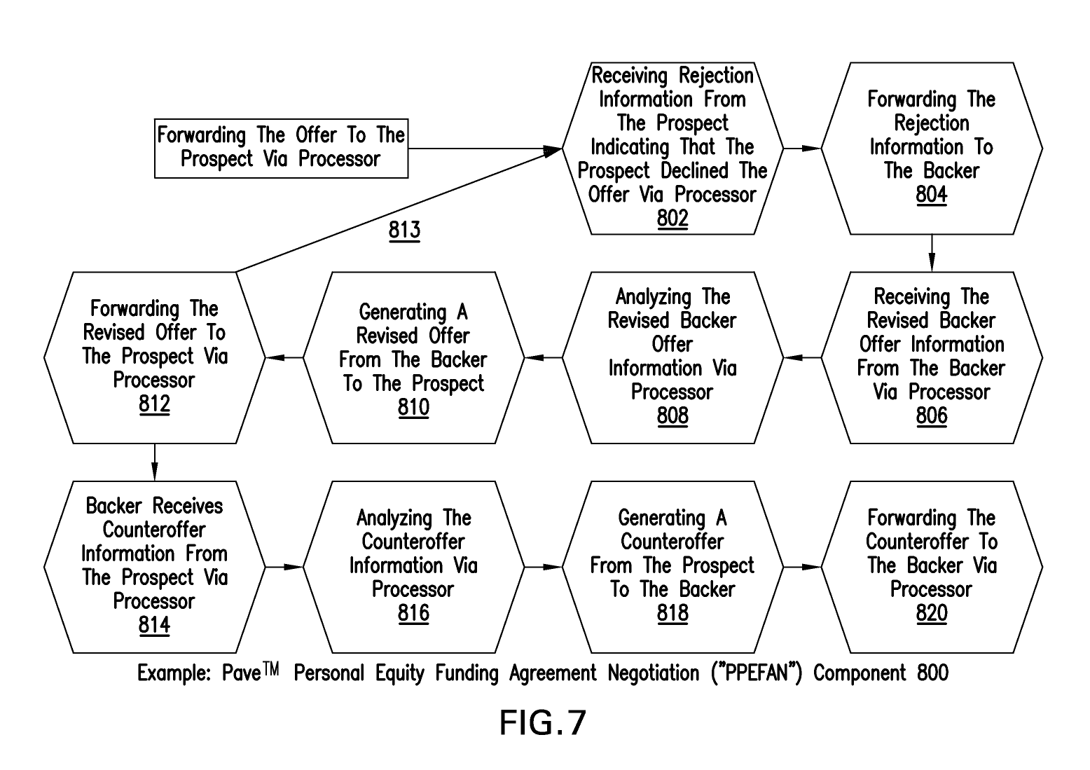

When the prospect receives an offer for funding from the backer, the prospect may either accept the offer or reject the offer. FIG. 7 illustrates an example of a process by which a prospect may provide a rejection to the backer through the online social media platform. The process includes, for example, receiving rejection information from the prospect indicating that the prospect declined the offer via processor at 802, and forwarding the rejection information to the backer at 804. When the rejection is forwarded to the backer, the backer may provide the prospect with a revised offer if the backer so desires. The process for revising the backer offer includes receiving revised backer offer information from the backer via processor at 806, analyzing the revised backer offer information via processor at 808, generating a revised offer from the backer to the prospect at 810, and forwarding the revised offer to the prospect via processor at 812.

Once the prospect receives the revised backer offer information the prospect may either accept the backers offer or offer a counteroffer. The terms of the agreement are very important to both parties and both the prospect and the backer should have a sense of contributing to the terms and conditions of the relationship that will guide the interactions between the prospect and the backer. An example of a process by which the prospect's counteroffer is created and forwarded to the backer occurs on the online social media platform and is also described in FIG. 7. The process begins with the backer receiving counteroffer information from the prospect via processor at 814. The counteroffer information will preferably indicate terms acceptable to the prospect. Alternatively, the prospect may further reject the agreement outright at 813, which would cause the negotiation cycle to repeat itself if the backer were amenable to doing so. Next, the counteroffer information is analyzed via processor at 816. The system then generates a counteroffer from the prospect to the backer at 818. The counteroffer is forwarded to the backer via processor at 820.

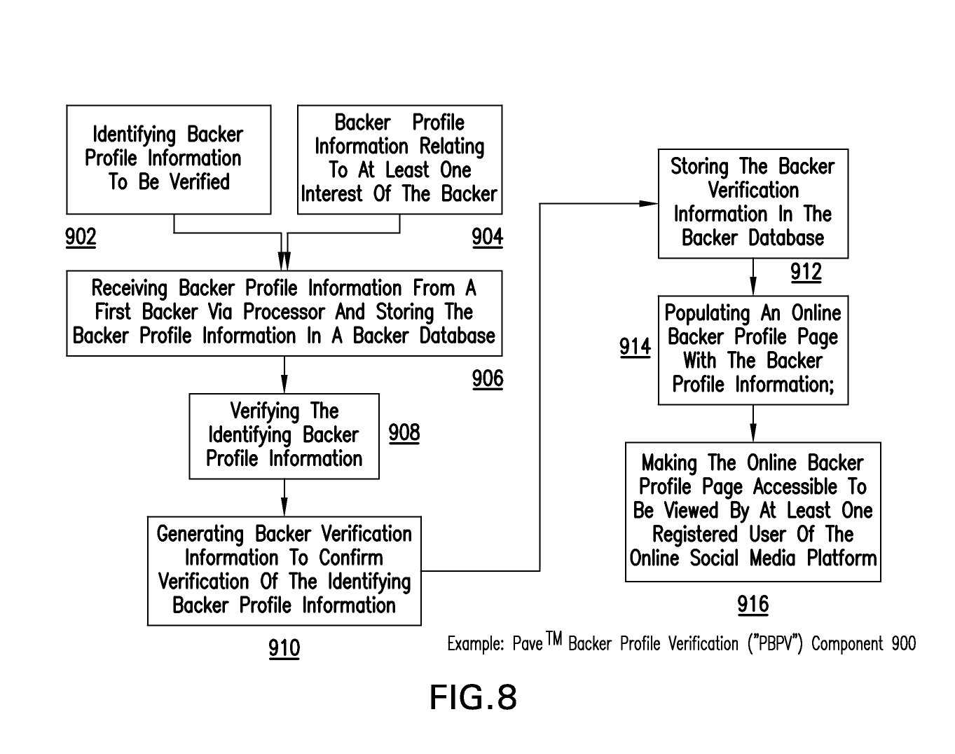

The online social media platform system can rely heavily on the truth and veracity of prospects and backers. In most implementations, the majority of the information on the backers and prospects profile pages should be verified by the online social media platform. For purposes of illustration, in FIG. 8, the method includes receiving backer profile information from a first backer via processor and storing the backer profile information in a backer database at 906. As illustrated, the backer profile information includes identifying backer profile information to be verified at 902, and backer profile information relating to at least one interest of the backer at 904. The method further can includes verifying the identifying backer profile information at 908, generating backer verification information to confirm verification of the identifying backer profile information at 910, storing the backer verification information in the backer database at 912, populating an online backer profile page with the backer profile information at 914, and making the online backer profile page accessible to be viewed by at least one registered user of the online social media platform at 916.

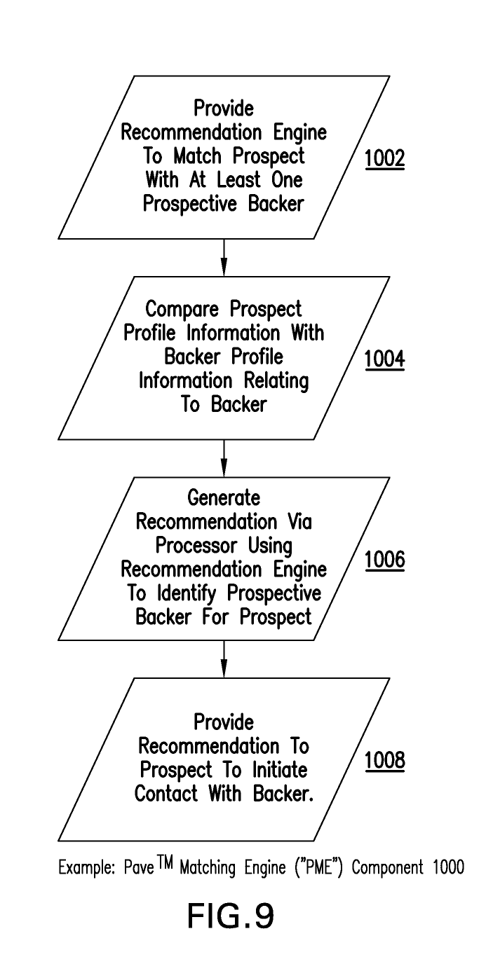

In various implementations, the Pave™ system is able to provide a recommendation to prospects on an appropriate backer and a matching backer to an appropriate prospect. One implementation illustrating some aspects of the recommendation engine is illustrated in FIG. 9. The method can include providing a recommendation engine for matching the prospect with at least one prospective backer at 1002, and comparing the prospect profile information with the backer profile information relating to the at least one prospective backer at 1004. Next, a recommendation is generated via processor using the recommendation engine to identify the at least one prospective backer for the prospect at 1006. Finally, the recommendation can be provided to the prospect to initiate contact with the at least one prospective backer at 1008.

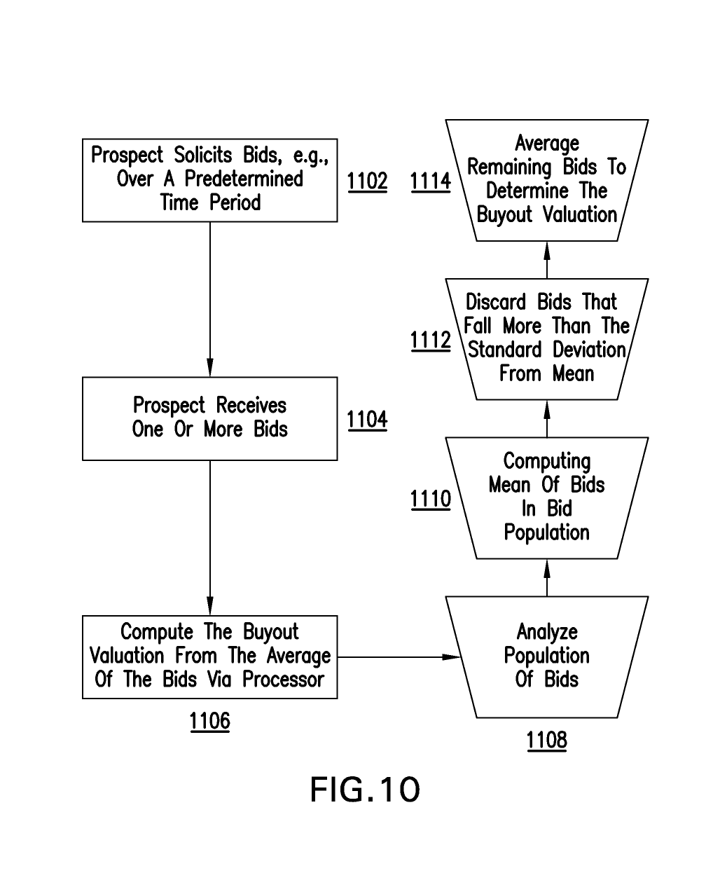

Ordinarily, it is contemplated that a prospect and backer will see the agreement through to the end of its term. However, in some instances, it is envisioned that the prospect and/or the backer will wish to terminate the agreement prior to the end of the agreement. If both parties wish to terminate the agreement and are able to agree as to how to terminate the agreement, they may do so. However, the funding agreement may similarly be worded in a manner that permits the prospect or the backer to initiate a valuation process of the prospect's future income. For example, if a prospect has decided to either determine the value of the agreement or buy out of the agreement that the prospect has entered into with the backer, the prospect may commence a bidding process to determine the value of the agreement. An illustration of one implementation of such a method is illustrated in FIG. 10. The process can begin, for example, with the prospect soliciting bids over a predetermined time period at 1102. The prospect can receive one or more bids at 1104, and the prospect can select an option to compute the buyout valuation from an average of the bids via a processor at 1106. This can be implemented, for example, by analyzing a population of bids at 1108, computing a mean of the bids in the population at 1110, discarding bids that fall more than the standard deviation from the mean at 1112; and averaging the remaining bids to determine the buyout valuation at 1114.

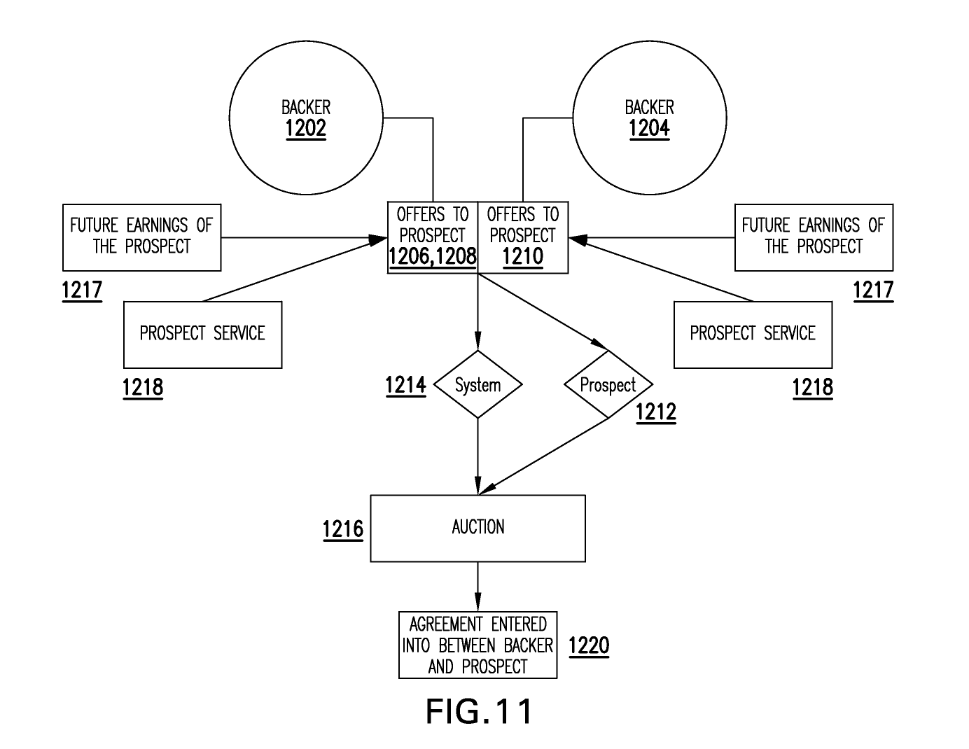

In the event a prospect receives offers from more than one backer, the online social media platform or the prospect may initiate an auction to determine which backer shall be the one to fund the prospect. In FIG. 11, one implementation of a process by which more than one backer at 1202, 1204 submit multiple offers at 1206, 1208, 1210 to fund a single prospect at 1212 is illustrated. In such scenarios, the multiple offers 1206, 1208, 1210 can be received by the online social media platform at 1214 and an auction 1216 can be initiated by the online social media platform 1214. In another embodiment, the offers can be sent to the prospect 1212 who then initiates the auction 1214. The auction 1214 can be for the future earnings 1217 of the prospect and at least one service 1218 the prospect can offer the backers. The winner of the auction will be the backer with which the prospect enters into an agreement at 1220.

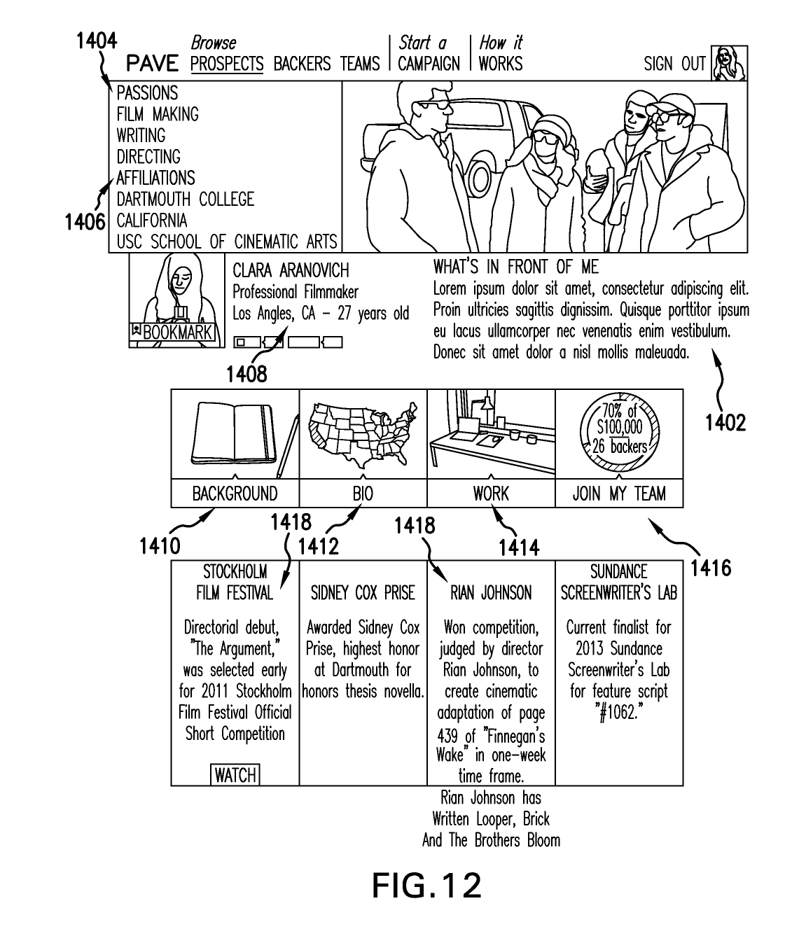

In FIG. 12, a preferred embodiment of a prospect's profile page on the Pave™ online social media platform is shown. In order to be attractive to prospective backers, prospects should provide sufficient, relevant information for review by backers in their own words 1402. In addition, the prospect's passions 1404 and affiliations 1406 can also be listed. The prospects passions 1404 can be set forth in a summary describing, for example, who the prospect is and what they most identify with. For instance, a filmmaker's passions as illustrated are stated to be writing, directing and film making. The affiliations 1406 of the prospect can include, for example, universities and schools the prospect has attended, is attending or plans to attend. The prospect's name, occupation, city and state or residence, photo and age 1408 can also be shown. The prospect's profile page can be interactive and is preferably easily accessible and searchable by backers. Headings 1410, 1412, 1414 can contain further information about the prospect, such as the prospect's background, bio, and work 1414. A backer who is interested in funding a prospect can view how much funding a prospect is requesting, how many backers a prospect has and what percentage of their funding goal has been achieved. Backers can also view what types of awards or special recognitions 1418 a prospect has earned.

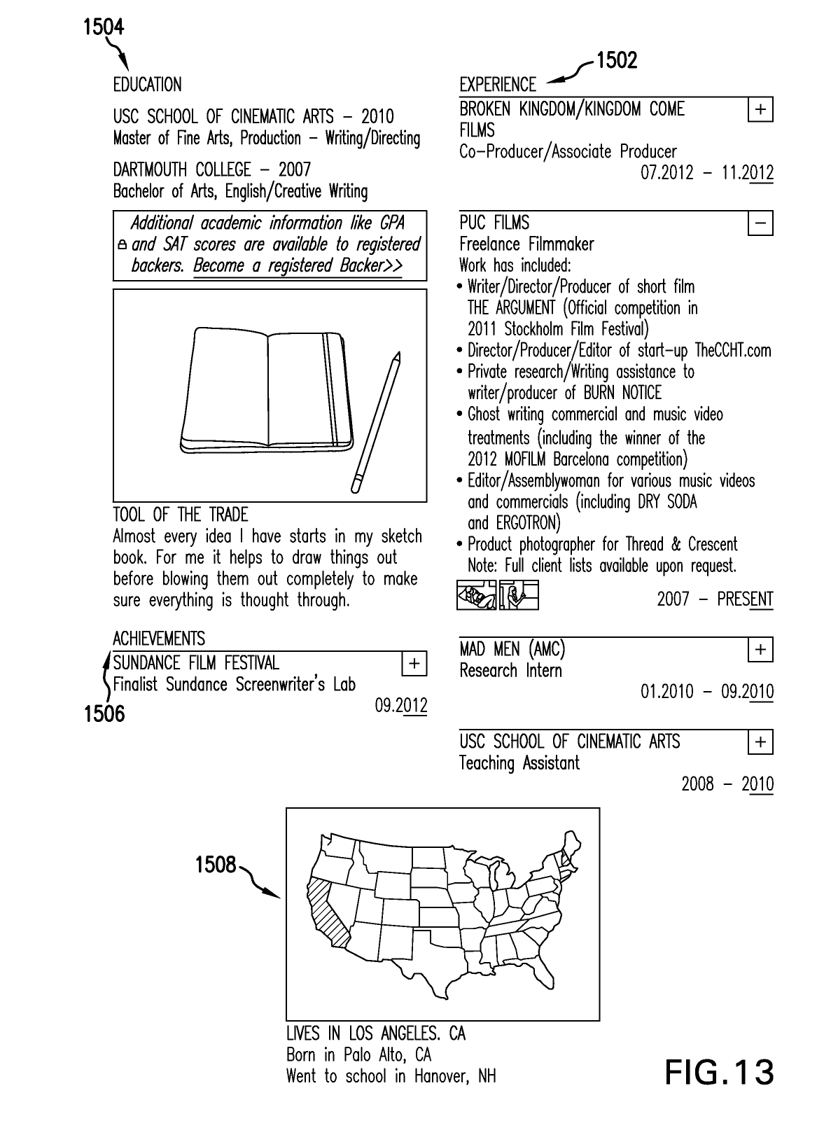

In another representative view of a prospect profile page as shown in FIG. 13, the details of the prospect's educational background 1504 can be viewed as well as the prospect's work experience 1502 showing positions held and dates of employment. In addition, other notable achievements 1506 the prospect has accomplished can also be viewed. The online social media platform can also be interactive. Thus, portions relating to the regions of the world 1508 where the prospect resides and works may be highlighted.

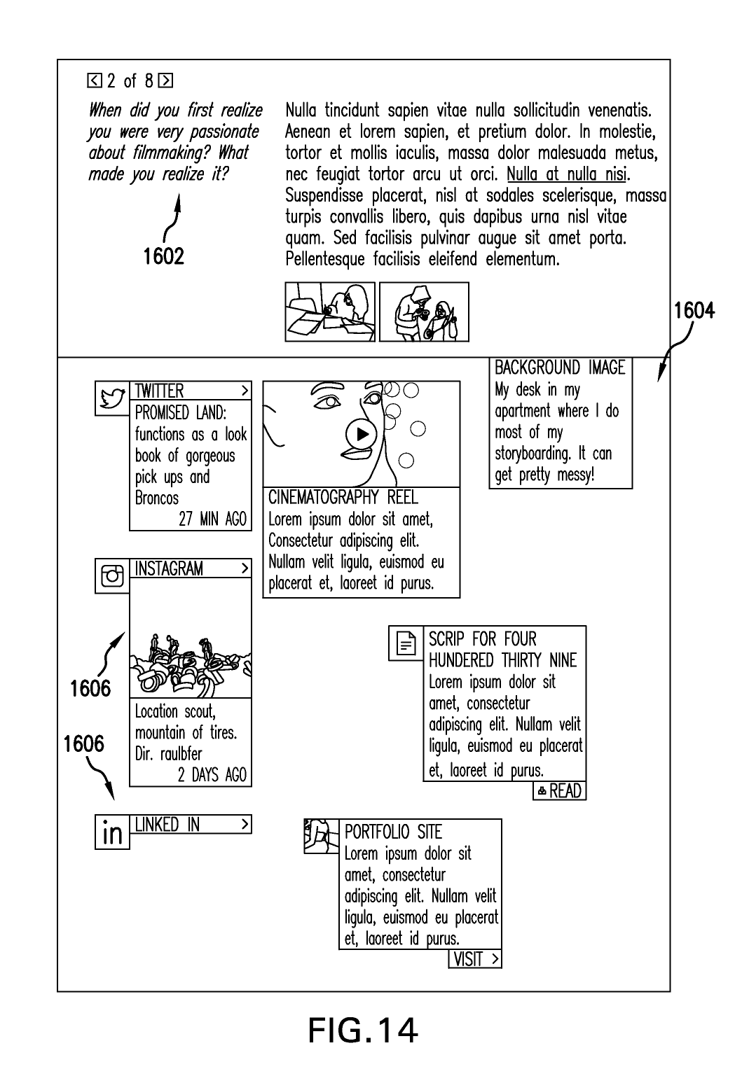

In another view of the prospect profile page illustrated in FIG. 14, the prospect is able to provide in depth answers to thought provoking questions 1602, posed by the online social media platform and relating to the prospect's passions. Answers to such questions can provide insight into a prospect that can be helpful to a backer. An interactive pin board 1604 is also provided where links to the prospect's social media accounts 1606 are provided, such as LinkedIn, Twitter, and Instagram. Depending on the prospect, other types of information and links can be added to the pin board 1604.

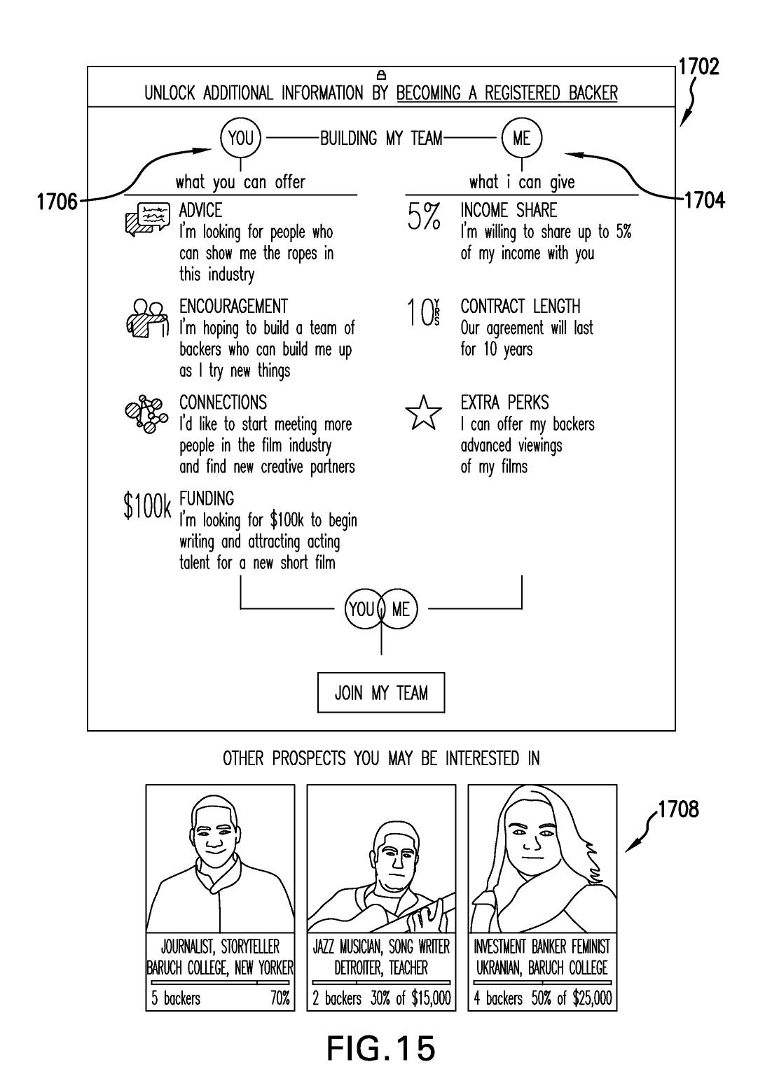

In FIG. 15, a view of a further portion of the prospect's page is provided. This portion of the prospect's page includes a solicitation for a backer, and specifies what the prospect is seeking in a backer, as well as what the prospect is offering. Depending on the interests of the backer viewing the page, the online social media platform may offer recommendations as to other prospects 1708 the backer may be interested in.

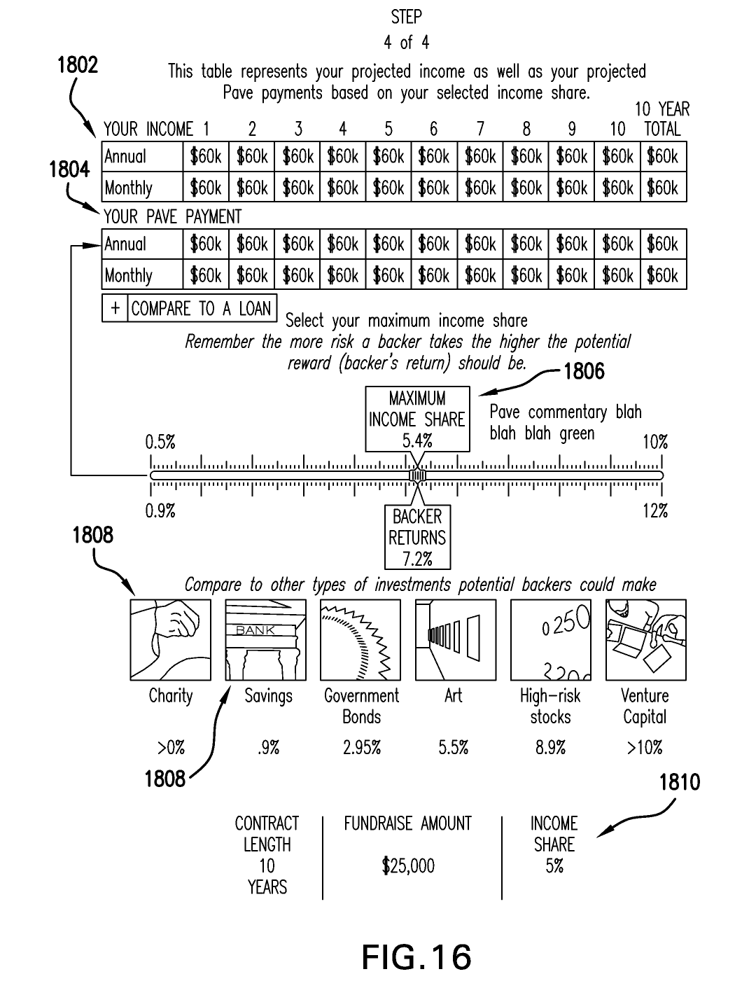

In FIG. 16, an interactive table is provided that can illustrate the payments that a prospect is required to make to the backer, e.g., via the online social media platform (“Pave Payment 1804”) as a percentage of income. While the numbers in the particular illustration do not illustrate a particular income and payment scenario (as all the fields are configured to recite “60K” in the figure), when appropriately configured, the tables compute and display income projections as well as corresponding payments to be made under the personal equity funding agreement. Thus, the prospect is able to view what their annual or monthly income would be in relation to the prospect's monthly or annual Pave payment. The sliding scale is configured to inform a prospect what the maximum income share 1806 percentage is to be paid to the Backer. In using the sliding node of projected earnings, a prospect is therefore able to price his campaign. For example, if a prospect is need of additional education to reach a higher earning potential, the prospect may include the cost of the tuition in his funding campaign to backers. The platforms sliding scale of projected income scale is based on comparative investments 1808. For instance, a prospect is able to view the percentage return for other types of investments a backer can invest in. For example, a United States Treasury bond which might yield a 2.95% return on investment. Thus, the prospect may select to offer a backer a 6 percent return of investment on the prospects future earnings. This would ensure that a backer would invest in a prospect that can yield a higher return on investment. The prospect's current contract length, fundraising amount and actualized income share 1810 are all viewable.

In accordance with a further embodiment, a prospect can agree to reinvest a percentage of their future earnings as reinvestment money that is only invested in prospects via the platform. The reinvestment money can be tracked and viewed on the prospect's profile page such that a prospect is able to see how their reinvestment money is performing. The prospect can also view what prospects and projects the reinvestment money has been invested in. The prospect can also track the path of the reinvestment money during its reinvestment into another prospect. As a result, the prospect effectively becomes a backer of another prospect in whose project the prospect has chosen to reinvest their reinvestment money. A backer may also view and track the backer's reinvestments.

As one illustration, a backer funds a prospect in the amount of $20,000, which in this example is the amount of money that the prospect needs for their project. The backer can agree to give the prospect a onetime payment of $20,000 in exchange for 5% of the future earrings of the prospect every year for 10 years. However, the funding agreement can specify that some or all of the 5% of the future earnings can be designated as reinvestment money. The reinvestment money can then be reinvested in another prospect. The decision as to which prospect to invest in can be left up to the original prospect that was funded, and/or the original backer.

A prospect or backer who decides to invest reinvestment money may condition the use of their reinvestment money. For example, the prospect or backer may specify that their reinvestment money be given to a specific prospect who shares a passion or affiliation with the prospect or backer. A backer or prospect may similarly choose to condition the investment of their reinvestment money such that the backer or prospect's identity is concealed from the further prospect that is invested in.

Reinvestment money can be tracked graphically by a prospect or backer by viewing a further prospect that received the original prospect's reinvestment money, the project the reinvestment money was invested in or by tracking the reinvested money geographically, e.g. by the region or state where the project or prospect is located in that received the reinvestment money. A virtual account balance can similarly be displayed for a backer or prospect, wherein the account balance shows the aggregate amount of the reinvested money, in addition to further money that was generated and reinvested as a result of the reinvested money. Thus, a backer that invests $50K, and specifies all money is to be reinvested on the platform, will have a reinvestment money account balance of $55K if the original $50K generates an additional $5K that is further invested as reinvestment money.

While the account may be virtual, in some implementations, rewards may be provided by a partner company to the online platform that provides actual value to the holder of the virtual reinvestment money account. Thus, such “reinvestment points” may be used by a prospect or backer to trade for goods and services offered from the online social media platform's sponsors, partners or affiliates. Sponsors of the online social media platform may include, for example, airlines or book retailers where prospects can use their reinvestment points to purchase airline tickets or discounts for their favorite book. Reinvestment points may be used, for example, to buy movie theater tickets or funds to be donated to charities. Prospects may able to use their reinvestment points to trade for additional services from their backers or from backers they wish to work with. In another embodiment, reinvestment points may be used to buy mentorship services from outside the prospect's mentorship circle or prospect community. Accumulating such reinvestment points may be used as a criteria for rating a backer or prospect, possibly resulting in an increase in the rating of a backer or prospect.

Reinvestment money and reinvestment points can be conditioned as described above. Additionally, reinvestment money and reinvestment points can be automated. For example, a prospect or backer can instruct the online social media platform that all reinvestment money must always go to the same affiliation or prospect at the same time of year. Similarly, a booster may be able to automate and condition his booster capital in the same way.

A prospect or backer may choose to exchange their reinvestment profits in exchange for reinvestment money or reinvestment points at any time. Reinvestment points can be held on a reinvestment card which may be used as a traditional credit card or gift card. A reinvestment card may be characterized in named levels (e.g., Gold, Silver, Platinum, Black, plum, diamond and the like) depending on the amount of reinvestment points a prospect or backer has on their reinvestment card. The amount of reinvestment points and/or named level of the reinvestment card can corresponds to a prospect's or backer's level of altruism. For example, a prospect that holds a gold reinvestment card with a point value at a high level can signify to others on the platform that the prospect has invested in numerous prospects and instead of choosing financial profit, has chosen to trade the prospect's investment profits for reinvestment points.

In another aspect, backers and prospects can be rewarded with virtual badges and awards that correspond to the quantity of their reinvestment activities.

In some implementations, a prospect or backer may not know what to do with their reinvestment money. The prospect or backer may thus elect for the online social media platform to provide a recommendation through a recommendation engine as to where the reinvestment should go. The recommendation engine can analyze the affiliations and passions of the backer or prospect and, through the platform's matching engine, can provide an appropriate recommendation. In situations where the prospect or backer are still undecided, their reinvestment money can be held in an interest bearing account.

If a prospect is approached by a potential investor who is not approved by the platform as a backer or is not a part of the platform community, the prospect may be restricted from entering into an agreement with such investor as specified in the terms of the personal equity funding agreement.

In some implementations, a prospect can be matched with a backer by the recommendation engine of the online social media platform. A prospect may choose a backer depending on the backer's profile rating while a backer may choose a prospect depending on the prospect's profile rating. The online social media platform may establish a numerical rating system wherein the value of the rating may equal the effectiveness of the prospect and/or backer. The interactions between a prospect and a backer can directly affect the rating system through feedback. Feedback on the level of involvement and interaction between the prospect and the backer can be assigned a numerical value. Likewise, the more successful a project is, the higher the numerical rating can be that is assigned by the prospect's. Prospective backers and prospects are preferably able to view and search ratings. A low rating does not necessarily signify a negative backer/prospect relationship but instead may indicate a lesser involvement between the backer and the prospect, which may be desired by future participants in the online social media platform. The public disclosure of ratings may act as incentives to other prospects to achieve a certain profile rating. Numerical values of profile ratings of backers and prospects can also indicate a certain effectiveness and type of backer or prospect. Numerical values of profile ratings may be categorized by the online social media platform into named levels. For instance a prospect profile rating with a high numerical value may be named “Superb” prospect. Accordingly, other prospects may strive to achieve certain profile ratings in order to appeal to potential backers. Backers and prospects may search profile ratings based on numerical values. Profile ratings may also provide incentives to backers to achieve a level of successful funding of prospects in order to be viewed as the most valuable backer.

An investor who is not a member of the social networking platform may still wish to invest in projects and prospects as a booster. A booster can invest any desired amount of money. However, in some implementations, an investment below a threshold value, (e.g., $500) may automatically be treated as a booster investment. The booster investment may be viewed as a gift, requiring no return on investment to the booster. Boosters may choose to withhold their identity from prospects and backers.

A backer may choose to mentor a prospect in a variety of different ways such as guidance, advice and connections offered to a prospect. The online social media platform may establish a tier system wherein the level of interaction, involvement and time spent between backer and prospect is assigned a named level, and if desired, a corresponding profile rating level of the backer and prospect. For instance, a first tier, Tier 1, could be named Easy, wherein the prospect may receive a letter from the backer who has decided to offer a minimum amount of interaction with the prospect he is funding. In a second tier, such as Tier 2, or Medium, the backer can have a desire to invest more time in the prospect and may contact the prospect he is funding on a monthly basis via the telephone. In a third tier, Tier 3, called High, for example, the backer may decide to contact the prospect on a weekly basis by telephone or email. In a fourth tier, Tier 4, called Personal, for example, the backer can agree to meet the prospect face to face for one or more in-depth meetings to discuss their shared passions and goals of the prospect. In another embodiment, the prospect and backer may define, negotiate or agree to the interactions that constitute tiers. Such tiered systems can act to inspire prospects and backers to increase their interaction as the relationship strengthens over the term of the agreement. The motivation to jump tiers and therefore increase interaction helps ensure a successful project and relationship.

Backers who decide to increase their level of interaction and go from a lower to tier to a higher tier may do so without any regard or consequence to the initial terms and conditions of the agreement. However, if a backer goes from an increased interaction tier to a lower interaction tier, this may cause the online social media platform to intercede and determine why the backer has decreased their interaction. The platform's involvement at this stage is to ensure the integrity of the original agreement and prevent negative backer feedback by a prospect and therefore a lower backer profile rating.

In situations where the backer and/or the prospect are not performing according to the terms and conditions of the agreement, the prospect or the backer may choose to terminate and exit the agreement. Likewise, the online social media platform may terminate the agreement if the level of interaction has ceased without satisfactory explanation from the backer or prospect. In some embodiments, the agreement may be put on hold. For example, the agreement may be put on hold if the prospect is engaged in non-income producing activities such as a prospect returning to school full time in order to achieve a milestone in the agreement.

In many implementations, the online social media platform will take all reasonable steps to ensure the truthfulness and veracity of backer or prospect feedback. Backers or prospects that receive low feedback and in turn a lower backer rating or prospect rating can be contacted by the online social media platform and provided an opportunity to raise their numerical rating. This may include a prospect donating a higher percentage of reinvestment money or a backer funding an additional prospect.

The value rating system can be interconnected to all the interactions and involvements between a prospect or backer and anyone else on the social networking platform. For example, the rating can detect and process the degree and quality of interaction between a backer or prospect and any other prospect, backer and/or booster on the platform.

In some implementations, Prospects can communicate with other prospects on the platform to form groups of common interest. Prospects may be permitted to interact with other prospects who are being funded by a specific backer.

In some embodiments, a backer may choose to interact with a prospect who has already been funded by a backer. A prospect may be able to receive information from another prospect regarding what the backer expects from a prospect who shares the same passions. In some embodiments, communities of prospects can offer each best practices tips and strategies on how to be the best prospect they can be at a certain level of backer interaction and mentorship. Likewise, backer communities can educate other backers and prospective backers as to what it's like to be a backer funding a prospect with a specific passion and goal.

In some embodiments, prospects who share passions with other prospects are able to form prospect circles, the parameters of which can be adjusted by the members of the circle. For instance, three prospects who share the same passions and that have formed a circle may set a limit to the amount of prospects allowed to enter the circle. Likewise, backers can adjust the parameters and conditions to backer circles. Backers may limit backers entry into their circles to backers who have funded a particular number of prospects or who have funded a monetary amount over a specific monetary amount. In another embodiment of the platform, the circles between mentoring backers and mentored prospects can be labeled as a “mentorship circle.” Such a mentorship circle may be adjusted with specific conditions and parameters by the prospect or backer. Mentorship circles may be graphically represented as circles on the profile pages of the prospect and backer, wherein each circle represents a prospect or backer, wherein overlapping circles signify that the prospect and backer are engaged in an exclusive mentorship circle. As prospects and backers enter into new mentorship relationships, new circles can be graphically connected to the existing mentorship circles. Prospects and backers can track their mentorship circles as they grow on their profile pages.

The online social media platform can be configured to socially link prospects with backers based on their shared passions or affiliations, such as prospects who all graduated from a particular university or backers who are part of the same film makers union. Prospects and backers can be permitted to link the passions and affiliations of other users of the online social media platform provided the backer and prospect desire certain affiliations to be viewed and searchable by other users of the platform.

In another embodiment, the online social media platform may establish a founding community of original backers and prospects. These initial prospects and backers can become the leading examples for future prospects and backers and from time to time may receive special treatment from the online social media platform. Likewise, the platform may establish a reward system for those backers who consistently receive positive feedback and maintain a high numerical backer rating. Such backers may be featured as the backer of the month on the platform. As a result, featured and proven backers may be more desirable to prospects than other backers. Like backers, prospects and their projects can be featured by the platform and awarded specific recognition and preferential treatment. In another embodiment, new prospects and backers may receive a welcome kit with their initial registration with the online social media platform.

In some implementations, the online social media platform can establish a crowd sourcing mechanism in addition to the crowd funding element by which prospect may offer ideas to other prospects on best practices. Likewise, backers may offer opinions to other backers on how best to treat and interact with prospects.

In another embodiment, the online social media platform may from time to time establish in person meetings and gatherings of prospects and backers. Such meetings may be informal or formal. Such meetings can take place at locations belonging to the platform's sponsors or companies who are participating in promotions with the platform. In person meetings of prospects and backer may involve an educational component and provide a curriculum to educate prospects and backers on effective methods of negotiating agreements, mentorship, entrepreneurial skills and networking techniques.

In order to address various issues and advance the art, the entirety of this application for PAVE™ APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all disclosed embodiments. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a PAVE™ individual and/or enterprise user, database configuration and/or relational model, data type, data transmission and/or network framework, syntax structure, and/or the like, various embodiments of the PAVE™ may be implemented that enable a great deal of flexibility and customization.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software as set forth herein.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

The methods, systems, computer programs and mobile devices of the present disclosure, as described above and shown in the drawings, among other things, provide for improved social networking platforms and aspects thereof. It will be apparent to those skilled in the art that various modifications and variations can be made in the devices, methods, software programs and mobile devices of the present disclosure without departing from the spirit or scope of the disclosure. Thus, it is intended that the present disclosure include modifications and variations that are within the scope of the subject disclosure and equivalents.

What is claimed is:

1. A method of operating an online social media platform, comprising:
a) facilitating an introduction on the social media platform via processor between a prospect and a backer that wishes to invest capital and mentoring in the prospect;
b) establishing an online connection between the prospect and backer via processor on the social media platform to facilitate the investment of at least one of (i) capital and (ii) mentoring in the prospect;
c) providing a first set of online tools on the social media platform via processor to define a personal equity funding agreement that delineates a plurality of parameters that define the investment of at least one of (i) capital and (ii) mentoring in the prospect; and
d) providing a second set of online tools via processor to ensure that the prospect pays money into an account controlled by an administrator of the social media platform as a condition of the contractual relationship.

2. The method of claim 1, wherein the investment includes a capital contribution to the prospect and at least one of (i) an introduction by the backer to the prospect to a contact of the investor and (ii) a professional service to be rendered by the backer for the prospect.

3. The method of claim 2, wherein the professional service is selected to improve a skill of the prospect.

4. The method of claim 2, wherein the professional service includes at least one of (i) a voice lesson, (ii) a mentoring session and (iii) providing publicity for the prospect.

5. The method of claim 1, wherein capital received by the prospect under the contract includes at least one of: an amount received at the onset of the agreement, an amount to be paid during the term of the agreement, and amounts distributed over a predetermined time period.

6. The method of claim 1, wherein the prospect pays money under the contract that is at least one of (i) a percentage of gross income, (ii) a percentage of after tax income and (iii) a flat fee.

7. The method of claim 1, wherein the contract specifies that the prospect pays money only if the prospect's income exceeds a threshold amount.

8. The method of claim 1, wherein the threshold amount includes at least one of (i) a fixed amount, (ii) a variable amount depending on cost of living of the geographic region in which the prospect resides and (iii) an amount based on the poverty line level for the geographic region in which the prospect resides.

9. The method of claim 1, wherein the terms of the personal equity funding agreement includes at least one of (i) the name and current residence address of the prospect, (ii) the social security number or taxpayer ID number of the prospect, (iii) the prospect's date of birth, (iv) the prospect's marital status, (v) the educational background of prospect, (vi) the period of study of the prospect, (vii) the amount of investment sought, (viii) the date that the investment is desired, (ix) the purpose for the investment, (x) the repayment period, (xi) termination conditions of the agreement, (xii) privacy and confidentiality provisions, (xiii) an amount of future earnings to be repaid, (xiv) an upfront fee to be paid to administrator of social media platform, (xv) terms specifying prepayment of agreement by prospect, (xvi) bankruptcy provisions, (xvii) default and remedies provisions, (xviii) governing law and jurisdiction, (xix) assignability of the agreement; (xx) representations and warranties of backer and/or prospect; (xxi) an agreement to provide written permission to an administrator of the social media platform or the backer to obtain federal tax transcripts for one or a plurality of years during the term of the agreement, (xxii) written permission to deposit or remove a fixed amount of capital from a bank account of the prospect and (xxiii) written permission to permit an administrator of the social media platform or a backer to obtain payment under the funding agreement from the prospect directly from an employer or a bank account of the prospect.

10. The method of claim 1, wherein the prospect agrees to obtain permission from an individual that files taxes jointly with the prospect to provide the tax transcripts, or to file a tax return individually if that permission cannot be obtained.

11. The method of claim 1, wherein the representations and warranties by the prospect include at least one of: (i) a statement that no lawsuit is pending against the prospect that would impair performance under the agreement, (ii) a statement that the prospect has not defaulted on any material contract, (iii) a statement that the prospect has filed all tax returns and paid all taxes due, (iv) a statement that the prospect has no prior criminal convictions, and (v) a statement that the prospect has not filed for personal bankruptcy.

12. A method of evaluating a future career of a prospect on an online social media platform via processor, the method comprising:
a) receiving career input from the prospect via processor;
b) analyzing the career input from the prospect via processor by comparing the career input from the prospect with benchmark career data in a database; and
c) generating an evaluation via processor that summarizes the career prospects of the prospect.

13. The method of claim 12, wherein the evaluation includes assigning a value or a range of values via processor to the future career of the prospect.

14. The method of claim 12, wherein the evaluation includes assigning a rank to the prospect via processor.

15. The method of claim 12, wherein the evaluation includes delivering at least one recommendation to the prospect via processor to modify the career input to enhance the career prospects of the prospect.

16. The method of claim 12, wherein the career input includes at least one of (i) career interest data of the prospect, (ii) a desired retirement age for the prospect, (iii) a desired income range for the prospect, (iv) a maximum debt load the prospect is willing to commit to in order to achieve the prospect's career goals, and (v) a geographical region in which the prospect would like to engage in their career.

17. The method of claim 15, wherein the recommendation includes at least one of (i) recommended steps to maximize future potential revenue of the prospect and (ii) a recommendation of a career path for the prospect.

18. The method of claim 17, wherein the recommendation includes a recommendation delivered to the prospect via processor for the prospect to (i) learn another language, (ii) change a concentration of study, (iii) engage in further coursework, (iv) engage in a particular internship, (v) change educational institutions, (vi) pursue an additional degree, (vii) seek counsel of a particular backer on the platform or a particular type of backer, and (viii) change the geographic location in which the prospect wishes to work or reside.

19. The method of claim 12, wherein the evaluation is generated by analyzing via processor at least one of (i) the age of the prospect, (ii) the education of the prospect, (iii) skills or experiences of the prospect, (iv) the personal contacts of the prospect, and (v) past income of the prospect.

20. The method of claim 19, wherein analyzing the education of the prospect includes analyzing via processor at least one of (i) an educational institution attended by the prospect, (ii) an educational course of study taken by the prospect, (iii) internships performed by the prospect, (iv) grades of the prospect in major coursework of the prospect and (v) the overall grade point average of the prospect.
